(19) United States
(12) Patent Application Publication
(10) Pub. No.: US 2026/0184333 A1
(43) Pub. Date: Jul. 2, 2026

(54) CONTEXT-AWARE EXTERNAL OBJECT DETECTION AND VEHICLE GUIDANCE

(71) Applicant: TOYOTA MOTOR ENGINEERING & MANUFACTURING NORTH AMERICA, INC., Plano, TX (US)

(72) Inventors: Rohit Gupta, Santa Clara, CA (US); Yunsheng Ma, West Lafayette, IN (US); Amr Abdelraouf, Foster City, CA (US); Kyungtae Han, Palo Alto, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, AICHI-KEN (JP)

(21) Appl. No.: 19/004,331

(22) Filed: Dec. 29, 2024

(51) Int. Cl. B60W 60/00; G06F 40/20

(52) U.S. Cl. CPC B60W 60/001; G06F 40/20; B60W 2420/54; B60W 2555/60; B60W 2556/45

(57) ABSTRACT

An example operation includes one or more of processing, by at least one processor on a vehicle, a query related to a sign proximate a road that the vehicle is traveling on using a first artificial intelligence (AI) model deployed on the vehicle to generate contextual information related to the sign, sending, by the at least one processor, the query and the contextual information to a second AI model deployed on a server off the vehicle, processing, by the server, the query and the contextual information using the second AI model, generating, by the server, a response related to the query and the contextual information, sending, by the server, the response to the at least one processor, and providing, by the at least one processor, the response to the vehicle.

### BACKGROUND

Vehicles or transports, such as cars, motorcycles, trucks, planes, trains, etc., generally provide transportation to occupants and/or goods in a variety of ways. Functions related to vehicles may be identified and utilized by various computing devices, such as a smartphone or a computer located on and/or off the vehicle.

### SUMMARY

The instant solution provides a method for context-aware external object detection and vehicle guidance that includes one or more of processing, by at least one processor on a vehicle, a query related to a sign proximate a road that the vehicle is traveling on using a first artificial intelligence (AI) model deployed on the vehicle to generate contextual information related to the sign, sending, by the at least one processor, the query and the contextual information to a second AI model deployed on a server off the vehicle, processing, by the server, the query and the contextual information using the second AI model, generating, by the server, a response related to the query and the contextual information, sending, by the server, the response to the at least one processor, and providing, by the at least one processor, the response to the vehicle.

The instant solution also provides a system for context-aware external object detection and vehicle guidance comprising a memory and at least one processor, wherein the memory and the at least one processor are communicatively coupled, wherein the at least one processor is configured to perform one or more of process, by at least one processor on a vehicle, a query related to a sign proximate a road that the vehicle travels on via a first artificial intelligence (AI) model deployed on the vehicle to generate contextual information related to the sign, send, by the at least one processor, the query and the contextual information to a second AI model deployed on a server off the vehicle, process, by the server, the query and the contextual information via the second AI model, generate, by the server, a response related to the query and the contextual information, send, by the server, the response to the at least one processor, and provide, by the at least one processor, the response to the vehicle.

The instant solution further provides a computer program product comprising one or more computer-readable storage media, and program instructions stored on the one or more computer-readable storage media to perform operations comprising processing, by at least one processor on a vehicle, a query related to a sign proximate a road that the vehicle travels on via a first artificial intelligence (AI) model deployed on the vehicle to generate contextual information related to the sign, sending, by the at least one processor, the query and the contextual information to a second AI model deployed on a server off the vehicle, processing, by the server, the query and the contextual information via the second AI model, generating, by the server, a response related to the query and the contextual information, sending, by the server, the response to the at least one processor, and providing, by the at least one processor, the response to the vehicle.

The instant solution further provides a method that includes one or more of analyzing a sign proximate a road that a vehicle is traveling on to determine an action to be performed by the vehicle and a level of the action to be performed, determining a query related to the action to be performed when the action to be performed is above a first threshold, responsive to the action being below a second threshold, processing the query to generate a first response, responsive to the action being at or above the second threshold, sending the query to a server, receiving a second response from the server to the query, and autonomously performing the action, by the vehicle, based on at least one of the first response or the second response.

The instant solution further provides a system that includes a memory communicably coupled to a processor, wherein the processor is configured to perform one or more of analyze a sign proximate a road that a vehicle travels on to determine an action to be performed by the vehicle and a level of the action to be performed, determine a query related to the action to be performed when the action to be performed is above a first threshold, responsive to the action that is below a second threshold, process the query to generate a first response, responsive to the action that is at or above the second threshold, send the query to a server, receive a second response from the server to the query, and autonomously perform the action, by the vehicle, based on at least one of the first response or the second response.

The instant solution further provides a computer program product comprising one or more computer-readable storage media, and program instructions stored on the one or more computer-readable storage media to perform operations comprising analyzing a sign proximate a road that a vehicle is traveling on to determine an action to be performed by the vehicle and a level of the action to be performed, determining a query related to the action to be performed when the action to be performed is above a first threshold, responsive to the action being below a second threshold, processing the query to generate a first response, responsive to the action being at or above the second threshold, sending the query to a server, receiving a second response from the server to the query, and autonomously performing the action, by the vehicle, based on at least one of the first response or the second response.

### BRIEF DESCRIPTION OF THE DRAWINGS

FIG. 1A illustrates an example network diagram according to an example of the instant solution.

FIG. 1B illustrates a further network diagram, according to an example of the instant solution.

FIG. 1C illustrates a message flow diagram, according to an example of the instant solution.

FIG. 1D illustrates another flow diagram, according to an example of the instant solution.

FIG. 1E illustrates another flow diagram, according to an example of the instant solution.

FIG. 1F illustrates a flowchart of formulating a query, according to an example of the instant solution.

FIG. 2A illustrates a vehicle network diagram, according to an example of the instant solution.

FIG. 2B illustrates another vehicle network diagram, according to an example of the instant solution.

FIG. 2C illustrates yet another vehicle network diagram, according to an example of the instant solution.

FIG. 2D illustrates a further vehicle network diagram, according to an example of the instant solution.

FIG. 2E illustrates a flow diagram, according to an example of the instant solution.

FIG. 2F illustrates another flow diagram, according to an example of the instant solution.

FIG. 2G illustrates yet another vehicle network diagram, according to an example of the instant solution.

FIG. 2H illustrates a further vehicle network diagram, according to an example of the instant solution.

FIG. 2I illustrates another flow diagram, according to an example of the instant solution.

FIG. 2J illustrates a further flow diagram, according to an example of the instant solution.

FIG. 3A illustrates an Artificial Intelligence (AI)/Machine Learning (ML) network diagram for integrating an artificial intelligence (AI) model into any decision point in an example of the instant solution.

FIG. 3B illustrates a process for developing an Artificial Intelligence (AI)/Machine Learning (ML) model that supports AI-assisted vehicle or occupant decision points.

FIG. 3C illustrates a process for utilizing an Artificial Intelligence (AI)/Machine Learning (ML) model that supports AI-assisted vehicle or occupant decision points.

FIG. 3D illustrates a machine learning network diagram, according to an example of the instant solution.

FIG. 3E illustrates a machine learning network diagram, according to an example of the instant solution.

FIG. 4A illustrates a diagram depicting electrification of one or more elements, according to an example of the instant solution.

FIG. 4B illustrates a diagram depicting interconnections between different elements, according to an example of the instant solution.

FIG. 4C illustrates a further diagram depicting interconnections between different elements, according to an example of the instant solution.

FIG. 4D illustrates yet a further diagram depicting interconnections between elements, according to an example of the instant solution.

FIG. 4E illustrates yet a further diagram depicting an example of vehicles performing secured Vehicle-to-Vehicle (V2V) communications using security certificates, according to an example of the instant solution.

FIG. 5A illustrates an example vehicle configuration for managing database transactions associated with a vehicle, according to an example of the instant solution.

FIG. 5B illustrates an example blockchain group, according to an example of the instant solution.

FIG. 5C illustrates an example interaction between elements and a blockchain, according to an example of the instant solution.

FIG. 5D illustrates an example data block interaction, according to an example of the instant solution.

FIG. 5E illustrates a blockchain network diagram, according to an example of the instant solution.

FIG. 5F illustrates an example new data block, according to an example of the instant solution.

FIG. 6 illustrates an example system that supports one or more of an example of the instant solution.

### DETAILED DESCRIPTION

It will be readily understood that the instant components, as generally described and illustrated in the figures herein, may be arranged and designed in a wide variety of different configurations. Thus, the following detailed description of the instant solution of at least one of a method, apparatus, computer program product, computer-readable storage medium system, and other element, structure, component, or device as represented in the attached figures, is not intended to limit the scope of the application as claimed but is merely representative of aspects of the instant solution.

Communications between the vehicle(s) and certain entities, such as remote servers, other vehicles, and local computing devices (e.g., smartphones, personal computers, vehicle-embedded computers, etc.) may be sent and/or received and processed by one or more ‘components’ which may be hardware, firmware, software, or a combination thereof. The components may be part of any of these entities or computing devices or certain other computing devices. In one example, consensus decisions related to blockchain transactions may be performed by one or more computing devices or components (which may be any element described and/or depicted herein) associated with the vehicle(s) and one or more of the components outside or at a remote location from the vehicle(s).

The instant features, structures, or characteristics described in this specification may be combined in any suitable manner in the instant solution. Thus, the one or more features, structures, or characteristics of the instant solution, described or depicted in this specification, are utilized in various manners. Thus, the one or more features, structures, or characteristics of the instant solution may work in conjunction with one another, may not be functionally separate, and these features, structures, or characteristics may be combined in any suitable manner. Although presented in a particular manner, by example only, one or more feature(s), element(s), and step(s) described or depicted herein may be utilized together and in various combinations, without exclusivity, unless expressly indicated otherwise herein. In the figures, any connection between elements (for example, a line or an arrow) can permit one-way and/or two-way communication, even if the depicted connection shown is a one-way or two-way connection.

In the instant solution, a vehicle may include one or more of cars, trucks, Internal Combustion Engine (ICE) vehicles, electric vehicles, such as battery electric vehicles (BEVs), hybrid electric vehicles (HEVs), plug-in electric vehicles (PHEVs), and any other type of electric vehicles, fuel cell vehicles, any vehicle utilizing renewable sources, other hybrid vehicles, such as parallel hybrid vehicles, series hybrid vehicles, and mild hybrid vehicles, e-Palettes, buses, motorcycles, scooters, bicycles, boats, recreational vehicles, planes, drones, Unmanned Aerial Vehicles and any object that may be used to transport people and/or goods from one location to another.

In addition, while the term “message” may have been used in the description of method, apparatus, computer-readable storage medium system, and other element, structure, component, or device, other types of network data, such as, a packet, frame, datagram, etc. may also be used. Furthermore, while certain types of messages and signaling may be depicted in exemplary configurations they are not limited to a certain type of message and signaling.

Example configurations of the instant solution provide methods, systems, components, non-transitory computer-readable storage mediums, devices, and/or networks, which provide at least one of a transport (also referred to as a vehicle or car herein), a data collection system, a data monitoring system, a verification system, an authorization system, and a vehicle data distribution system. The vehicle status condition data received in the form of communication messages, such as wireless data network communications and/or wired communication messages, may be processed to identify vehicle status conditions and provide feedback on the condition and/or changes of a vehicle. In one example, a user profile may be applied to a particular vehicle to authorize a current vehicle event, service stops at service stations, to authorize subsequent vehicle rental services, and enable vehicle-to-vehicle communications.

An instant method, apparatus, computer program product, computer-readable storage medium system, and other element, structure, component, or device provides a service to a particular vehicle and/or a user profile that is applied to the vehicle. For example, a user may be the owner of a vehicle or the operator of a vehicle owned by another party. The vehicle may require service at certain intervals, and the service needs may require authorization before permitting the services to be received. Also, service centers may offer services to vehicles in a nearby area based on the vehicle's current route plan and a relative level of service requirements (e.g., immediate, severe, intermediate, minor, etc.). The vehicle needs may be monitored via one or more vehicle and/or road sensors or cameras, which report sensed data to a central controller computer device in and/or apart from the vehicle. This data is forwarded to a management server for review and action. A sensor may be located on one or more of the interior of the vehicle, the exterior of the vehicle, on a fixed object apart from the vehicle, and/or on another vehicle proximate the vehicle. The sensor may also be associated with the vehicle's speed, the vehicle's braking, the vehicle's acceleration, fuel levels, service needs, the gear-shifting of the vehicle, the vehicle's steering, and the like. A sensor, as described herein, may also be a device, such as a wireless device in and/or proximate to the vehicle. Also, sensor information may be used to identify whether the vehicle is operating safely and whether an occupant has engaged in any unexpected vehicle conditions, such as during a vehicle access and/or utilization period. Vehicle information collected before, during and/or after a vehicle's operation may be identified and stored in a transaction on a shared/distributed ledger, which may be generated and committed to the immutable ledger as determined by a permission granting consortium, and thus in a “decentralized” manner, such as via a blockchain membership group.

Each interested party (i.e., owner, user, company, agency, etc.) may want to limit the exposure of private information, and therefore the blockchain and its immutability can be used to manage permissions for each user vehicle profile. A smart contract may be used to provide compensation, quantify a user profile score/rating/review, apply vehicle event permissions, determine when service is needed, identify a collision and/or degradation event, identify a safety concern event, identify parties to the event and provide distribution to registered entities seeking access to such vehicle event data. Also, the results may be identified, and the necessary information can be shared among the registered companies and/or individuals based on a consensus approach associated with the blockchain. Such an approach may not be implemented on a traditional centralized database.

Various driving systems of the instant solution can utilize software, an array of sensors as well as machine learning functionality, light detection and ranging (LiDAR) projectors, radar, ultrasonic sensors, etc. to create a map of terrain and road that a vehicle can use for navigation and other purposes. In some examples of the instant solution, global positioning system (GPS), maps, cameras, sensors, and the like can also be used in autonomous vehicles in place of LiDAR.

The instant solution includes, in certain instant examples, authorizing a vehicle for service via an automated and quick authentication scheme. For example, driving up to a charging station or fuel pump may be performed by a vehicle operator or an autonomous vehicle and the authorization to receive charge or fuel may be performed without any delays provided the authorization is received by the service and/or charging station. A vehicle may provide a communication signal that provides an identification of a vehicle that has a currently active profile linked to an account that is authorized to accept a service, which can be later rectified by compensation. Additional measures may be used to provide further authentication, such as another identifier may be sent from the user's device wirelessly to the service center to replace or supplement the first authorization effort between the vehicle and the service center with an additional authorization effort.

Data shared and received may be stored in a database, which maintains data in one single database (e.g., database server) and generally at one particular location. This location is often a central computer, for example, a desktop central processing unit (CPU), a server CPU, or a mainframe computer. Information stored on a centralized database is typically accessible from multiple different points. A centralized database is easy to manage, maintain, and control, especially for purposes of security because of its single location. Within a centralized database, data redundancy is minimized as having a single storing place of all data and also implies that a given set of data only has one primary record. A decentralized database, such as a blockchain, may be used for storing vehicle-related data and transactions.

Any of the actions described herein may be performed by one or more processors (such as a microprocessor, a sensor, an Electronic Control Unit (ECU), a head unit, and the like), with or without memory, which may be located on-board the vehicle and/or off-board the vehicle (such as a server, computer, mobile/wireless device, etc.). The one or more processors may communicate with other memory and/or other processors on-board or off-board other vehicles to utilize data being sent by and/or to the vehicle. The one or more processors and the other processors can send data, receive data, and utilize this data to perform one or more of the actions described or depicted herein.

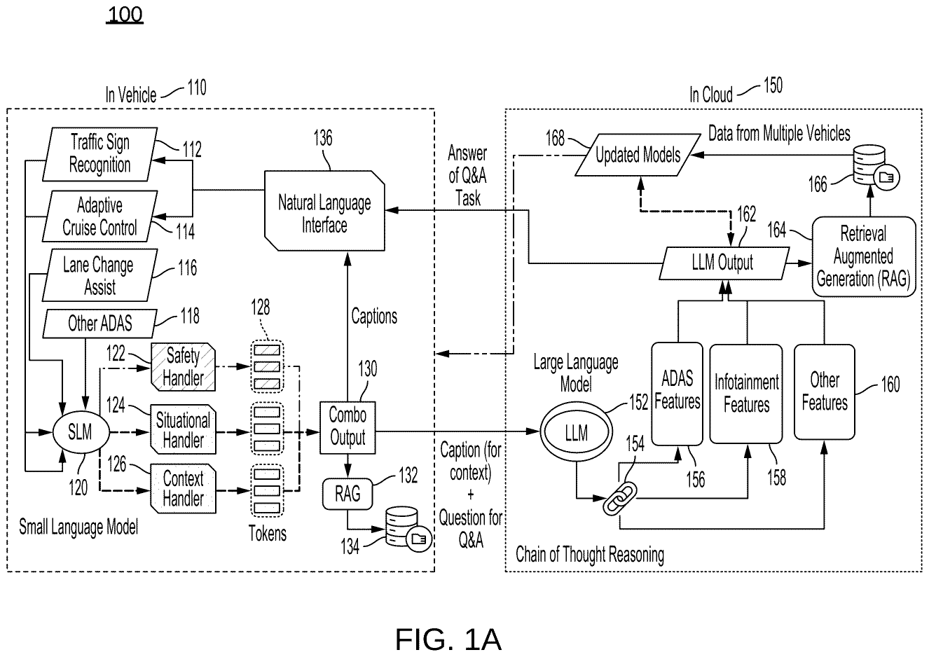

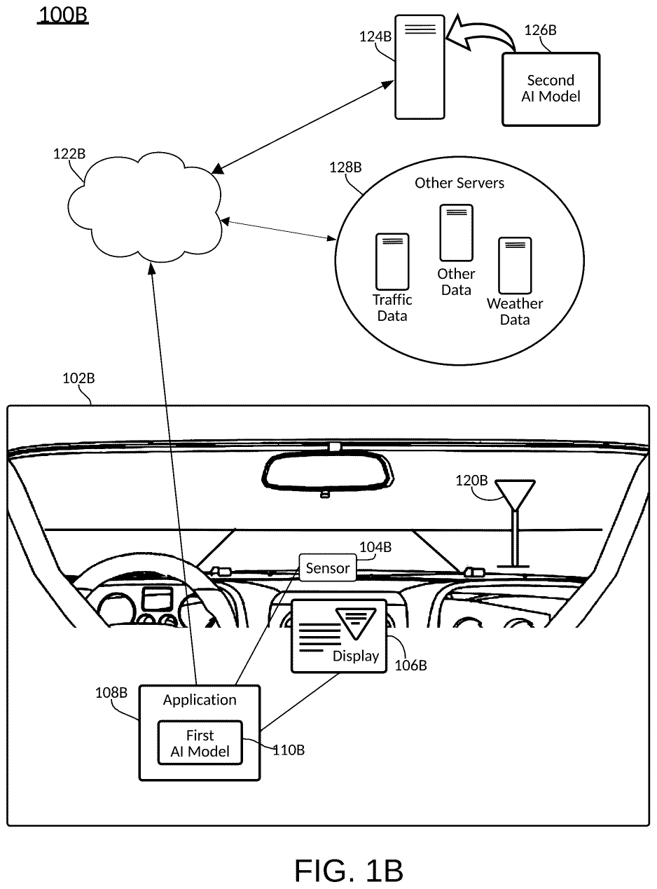

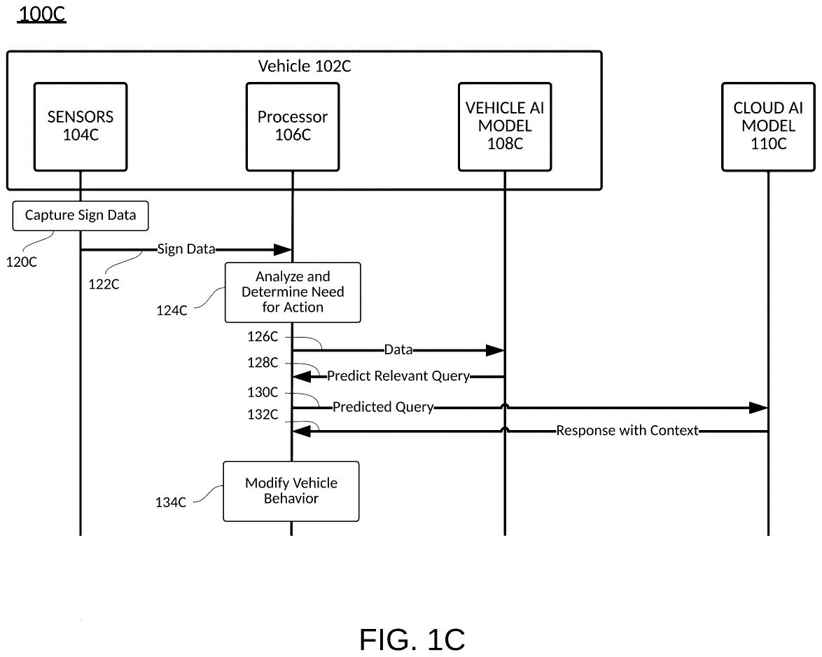

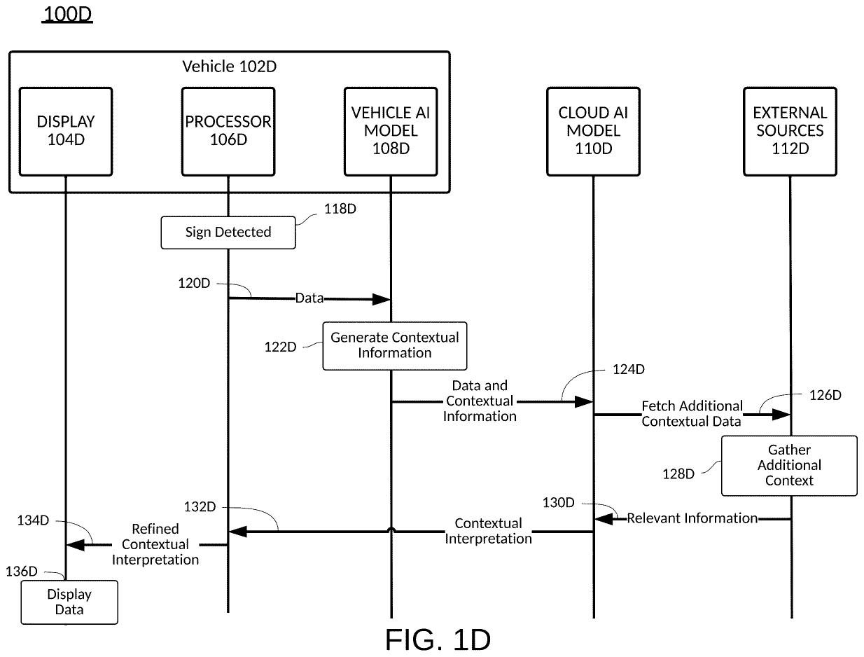

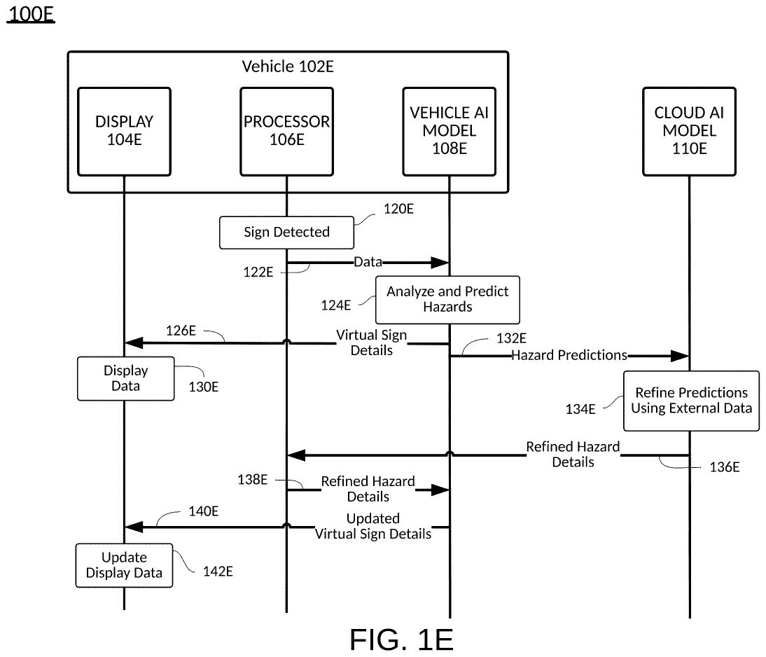

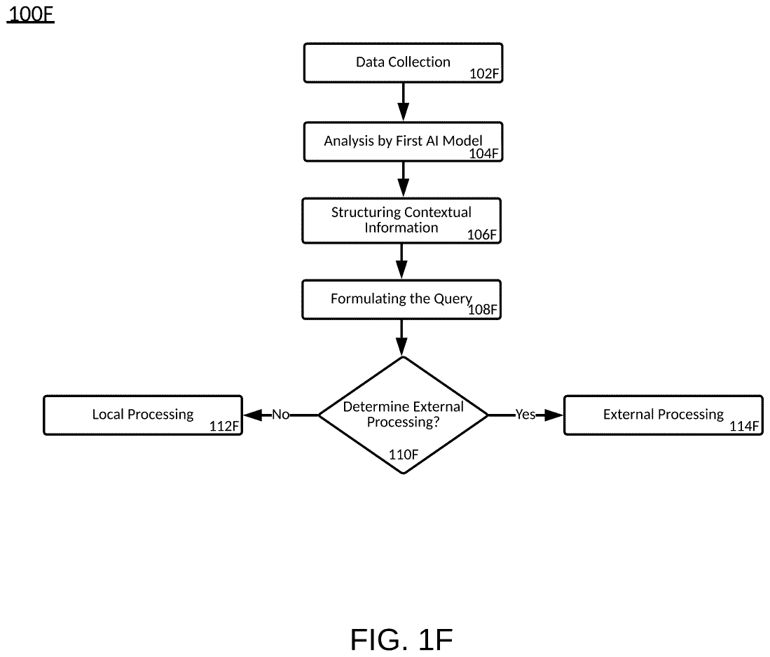

FIG. 1A is a network diagram 100 of the instant solution, according to example embodiments. The figure depicts a vehicle 110 and a cloud 150. A small language model (SLM) 120 resides in vehicle 110, and a large language model (LLM) resides in the cloud.

The SLM 120 is a machine learning (ML) model designed for the generation and interpretation of human language, using a constrained set of parameters in comparison to larger-scale models. These parameters, optimized during a training phase of the language model, enable the model to capture linguistic patterns derived from its training dataset. The design of SLMs requires lower power and memory resources, supporting rapid and cost-effective deployment in various applications. The LLM 152 represents an artificial intelligence (AI) model engineered to execute complex language processing, generation, and comprehension tasks. LLMs are characterized by a large array of parameters fine-tuned throughout training to enable the model to recognize and emulate linguistic patterns, syntactic structures, contextual nuances, and advanced semantic relationships.

In the instant solution, traffic sign recognition (TSR) 112 adaptive cruise control 114, lane change assist 116, and other ADAS 118 are interacted with as the instant solution (which may be referred to herein as the system) modifies the vehicle based on the response generated by the SLM 120 and/or the LLM 152. This processing leverages the vehicle SLM 120 and/or the LLM 152 to accurately detect, classify, and display information related to objects, such as road signs. The instant solution relies on sensors, such as cameras and radar, to scan the environment for objects, such as traffic signs, as the vehicle maneuvers. These sensors capture data, such as visual and spatial data, identifying objects, such as signs in the vehicle's surroundings. The captured data is processed by the SLM 120. Once a traffic sign is detected, the SLM 120 uses machine learning algorithms to classify the sign. The model categorizes it based on its shape, color, text, and other defining features, identifying the specific type of sign, such as a speed limit, yield, stop, or caution sign, for example. For ambiguous or non-standard signs (e.g., signs with varied fonts, colors, or styles), the SLM applies context-aware processing. It considers nearby text, the road context, and visual cues to interpret the sign accurately, even if it deviates from standard design conventions. This classification process allows TSR to adapt to different traffic sign designs and interpret unfamiliar signs based on context. ADAS components, such as adaptive cruise control 114, lane change assist 116, and other components 118 may be modified in response to data that is processed by any functionality mentioned herein.

In one example, output from the SLM 120 may be sent to handlers such as a safety handler 122, a situational handler 124, and/or a context handler 126. The safety handler 122 is responsible for managing safety-related functionalities using data processed by the SLM. This handler interacts with the vehicle's advanced driver assistance systems (ADAS) by ensuring that the system can respond to potentially hazardous situations, as well as assist the driver in emergencies. The safety handler interprets critical data related to driving conditions (e.g., rapid deceleration, nearby obstacles) and initiates alerts or guidance instructions for the driver. For example, when the SLM detects an obstacle, the safety handler can trigger an emergency response, such as a message (“Emergency braking activated. Please take control”) presented to the driver of the vehicle to ensure the driver is aware of the risk. The safety handler may process context-aware information, such as changing road or traffic conditions, to provide situational alerts that adjust based on real-time data from the SLM. For example, in case of a detected slippery road condition or sharp curve ahead, the handler could initiate an alert such as, “Reducing speed due to slippery road conditions.” Based on the SLM's interpretations of surrounding conditions, the safety handler may adjust other ADAS functionalities to align with safety requirements, which may involve modifying recommended speed limits, adjusting following distances, or increasing alert sensitivity in hazardous conditions.

In another example of the instant solution, output from the SLM 120 may be sent to an Emergency Handler, which functions to manage high-priority, safety-critical responses by utilizing data provided by the SLM. When the SLM detects urgent conditions, such as imminent collisions, sudden obstacles, or rapid speed changes, the Emergency Handler immediately activates safety responses, including emergency braking, lane adjustments, or evasive maneuvers, to mitigate potential accidents. It issues alerts to guide the driver, such as “Take control immediately” or “Obstacle detected ahead,” providing actionable instructions suited to the detected situation's severity. The SLM processes data from sensors monitoring the vehicle's environment and operational state, including inputs from cameras, radar, Lidar, and accelerometers. When the SLM identifies conditions such as imminent collisions, sudden obstacles, or rapid speed changes, it triggers the Emergency Handler to execute safety measures in real time. These measures include actions such as applying emergency braking, performing lane adjustments, or initiating evasive maneuvers to avoid accidents. The system may communicate alerts to the driver through the display or audio interface, providing instructions, such as “Take control immediately” or “Obstacle detected ahead.”

The Emergency Handler assesses the driver's state, such as alertness or distraction levels, ensuring the driver can assume control when prompted, or it increases autonomous response if needed. Sensors such as in-cabin cameras, infrared eye-tracking devices, and steering input monitors detect key indicators of driver alertness, such as gaze direction, eyelid movement, grip on the steering wheel, and reaction time to minor control prompts. These conditions may be determined by analysis of data from the sensors in the vehicle, for example. The Emergency Handler processes this data through the AI model to evaluate whether the driver is attentive or distracted. If the driver is determined to be alert and capable of responding, the system provides clear prompts such as “Take control immediately,” ensuring the driver can safely assume manual control. When the monitoring system detects signs of distraction, drowsiness, or incapacitation, the Emergency Handler dynamically increases the level of autonomous response, such as taking full control of braking, steering, and maneuvering around obstacles and/or raising the alert via adding or increasing an audible alert.

This handler also coordinates with other ADAS features to enhance system-wide reactions and, if necessary, communicates with the cloud-based LLM 152 for added situational context, like real-time updates from nearby vehicles or changing road conditions. The handler's ability to deliver guidance through explanations, such as “Engaging emergency braking due to detected obstacle”, informs the driver.

The situational handler 124 interprets data from the SLM 120 to enhance the driver's situational awareness by providing alerts related to the current driving environment. When the SLM detects specific road conditions or events, such as a sharp curve ahead, a change in speed limits, or potential hazards like slippery roads, the handler generates alerts that inform the driver about these conditions. The situational handler may depict a reason that certain actions are being taken, such as “Reducing speed due to detected sharp curve” or “Increasing following distance due to wet road conditions.” This handler facilitates interactive feedback, allowing the driver to ask questions, such as “Why are we slowing down?” and receive real-time, understandable explanations, thereby enhancing both trust and situational awareness. The situational handler 124 is integrated with the SLM 120 and the vehicle's user interface systems to provide enhanced situational awareness for the driver. The situational handler receives real-time data and context analysis from the SLM, which processes sensor inputs such as camera imagery, radar data, Lidar, weather sensors, and vehicle operational parameters. When the SLM detects specific road conditions or events, such as a sharp curve, a change in speed limits, or potential hazards like wet or icy roads, it transmits this contextual information to the situational handler. The handler interprets this data and generates alerts tailored to the detected conditions, such as “Sharp curve ahead, reducing speed to 30 mph” or “Increasing following distance due to slippery road.” These alerts are presented to the driver through visual, auditory, or haptic feedback systems to ensure timely and clear communication.

The situational handler also incorporates interactive feedback functionality, allowing the driver to engage with the system by asking questions like “Why are we slowing down?” or “What's the current hazard?” The SLM processes these queries and formulates intuitive, real-time explanations, such as “We are slowing down due to reduced traction on the upcoming icy bridge.” This implementation enhances safety and driving experience by combining intelligent alerts with interactive, context-aware feedback. The situational handler receives contextual data and real-time analysis from the SLM, which processes inputs from the vehicle's sensors as well as operational data like speed, braking, and steering. When a change in the driving environment or vehicle behavior occurs—such as deceleration, lane adjustments, or activation of safety systems—the situational handler identifies the cause and generates an explanation.

The vehicle's infotainment system, equipped with a voice recognition module or touchscreen interface, acts as the communication bridge between the driver and the SLM. When the driver asks questions like “Why are we slowing down?” or “What is the current hazard?” the input is processed by the SLM, which interprets the query, retrieves the relevant contextual information, and formulates a clear, real-time response. For example, if the vehicle is slowing due to icy conditions detected on an upcoming bridge, the SLM might respond with, “We are slowing down due to reduced traction expected on the icy bridge ahead.” The system leverages the SLM's natural language processing capabilities to ensure that responses are concise, intuitive, and contextually appropriate. This interaction is seamlessly delivered via audio output, visual displays, or a combination of both, ensuring accessibility and minimal distraction for the driver. Additionally, the situational handler can provide proactive explanations without driver input, such as “Reducing speed for a sharp curve ahead,” to preemptively enhance driver awareness.

In one example, an Interactive feedback feature within the situational handler 124 allows drivers to actively engage with the ADAS system by asking questions and receiving real-time explanations for the vehicle's actions. When the SLM 120 initiates certain responses such as slowing down, adjusting the following distance, or changing lanes due to detected hazards. the driver can inquire about these actions by asking questions such as “What is causing the alert?” The system provides responses, such as “We are reducing speed due to a detected curve ahead” or “Increasing distance because of slippery road conditions.”

The context handler 126 is a component that works with the SLM 120 to interpret, refine, and provide context to the data processed within the vehicle. It ensures that the SLM's responses and actions are contextually relevant, accurate, and tailored to the driver's environment, allowing for a more intuitive and informed in-car experience. The context handler takes data from various vehicle sensors and combines this with real-time inputs from the SLM. This data includes information about traffic signs, road conditions, nearby vehicles, speed, and location. By integrating this sensory information, the context handler builds a real-time understanding of the current driving environment. For example, it recognizes whether the vehicle is in an urban area, a school zone, or on a highway, which helps tailor the SLM's responses based on this situational awareness. When a driver issues a command or asks a question, the context handler modifies the SLM's processing by adding relevant context to the query. For example, if a driver says, “Find the nearest gas station,” the context handler uses GPS data to refine this command to locate gas stations within a reasonable radius based on the vehicle's fuel level and current route. This contextual enhancement allows the SLM to provide responses that are not only accurate but also relevant to the driver's current needs and circumstances. For example, if the SLM detects a partially obscured traffic sign, the context handler evaluates the vehicle's location, road type, and surrounding traffic flow to help the SLM make an informed guess. By considering nearby signs or commonly expected signs in that area, the context handler helps the SLM reduce uncertainty and provide the driver with the most likely interpretation, such as “Yield ahead” if the vehicle is approaching an intersection.

The context handler 126 dynamically adjusts the SLM's 120 responses based on real-time changes in driving conditions. For example, if the vehicle is approaching a construction zone, the context handler may modify alerts to increase their urgency or provide alternative route suggestions if available.

The context handler 126 works in conjunction with the SLM 120 and the vehicle's onboard and external systems to dynamically adapt the SLM's responses based on real-time driving conditions. The context handler is deployed on a processor such as the vehicle's onboard processor 110 or an external server processor 124, depending on the complexity of the analysis required. The vehicle's sensors collect data about the driving environment, such as proximity to construction zones, changes in road conditions, or traffic patterns. This data is transmitted to the SLM 120, which processes it to generate an initial response, such as “Caution: Construction ahead.” The context handler 126 then refines this response by integrating additional contextual information, such as the distance to the construction zone, current traffic congestion, and availability of alternate routes. For example, if the vehicle is approaching a construction zone and traffic data indicates heavy congestion, the context handler may modify the SLM's 120 output to include actionable recommendations, such as “Construction ahead with heavy traffic. Consider taking the next exit.” The context handler achieves this by issuing a command to the SLM, instructing it to adjust the tone, urgency, or content of its response. Messages exchanged between the SLM and context handler include both raw environmental data and higher-level contextual metadata, ensuring the adaptation is timely and accurate. The adapted response is then transmitted to the vehicle's infotainment system, where it is displayed visually on the interface or delivered audibly through the speaker system.

In an alternate example, the context handler enables the SLM to retain short-term memory of recent interactions. When a driver asks about road conditions and follows up with “What's the traffic like ahead?” the context handler helps the SLM understand the relationship between these questions, providing coherent and contextually relevant answers that align with the ongoing conversation. This situational memory makes the interaction feel natural and reduces the need for the driver to repeat details, allowing for a more intuitive in-car experience.

The handlers 122, 124, and 126 may create output texts through the use of tokens 128, which are used by a combo output 130 and shown as captions to a natural language interface 136.

Tokens 128 are fundamental to how both the SLM 120 within the vehicle and the LLM 152 in the cloud processes and understands language. Tokens represent the smallest units of language—such as words or sub-words, breaking down driver commands, environmental context, or detected traffic sign text into manageable, discrete pieces. When the SLM receives driver inputs like commands or questions, it tokenizes these inputs to interpret the meaning accurately, enabling the system to provide relevant responses or actions. For example, when processing a command like “Turn on hazard lights,” the SLM splits the command into tokens (“Turn,” “on,” “hazard,” “lights”) to understand the intended action. Tokens also allow the system to handle complex commands and make sense of ambiguous or context-specific terms by building a contextual representation of each token based on its surroundings. Additionally, tokens facilitate communication between the SLM and the LLM by enabling efficient, structured data transfer, allowing the vehicle model to send processed tokens to the cloud-based model for more complex, resource-intensive analysis or to receive enhanced responses. This token-based structure supports a wide range of ADAS functions, from understanding traffic sign variations to responding to driver queries, by ensuring language processing is both efficient and accurate across the system.

In another example of the instant solution, the handlers 122,124, and 125 within the system generate tokens 128 that encapsulate specific pieces of data, such as traffic information, detected road signs, vehicle state (e.g., speed or state-of-charge), and environmental conditions (e.g., weather or road surface). These tokens 128 may be combined into a unified output, ensuring that all relevant data is aggregated into a single, streamlined package. When the tokens 128 are sent to the LLM 152 through the combo output 130, the system simplifies the communication process, reducing complexity and improving the LLM's 152 ability to process and analyze the input effectively.

Combo output 130 generates captions for the Natural Language Interface, providing the driver with visual or audio cues that describe the current driving situation or system status. For example, when the system recognizes a traffic sign, it might display a caption such as “Speed Limit 40 mph” or “Yield Ahead” on the dashboard. These captions are concise, accessible, and presented in everyday language to ensure the driver can quickly understand and act on the information. When the system encounters more complex queries or contextual requirements beyond the SLM's 120 capability, Combo output 130 sends these requests to the LLM 152 in the cloud. The LLM uses its extensive training and computational power to interpret nuanced queries, provide in-depth explanations, and generate detailed responses. For example, if the driver asks a question like “Are there any gas stations along the route?” Combo Output 130 routes this query to the LLM, which retrieves the information and sends a relevant, contextually enriched answer back to the vehicle utilizing external data sources and/or data from other vehicles, in one example. Combo output 130 leverages retrieval-Augmented generation (RAG) to access real-time, external information sources, providing answers that are up-to-date and contextually tailored. In cases where the driver's question requires immediate external data, such as “What's the weather at my destination?” or “Is there traffic on Route A?”, combo output 130 directs the query to RAG 132 and the RAG database 134, which retrieves pertinent information from external databases or live feeds and incorporates it into a coherent response. In another instant solution example, multiple questions may be provided by one or more of the vehicle's occupants or by the vehicle itself. The second question may originate from a different entity than the entity that asked the first question. For example, the vehicle asks the first question, and an occupant asks the second question.

The Natural language interface (NLI) 136 in the ADAS system serves as a crucial component that enables intuitive communication between the driver and the vehicle's AI systems. It facilitates the interaction in a way that feels natural and user-friendly, allowing drivers to engage with the vehicle's functions without needing specialized technical knowledge. The NLI allows occupants to provide inputs through both voice commands and text-based interactions. This flexibility ensures that users can communicate with the system in their preferred manner, whether they are asking questions, issuing commands, or seeking information about the vehicle's status. Using natural language processing (NLP) techniques, the NLI 136 interprets the meaning behind driver inputs by analyzing the tokens and context of the requests. This capability enables the system to understand not just the specific words used but also the underlying intent. For example, if a driver says, “I need to slow down,” the system interprets this as a request to reduce speed based on the current driving conditions. Upon receiving a command or query, the NLI generates appropriate responses that are clear, concise, and relevant to the situation. For example, if a driver asks about upcoming traffic signs, the NLI can respond like, “There's a stop sign ahead; prepare to stop.” This ability to generate context-aware responses enhances the driver's situational awareness. The processing of the output from the server (such as via the LLM output 162) through the NLI 136 ensures that the vehicle interprets and acts upon the response in a manner that is both timely and contextually appropriate.

In the instant solution, the Q&A functionality is managed by a cloud-based LLM 152, which performs several key roles to enhance driver assistance, situational awareness, and overall vehicle intelligence. When drivers ask questions—whether related to the current driving conditions, vehicle status, or specific ADAS functionalities—the vehicle SLM 120 forwards these queries to the cloud-based LLM 152 when they require more complex processing.

The LLM, with its greater computational power and extensive training, interprets the query, processes it, and generates a clear, accurate response, which is relayed back to the driver through the vehicle's display or audio interface. Providing contextual and detailed answers: The cloud-based LLM can draw on a vast range of data to provide contextually relevant and detailed answers that the SLM 120 in the vehicle might not be able to handle independently. For example, if a driver asks, “Is there a faster route?” or “What's the weather like at my destination?” the LLM accesses relevant databases or external sources, processes the data, and responds with precise information tailored to the driver's situation. The cloud system, where the off-vehicle LLM resides, may collect and store data from multiple vehicles, such as in a RAG database 166, enabling it to learn from a broad dataset that includes diverse driving conditions, traffic patterns, and driver behaviors.

Chain-of-Thought Reasoning 154 may be used by the instant solution when sending output from the LLM 152 to features 156, 158, and 160. Using chain-of-though reasoning, the response sent by the server (such as via the LLM output 162) is thoroughly examined and tailored to the specific needs of the user or the current situation. Chain-of-thought reasoning is a technique in language models that enhances the model's ability to solve complex problems by breaking down tasks into a series of intermediate, logical steps. Instead of providing a direct answer, the model processes each part of the question or task sequentially to build toward a comprehensive answer. This approach helps the model clarify complex questions, make accurate inferences, and draw upon relevant context, useful in multi-step reasoning tasks. In the instant solution, data from the LLM 152 leverages chain-of-thought reasoning to provide contextual, accurate information to various in-car features like ADAS features 156, infotainment features 158, and other features 160. For driving assistance tasks, the LLM uses chain-of-thought reasoning to interpret complex commands and make real-time safety suggestions. For example, if the driver asks, “Can I safely take the next exit given the current speed?” the LLM breaks down the query by considering speed, nearby traffic, and road conditions. The model outputs a logical, step-by-step assessment (e.g., slowing down, preparing for merging) to the ADAS features, which translates this reasoning into actionable guidance for the driver, such as displaying a prompt to reduce speed or suggesting lane changes. When handling infotainment requests 158, such as finding a nearby restaurant with a particular cuisine, the LLM uses chain-of-thought reasoning to process the driver's preferences, location, and availability of options. For example, a query like “Are there any Italian restaurants with outdoor seating nearby?” prompts the LLM to consider location, type of cuisine, and seating preferences in a structured sequence. It retrieves suitable options, synthesizes this information, and provides a list of infotainment features that can be displayed on the screen, offering suggestions aligned with the driver's preferences. For additional features 160, like route planning, weather updates, or setting reminders, the LLM uses chain-of-thought reasoning to break down multi-part questions into actionable steps. For example, if the driver asks, “How's the weather along my route, and should I refuel before reaching my destination?” the LLM first retrieves weather data and assesses fuel needs based on route distance and fuel efficiency. The output is directed to other features 160, where the system might display a suggested refueling stop on the map or alert the driver to upcoming weather changes, thus improving the decision-making experience.

The LLM output 162 serves as the central interface between the LLM 152 and various in-car systems, enabling it to process inputs from different features and distribute tailored responses or updates to specific components in the vehicle. The LLM output 162 receives input from ADAS features 156, related to driving assistance; the infotainment features 158, and other features 160. Input from infotainment features 158 may involve user-specific requests, like restaurant recommendations, music selections, or destination searches. These inputs allow the LLM to handle natural language commands, disambiguate user preferences, and deliver responses tailored to enhance the entertainment and convenience aspects of the vehicle. Additional inputs might include information for navigation, weather inquiries, or reminder settings. The LLM uses this data to generate responses that integrate multiple data points (e.g., road conditions, destination details), helping the system offer dynamic, multi-faceted assistance.

When the LLM encounters queries or commands that may require real-time external information, such as current traffic, live weather updates, or points of interest, the LLM output 162 directs these requests to the RAG 164/166 module. RAG retrieves up-to-date information from external databases or APIs, enabling the LLM to incorporate real-world data into its responses. The RAG-enhanced output sent into the LLM Output 162, allows the system to deliver accurate, context-aware answers that reflect real-time conditions. When the LLM processes a command or question and generates a response, the output is directed to the NLI 136 within vehicle 110. The NLI is responsible for presenting the response to the driver, either visually on the dashboard or via voice prompts, depending on the context. For example, if the driver asks for route options, the LLM processes the request, and the NLI displays the response as a list of routes with estimated times.

Based on aggregated interactions and learning from diverse vehicle data, the LLM can periodically improve its capabilities and those of the vehicle SLMs by sending model updates to the updated models 168 component of the instant system. These updates may include refinements in language understanding, improved recognition of regional traffic patterns, or enhanced response templates for common queries. Updated models 168 distribute these improvements to the SLMs across vehicles, ensuring that each system remains current and can handle an evolving set of commands or scenarios without needing constant cloud access.

In the instant solution, contextual interaction, contextual embeddings, and semantic associations are implemented within the SLM 120 to enhance its understanding and adaptability, enabling it to interpret ambiguous signs and respond effectively to driver queries. The SLM 120 is designed to handle ongoing interactions with the driver, allowing them to ask follow-up questions for clarification or additional details. For example, when the system alerts the driver about a detected school zone, the driver could ask, “What's the speed limit here?” The SLM, with its conversational memory, understands this follow-up in relation to the initial alert and provides an accurate answer without needing the driver to repeat the context. The SLM 120 uses language that avoids technical jargon, ensuring responses are clear and easy for non-expert drivers to understand. Instead of complex explanations, the SLM offers straightforward responses like “Slow down; school zone ahead,” making it intuitive for drivers to follow the guidance without confusion. Contextual embeddings allow the SLM 120 to derive meaning from the surrounding context of words and phrases. When the system encounters a potentially ambiguous traffic sign or term, it uses contextual clues from nearby text or visual indicators, such as via sensors on vehicle 110, to interpret the sign accurately. For example, if a sign says, “School Zone Ahead,” the SLM uses context to understand that this typically implies a reduced speed limit, even if the exact speed limit is not explicitly stated.

The SLM 120 encodes semantic relationships between related traffic signs or commands. It understands that certain signs, like “yield” and “stop,” are associated with caution and the need to reduce speed or halt. By establishing these relationships, the SLM interprets signs accurately even when their design or text varies slightly. For example, if a stop sign appears in a unique format or font, the SLM can infer its meaning based on the recognized shape and color, as well as its association with the concept of stopping. When faced with a less common or modified sign, the SLM 120 can infer its meaning based on learned associations. For example, if it encounters a new type of yield sign with a different text or layout, the SLM's understanding of semantic relationships allows it to correctly identify it as a cautionary instruction, prompting the driver to yield as intended.

In the instant solution, common patterns allow the SLM to enhance its ability to recognize and interpret traffic signs accurately, even if they are unfamiliar or vary in design. This functionality allows the SLM to generalize from past experiences and data, using learned patterns to make informed predictions about new or ambiguous signs. The SLM 120 is trained on a wide range of traffic sign images and related data from different regions, contexts, and driving environments. This data includes a variety of common signs with different shapes, colors, and symbols, as well as signs with slight variations in design (e.g., font styles or language differences). Through this training, the SLM identifies recurring patterns, such as the use of red circles for prohibitory signs (e.g., “No Entry” or “No U-Turn”) or triangular shapes for warning signs. These patterns become embedded in the SLM's model, forming a basis for recognizing sign types even when they deviate slightly from the standard appearance. When the SLM 120 encounters a sign, it analyzes its features, such as shape, color, and symbols, and matches these features against its learned patterns. For example, if it detects a red circular sign with a diagonal line, it can classify this as a prohibitory sign even if the text or specific symbol is unclear. This recognition process is not limited to exact matches. Instead, the SLM uses its understanding of patterns to make close predictions based on similar elements. If a new type of speed limit sign has an unusual font but retains the familiar round shape and numeric indicators, the SLM can still classify it as a speed limit sign due to these common attributes. In cases where the SLM 120 encounters a completely unfamiliar sign, it uses its learned patterns to make educated guesses. For example, if it sees a triangular sign with a bold symbol in the center, it may infer that it is a warning sign based on the common pattern of using triangles for warnings.

The instant solution uses few-shot learning, which is a capability within the SLM 120 that enables it to perform accurately on new or ambiguous traffic signs, even with minimal prior examples. This few-shot learning approach enhances the SLM's adaptability and efficiency, allowing it to respond to unfamiliar situations by leveraging context and previously learned knowledge. Unlike the LLM 152, the SLM 120 is designed with a smaller number of parameters to operate efficiently within the vehicle's hardware constraints. However, few-shot learning compensates for its smaller scale by quickly learning from limited examples without needing extensive data or resources. Few-shot learning allows the SLM to generalize from a small set of examples and apply these insights to new, similar situations, making it both efficient and versatile in real-time driving contexts. When the SLM 120 encounters an unfamiliar or ambiguous sign, it converts the interpretation task into a cloze question or fill-in-the-blank format. For example, if it encounters a partially obstructed speed limit sign that reads “Speed Limit ______ mph,” the SLM frames the problem as “What speed limit should be here?” By creating a cloze-style question, the SLM can use its contextual understanding to predict the missing or unclear information, filling in the “blank” based on its knowledge of standard speed limits or expected values in similar contexts. Few-shot learning relies heavily on context. The SLM 120 uses contextual clues from the surrounding environment or text to interpret the ambiguous sign. For example, if the SLM sees a partially visible “School Zone” sign, it draws on prior knowledge that school zones generally imply a lower speed limit, enabling it to suggest an appropriate response like slowing down. Additionally, by referencing previous examples stored in its memory, the SLM can recognize patterns even with minimal data, helping it deduce the likely meaning of a sign based on related, learned examples (e.g., recognizing a faded yield sign due to its triangular shape and proximity to an intersection). The SLM 120 may employ gradient-based optimization techniques to adjust its responses based on a few available examples. When new data points or sign types are introduced, the model adjusts its parameters to incorporate these examples without requiring retraining.

The LLMs 152 work collaboratively with SLMs 120 embedded in vehicles to enhance in-car functionalities and performance. This distributed approach balances real-time responsiveness with complex processing capabilities by leveraging both on-device and cloud-based resources. The vehicle SLM 120 handles latency-sensitive tasks that require immediate responses, such as basic voice commands, simple natural language interactions, and direct control over vehicle functions, such as adjusting settings, initiating safety alerts, or navigating menus. The SLM 120 is optimized for speed and efficiency, ensuring that tasks critical to real-time driving are managed quickly without relying on cloud latency. For tasks that are computationally intensive or require a higher level of language understanding, the SLM 120 forwards queries to the cloud-based LLM. The LLM, which has significantly more computational power and training, processes complex data and sends back refined results to the vehicle. For example, if a driver asks a multi-layered question like “What's the best route to avoid traffic given the weather forecast?” the LLM performs the analysis using broader data sources and returns an informed response to the vehicle. The LLM 152 provides a deeper and more nuanced understanding of language, which is particularly valuable in complex or ambiguous scenarios where the SLM 120 might struggle. The LLM can disambiguate commands and interpret context-heavy interactions by considering factors like driving context, recent dialogue history, and vehicle status. For example, if a driver asks, “Can I make it to the next gas station?” the LLM understands the intent behind the question and may consider fuel levels, distance, and traffic to provide a meaningful answer. LLMs can retain a conversational history over extended dialogues, enabling contextually coherent interactions. If a driver asks multiple related questions (e.g., “How's the traffic on Route A?” followed by “And Route B?”), the LLM remembers prior interactions and provides responses that build on previous answers. This memory helps maintain a fluid, contextually aware conversation, enhancing the overall user experience by making the system appear more intuitive and responsive.

Updated models 168 allow the cloud-based LLM 152 to periodically update and enhance the vehicle SLMs 120, ensuring that each vehicle remains equipped with the latest language understanding and processing capabilities without requiring extensive local resources. The cloud-based LLM 152 aggregates and analyzes data from multiple vehicles, which may be from the RAG 166, in various driving environments. This continuous learning allows the LLM to identify new patterns, adapt to emerging language trends, and refine its ability to interpret complex or ambiguous queries. For example, if drivers frequently ask about specific road conditions or use certain regional phrases, the LLM learns to handle these nuances more effectively. The LLM also leverages this aggregated data to improve the handling of context, semantic associations, and common driving scenarios, making it more robust in providing accurate responses across a broad set of use cases. Based on the improvements made in the LLM, updated models or refined capabilities are periodically packaged and sent to vehicle SLMs 120. These updates can include new language patterns, enhanced recognition of specific traffic signs, optimized responses, or new conversational abilities that improve the SLM's performance. Updates may be transmitted to each vehicle over-the-air (OTA), enabling seamless integration without the need for physical maintenance. The OTA delivery system ensures that updates are lightweight and can be installed quickly, maintaining the vehicle's operational continuity while applying enhancements in the background. Once received, the updated SLM model integrates the new capabilities, allowing it to function with improved accuracy and responsiveness. For example, an update might improve the SLM's 120 ability to recognize evolving road signs or interpret regional dialects, which enhances its adaptability in diverse driving conditions. With updated models, the SLM 120 in each vehicle can handle a wider range of real-time tasks independently, reducing its reliance on the cloud for certain types of queries or commands and allowing the SLM to manage latency-sensitive tasks more effectively while still having access to the LLM for more complex or resource-intensive requests. Each time the SLM 120 is updated, it may reflect the latest collective intelligence gathered from all connected vehicles, making it more adaptive to real-world driving needs.

FIG. 1B is another network diagram 100B of the instant solution, according to example embodiments. Sensors 104B in the vehicle 102B include various hardware components designed to capture real-time data from both the vehicle's surroundings and its internal systems. These sensors may include camera and associated sensors that provide data of the environment, such as road signs, objects such as construction barrels, lane markings, traffic lights, pedestrians, other vehicles, and the like, which are crucial for the first AI model 110B to interpret the environment accurately. Lidar and radar sensors offer depth perception, allowing the vehicle to detect objects, measure distances, and identify potential obstacles, which aids the AI model in assessing safe navigation paths. Other sensors 104B, such as microphones, audio sensors, and or other vehicle sensors, detect environmental sounds like emergency vehicle sirens or vehicle honks, allowing the AI model to incorporate auditory signals into its situational awareness, where the situational awareness is associated with the environment of the vehicle determined by analysis of the data from the sensors on the vehicle. Weather sensors, which monitor conditions such as rain, fog, temperature, and humidity, provide data that may assist the AI model in adjusting its interpretations of visual cues, taking visibility into account. GPS and location sensors provide geographic data, enabling the AI model to correlate road signs and conditions with specific locations. Vehicle diagnostic sensors monitor internal parameters like speed, acceleration, braking, and battery state-of-charge (SOC), allowing the AI model to consider the vehicle's operational status when generating responses.

Data is transmitted from the sensors 104B to application 108B, where the first AI model processes the data to generate contextual information related to detected objects, such as road signs. For example, the contextual information may alert or inform the vehicle to slow down to a particular speed when one or more orange construction barrels are determined to be on the road. The object may be stationary, such as a construction barrel, or the object may be in motion, such as an orange vest and/or hat worn by a construction worker.

The display 106B in the vehicle is a user interface component designed to present information, alerts, and guidance to occupants of the vehicle 102B. Positioned within the vehicle's dashboard or integrated into the central console or other locations, the display is configured to enhance occupant awareness by delivering visual feedback from the application 108B. This display can support various formats, including text, graphical elements, icons, video feeds, and maps. For example, it may present interpreted data about detected traffic signs, such as speed limits, stop signs, or lane restrictions, by displaying clear, and/or easy-to-understand symbols. The display may incorporate icons and/or visual alerts to indicate urgent warnings.

The display 106B can be a touchscreen, allowing for direct user interaction and enabling a driver and/or passengers to input queries, change settings, or respond to prompts. The display may have voice-command capabilities, enabling it to provide multimodal interaction that reduces the need for manual operation while driving. The display can adjust its content based on context, such as prioritizing urgent safety messages over routine notifications. In certain examples, the display may include a heads-up display (HUD) functionality, which projects information directly onto the windshield to maintain the driver's focus on the road.

The application 108B in the vehicle serves as a software component that manages the AI processing and user interactions related to driving assistance. It is stored in the vehicle's onboard computer system, which may include a dedicated electronic control unit (ECU) or an integrated infotainment system. The instant solution's software is executed by a processor within the vehicle, which interacts with the first AI model 110B.

The instant solution processes the query within a short time window (e.g., 5-10 seconds) from the initial information display to infer that the question pertains to the displayed content. This temporal association enables the system to identify the context without requiring detailed input from the user. By leveraging natural language processing, the system deciphers ambiguous queries and maps them to the topic, such as the need for additional details about the detected sign or related traffic conditions.

The vehicle 102B creates a query through a process that involves data collection, contextual analysis, and query formulation. The generation of a query begins with the vehicle's sensors 104B, such as cameras, radar, Lidar, and environmental sensors, capturing real-time data. For example, cameras detect a road sign and capture its visual content, such as text, shape, color, or symbols; weather sensors collect environmental data, like temperature, rain, or fog conditions and/or vehicle diagnostics provide operational data, such as speed, SOC, or braking patterns. This data forms the input for creating the query. The first AI model 110B, embedded in the application 108B within the vehicle, processes the sensor data to extract meaningful information. This information may include the recognition of the type of sign (e.g., speed limit, warning, or directional sign) and its specific details, assessing the vehicle's current conditions, such as location, time of day, speed, and weather, to determine the relevance of the sign's message, and determining whether the sign's message requires further clarification or immediate action based on its content and the current driving context. For example, a speed limit sign may require verification if the sign is partially obscured or if adverse weather conditions could alter its meaning.

The first AI model, 110B, combines the extracted information into a structured format, referred to herein as “contextual information.” The contextual information may include sign data such as the type of sign, text, or symbols, and any visual anomalies (e.g., partial visibility), environment data such as weather conditions, road surface status, or visibility issues, the vehicle's 102B status such as a current speed, direction, and SOC, and the surrounding traffic, including data about nearby vehicles'movements, when available. The instant solution formulates a query by combining the contextual information with a specific request for interpretation or guidance. In one example of the instant solution, the query is designed to address any uncertainties or ambiguities identified during the initial analysis. For example, when the sign is partially visible, the query may ask: “Detected a partially visible speed limit sign with text ‘35’. Is this accurate under current conditions?” When the sign's relevance depends on environmental factors, such as a school zone sign, the query might be: “School zone sign detected. Does the speed limit of 25 mph apply at 3:00 PM on a rainy day?”

Before sending the query, the system evaluates whether the first AI model 110B can handle the request or if the query should be forwarded to a second AI model 126B on the external server 124B for advanced processing. This decision may be based on the complexity of the contextual information, as assessed by predefined thresholds (e.g., poor visibility or ambiguous sign content may warrant external processing). When the query requires additional analysis, it is packaged with contextual information and sent to the second AI model 126B on the external server 124B via network 122B. The query includes all relevant data in a structured format, ensuring that the server has sufficient context to perform accurate and efficient processing.

When vehicle 102B creates a query, it relies on a hardware components to capture, process, and transmit data. Sensors 104B, such as cameras, capture images or video of road signs, lane markings, and surrounding conditions. These sensors provide the primary data used for detecting and identifying road signs.

In another example of the instant solution, the system assesses the meaning of the received query based on past correspondence, such as previous interactions with the occupant. For example, if the user previously requested detailed speed limit information when a similar query was made, the system can infer that a one-word query like “more” refers to providing extended data on the current sign. The past correspondence may be stored in memory in the vehicle and/or may be stored in a database coupled to the external server 124B.

The first AI model 110B is associated with the application 108B, which may include an embedding of the AI model within the application 108 facilitating integration and interworking with the vehicle's sensor data and processing capabilities. This AI model operates as a core functionality of the application, enabling it to process queries related to road signs and generate contextual information based on sensor inputs, such as visual data from cameras, audio signals from microphones, and environmental data from sensors, such as weather sensors. The application may act as an intermediary between the AI model and the vehicle's other systems.

The processor that executes the software in the application can include automotive-grade central processing units (CPUs), graphics processing units (GPUs), or specialized neural processing units (NPUs) that support AI operations. These processors may perform certain tasks, such as managing the computational load of the AI model, running inference tasks that involve interpreting sensor inputs, generating real-time responses, and sending data to the second AI model located on external servers for further processing when necessary.

The AI model is interworked with the application, allowing it to leverage the application's data management, communication, and user interface functions. For example, the application receives raw data from the sensors, preprocesses it, and sends the data to the AI model for interpretation. The preprocessing of the data may involve normalization, anonymization, missing value imputation, or noise reduction to allow the data to be further used effectively. The AI model's output is used by the application to generate responses, issue alerts, or guide the driver. The application also manages the transmission of data between the first AI model and the second AI model located on a server outside the vehicle, ensuring continuity of processing and response generation.

The network 122B in the system diagram is a communication framework that facilitates data exchange between vehicle 102B, external servers 128B, and the second AI model 126B, which is hosted on a server deployed outside vehicle 124B. This network is designed to handle both internal and external communication, ensuring seamless integration of vehicle systems with cloud-based processing resources. The network 122B may be referred to as a cloud in some examples. A cloud is a network of computing services, such as servers, storage, databases, networking, software, analytics, and intelligence, over the internet.

The network 122B extends connectivity beyond the vehicle to enable communication with cloud servers and off-vehicle AI models. This external communication may leverage wireless technologies such as cellular networks (e.g., 4G, 5G), Wi-Fi, or dedicated short-range communication (DSRC) for Vehicle-to-Infrastructure (V2I) communication. The network allows the vehicle to send data to and receive data from the second AI model 126B on the external server 124B, which performs more complex processing tasks and generates detailed responses. The network 122B may support secure data transmission, incorporating encryption protocols to protect data integrity and ensure privacy during communication. It is designed to handle high bandwidth demands for large data transfers, such as images or detailed contextual data while maintaining low latency to ensure timely responses from the AI models.

The external server 124B may be a computer with a processor and a memory located outside the vehicle, responsible for handling complex data processing tasks that go beyond the capabilities of the vehicle's onboard systems. In one example, the external server hosts the second AI model, 126B, which is designed to perform advanced analysis, deep learning inference, and natural language processing on data received from vehicle 102B. The external server 124B serves as a computational resource, complementing the vehicle AI model by managing detailed and resource-intensive processing tasks.

The second AI model 126B, integrated into the external server 124B, handles diverse inputs from the vehicle, such as contextual information generated by the first AI model 110B and raw data from sensors 104. The server receives this data through the network 122B, enabling it to conduct a thorough analysis and generate responses. The second AI model 126B may apply more sophisticated AI techniques, such as deep learning models, natural language understanding, and complex reasoning algorithms, to enhance the vehicle's interpretation of objects, such as road signs, traffic conditions, and environmental data allowing the second AI model to offer more comprehensive guidance, recommendations, or alerts that are sent back to the vehicle.

The external server 124B may interact with other servers 128B that may be connected via the network 122B. These other servers may include various cloud-based systems, such as traffic management databases, weather information services, map updates, or collaborative AI models from other vehicles. The interaction between external server 124B and servers 128B involves receiving additional contextual data, such as updated traffic patterns, weather alerts, or route recommendations. This exchange of information allows the second AI model 126B to refine its analysis, incorporating broader datasets and external intelligence to improve its output. The external server 124B can request additional data from these other servers based on specific processing needs, such as retrieving up-to-date traffic information to assess better a current route or obtaining real-time weather conditions to adjust guidance related to visibility or road traction.

In another example of the instant solution, the system interprets road signs and provides contextual information using a two-stage AI processing system/model (a first AI model 110B within the vehicle 102B and a second AI model 126B on an external server 124B). In an alternate example, one AI model may be present in the system in either the vehicle or the cloud. In another alternate example, both AI models may reside on vehicle 102B, and both AI models may reside on external server 124B. A query related to a road sign 120B is generated within the vehicle 102B which is initiated by the sensors 104B detecting an object, such as a sign 120B. In an alternate example, the query originates from an occupant of vehicle 102B (e.g., the driver asking about a specific sign).

In an alternate example, the application 108B determines the query. The query is processed by the first AI model 110B within the vehicle 102B. The first AI model 110B analyzes the query by using data from the sensors 104B, such as visual data from cameras or auditory signals from microphones. It generates contextual information related to the sign, such as its meaning, relevant traffic rules, or time-based restrictions. For example, if the sign indicates a school zone, the model infers that reduced speed limits may apply during school hours. The application 108B manages this processing and may communicate the contextual information to the vehicle's display 106B and send a message (such as a query) containing the original query and the contextual information for further processing by the second AI model 126B.

The vehicle's processor sends the query, along with the contextual information generated by the first AI model 110B, to the external server 124B via the network 122B, allowing the second AI model 126B to perform another analysis of the information. The message is directed to external server 124B, which hosts the second AI model 126B. The second AI model 126B performs another analysis which may be a more comprehensive analysis of the received query and contextual information. It may use AI techniques to enhance the understanding of the sign's context, which may include integrating data from external servers 128B, such as traffic databases, weather updates, or regional driving regulations, which may be provided by other servers 128B connected to external server 124B through network 122B. The second AI model 126B may request additional data from the other servers 128B B to refine its analysis. This interaction allows the model to incorporate real-time traffic conditions, road closures, or weather advisories that could affect the interpretation of the sign. The model generates a response that provides comprehensive guidance related to the query.

The second AI model 126B generates a response that may include additional data, such as guidance, recommendations, or explanations about the detected sign. For example, if the query relates to a time-based speed limit sign in a school zone, the response might indicate whether the limit currently applies, considering the time of day and traffic conditions. The response is sent back to vehicle 102B through network 122B, using the same or a similar communication channel that facilitated the original message exchange. The external server 124B ensures secure transmission of the response, incorporating any additional contextual information obtained from other servers 128B. The response from the second AI model 126B is received by the vehicle's processor, where the application 108B processes it further. Upon receiving the message from external server 124B, application 108B prepares the information for display or audible feedback, ensuring that the response is presented in a user-friendly manner, either through visual alerts on the display 106B or via the infotainment system's audio output, depending on the urgency and relevance of the information. In another example of the instant solution, the information may be presented in the vehicle (via displayed text or audibly) before a change is to take place. For example, the system knows that the speed limit will change in a distance, such as 1/4 mile. The system determines the current speed of the vehicle, and before reaching the sign, the information presented may be “The speed limit will change to 60 mph in the next 15 seconds, lower your speed.”

In another example, application 108B may deliver the response to display 106B in the vehicle, providing real-time guidance to the driver. If the response requires immediate action, such as slowing down for a school zone, it may be highlighted prominently on the screen or accompanied by an audible alert to ensure the driver's attention. Communication within the vehicle is facilitated through its internal network, such as a controller area network (CAN) bus. The display 106B can present the response in various formats, such as text, icons, or heads-up display projections, depending on the vehicle's configuration and the nature of the information.

The instant solution interprets objects and environmental data to provide context-aware guidance, with the complexity of the analysis dictating where and how processing occurs. For simple signs, such as stop signs or speed limit signs, the first AI model 110B in vehicle 102B may solely interpret these signs. For example, it identifies the sign as a stop sign and immediately recognizes the universally understood instruction to stop. For these straightforward signs, the contextual information may be analyzed locally within the vehicle. The instant solution evaluates the vehicle's current conditions, such as speed and distance from the sign, and generates a response to guide the driver. The system displays the response on the in-vehicle interface, such as alerting the driver to stop at the sign or adhere to the indicated speed limit. For more complex situations, such as construction barrels that may indicate temporary lane shifts or hazards, the system captures this data using the sensors 104B. The system transmits contextual information, such as the location, the arrangement of barrels, and any relevant environmental conditions, to a second AI model 126B on external server 124B. The second AI model performs a detailed analysis of the environment (e.g., the barrel configuration). It may identify patterns, correlate them with known construction site layouts, and determine the appropriate guidance for the driver, such as lane merging or reduced speeds. The server may incorporate additional data, such as traffic patterns or live updates from nearby vehicles.

In another example, when the system detects a speed limit sign that indicates a change in speed, the second AI model may assess the broader traffic patterns associated with the change. The server may leverage a traffic pattern model (such as via interaction with other servers 128B, to predict the effect of the speed limit change on the surrounding traffic flow. For example, it analyzes whether vehicles are slowing down before the sign or accelerating after passing it. The system uses this analysis to determine the optimal time to notify the driver. For example, it may delay the notification if the traffic model predicts a bottleneck or issue further down the road. Conversely, it may prioritize the notification if immediate action is required, such as decelerating for an upcoming curve. Based on the server's analysis, the system generates an appropriate notification, such as, “Reduce speed to 45 mph in 300 feet” or “Prepare to merge left due to construction.”

In another example of the instant solution, the application 108B may execute the entire instant solution on a processor in vehicle 102B or a portion of the instant solution, where the remaining portion of the instant solution executes on a processor associated with the external server 124B. Whether to send the query and contextual information to the second AI model on the external server may be based on the complexity of the contextual information, which is assessed relative to a predefined threshold. This predefined threshold may be stored in memory associated with the processor executing the instant solution. For example, the vehicle's 102B sensors 104B, such as cameras and weather sensors, detect a road sign 120B and capture data related to its visibility and environmental conditions. When the sign is partially obstructed, blurred, or affected by weather conditions such as rain, snow, or fog, the instant solution flags the visibility as minimal. The first AI model 110B within vehicle 102B processes the initial data and determines the contextual complexity of interpreting the sign. The first AI model 110B evaluates the complexity of the contextual information generated based on factors such as when the sign is fully visible and easy to interpret, the complexity is low, and the system processes it locally. During inclement weather, such as fog or heavy rain, the complexity is raised as visibility and sign readability are reduced. When the sign is faded, damaged, or contains ambiguous symbols or text, the complexity is higher. When the vehicle detects the sign from a significant distance under minimal visibility, the system anticipates the need for additional processing and raises the complexity.

The system compares the calculated complexity of the contextual information against a predefined threshold. When the complexity is below the threshold, the first AI model 110B processes the query entirely within the vehicle, providing a fast and localized response. If the complexity exceeds the threshold, indicating that the sign's interpretation requires additional resources or data, the system involves the second AI model 126B executing in an external server 124B. For high-complexity cases, such as when visibility is poor, or the sign is ambiguous, the system sends the query and contextual information to the second AI model 126B on the external server 124B via the network 122B. In another example, the contextual information includes details about the detected sign, environmental conditions, and any preliminary analysis performed by the first AI model 110B. The second AI model 126B on the external server 124B performs a more analysis, using broader datasets and advanced AI techniques. For example, it may compare the partially visible sign against a database of potential matches or incorporate additional environmental data, such as weather forecasts or nearby traffic patterns, to improve accuracy. When the server completes the analysis, the refined response is sent back to the vehicle. This response includes detailed insights or recommendations, such as the sign's inferred meaning, actions the driver should take, and/or alternative navigation guidance in case of uncertainty. The vehicle's application 108B processes the response and delivers it to the vehicle through the display 106B. For example, if the system determines that the detected sign is a speed limit sign partially obscured by rain, it may present the likely speed limit along with a cautionary note about the visibility.

In another example of the instant solution, contextual information is generated by integrating environmental data collected by the vehicle's sensors 104B with the interpretation of a detected road sign 120B. This process allows the system to provide actionable and context-aware guidance based on both the sign's message and the current driving conditions. The sensors 104B on the vehicle 102B, such as cameras and weather sensors, detect a road sign and collect associated environmental data. For example, a camera captures the visual content of a sign that reads, “Bridge may be icy in cold weather,” while a weather sensor simultaneously measures the outside temperature. The instant solution, in conjunction with the first AI model 110B, analyzes the captured sign and recognizes its message. It cross-references this information with the environmental data collected by the sensors to determine whether the sign's warning is relevant under the current conditions.

In another example of the instant solution, the system assesses real-time traffic conditions and driver behavior to determine the optimal driving lane and facilitate vehicle actions such as lane changes and speed adjustments. The vehicle's sensors, including cameras, radar, and Lidar, detect and monitor traffic in each lane, calculating the average speed and density of vehicles. This data is processed by the first AI model 110B to identify lanes that align with the driver's preferences and current traffic flow. The system analyzes the driver's historical behavior, such as their typical speed relative to limits, lane preferences, and responsiveness to traffic changes, to customize recommendations. The historical behavior may be obtained from local data on vehicle 102B or from an external server 124B. The system evaluates each lane, factoring in traffic patterns and individual driving characteristics, and recommends a most efficient and/or comfortable lane. For autonomous functionality, the processor triggers a lane change by identifying gaps in traffic, adjusting the vehicle's steering and speed, and using advanced driver-assistance systems (ADAS) to execute the maneuver safely. The system also adjusts speed dynamically to match traffic flow or maintain a safe following distance in the selected lane. The system may integrate GPS and map data to ensure its actions align with navigation needs, such as approaching exits or avoiding congestion. Before performing any action, the system may inform the occupants through visual or audio notifications, providing context for the decision and allowing manual overrides to ensure driver control.

In another example of the instant solution, the vehicle's sensors, including cameras and radar, detect surrounding traffic conditions, such as the speed and density of vehicles in each lane. The system monitors the average speed of vehicles in each lane. The first AI model 110B processes the collected data to calculate an average speed per lane. This calculation accounts for variations in traffic flow, such as faster-moving left lanes and slower-moving right lanes. Based on the analysis, the system determines which lane offers the optimal balance of speed, safety, and alignment with the driver's intended route. The system analyzes the driver's historical driving behavior (which may be stored on a memory associated with the vehicle), such as their average speed relative to speed limits, normally traveled lane (e.g., right, middle, or left), and responsiveness to traffic flow changes. The system matches the driver's typical driving style with the current traffic conditions. For example, if the driver prefers traveling slightly above the speed limit and tends to favor the middle lane, the system prioritizes recommendations for lanes that align with these preferences. In another example, the system assesses the suitability of each lane, factoring in traffic density, speed variability, and the driver's preferences. For example, if the driver prefers maintaining a steady speed, the system identifies lanes with the least variation in vehicle speeds. The system recommends the optimal lane based on the analysis, such as advising the driver to merge into the left lane to maintain their desired speed and avoid congestion. In another example, before performing a lane change or speed adjustment, the system informs the driver through the display or audio notifications, providing context for the action, such as, “Switching to the left lane to maintain optimal speed.” The driver can override the system's decisions manually, such as canceling an autonomous lane change or adjusting the speed manually, ensuring the system respects driver control when desired. The system continuously learns from real-time traffic conditions and the driver's reactions to its recommendations. This learning refines future recommendations and autonomous actions to improve accuracy and user satisfaction.

The instant solution may determine the environment of the vehicle and ascertain if the environment is related to the sign. For example, the environment may include anything that occurs regarding the vehicle, occupants, road conditions, etc. The system may determine that the sign's message is applicable based on the environment of the vehicle, such as when it is applicable only during cold weather. Using the temperature data provided by the sensors 104B, such as weather sensor, the first AI model 110B determines if the current temperature falls within a range where icy conditions are likely. When the temperature is around or below freezing, the instant solution concludes that the warning on the sign is relevant and generates contextual information to alert the driver about potential hazards on the bridge. When the temperature is above freezing, the system interprets that the warning is not immediately applicable and may choose to display a message indicating that the condition does not currently pose a risk, or the system may determine not to display any data. The contextual information generated by the system is presented to the driver via the display 106B. For example, if icy conditions are detected, the display might show a message such as, “Bridge ahead may be icy, proceed with caution.”

In another instant solution example, the second AI model 126B on external server 124B enhances its processing capabilities by applying a context-based adaptor that aligns with the current condition of vehicle 102B. These adaptors are modular enhancements tailored to specific scenarios, enabling the AI model to refine its analysis and generate responses that are highly relevant to the vehicle's situation. The vehicle's 102B first AI model 110B detects a road sign 120B and generates contextual information, such as the type of sign, its content, and relevant environmental data (e.g., weather, road conditions) when the contextual information indicates a complex or condition-specific scenario, such as icy roads, heavy traffic, or a low SOC. The contextual data is transmitted to the second AI model 126B on the external server 124B via the network 122B. The second AI model 126B identifies the current condition of the vehicle using the contextual information. For example, if the contextual data indicates inclement weather or a low SOC, the model may select an appropriate context-based adaptor designed for that scenario. This adaptor might include algorithms, datasets, or processing rules specifically optimized for interpreting data under the detected condition. For example, for inclement weather, the adaptor might enhance the second AI model 126B ability to interpret partially obscured road signs or assess the risk level of hazardous driving conditions. For a low SOC, the adaptor might prioritize interpreting signs related to charging stations or generating route recommendations to nearby stations.

The context-based adaptor dynamically adjusts the AI model's focus and processing logic. Once the adaptor is applied, the second AI model 126B processes the query and contextual information, incorporating both the vehicle's 102B real-time data and additional insights from external datasets (e.g., traffic conditions, weather forecasts, or map data). The model generates a detailed response tailored to the vehicle's condition and transmits it back to the vehicle 102B. For example, when the vehicle is traveling in foggy conditions and encounters a partially visible sign. In that case, the second AI model might use a weather-specific adaptor to determine the most likely content of the sign and generate a response such as, “Caution: Reduced visibility ahead—fog advisory.” This response is displayed to the driver via the vehicle's interface or display 106B.

In this example, the instant solution may leverage data from other vehicles associated with the primary vehicle 102B to enhance the response generated by the second AI model 126B on the external server 124B. This functionality enables the instant solution to incorporate real-time insights from vehicles that have recently encountered the same road sign or traffic condition, creating a more comprehensive and contextually relevant response. Other vehicles on the road, particularly those traveling in the same or opposite direction as the primary vehicle, may send data to external server 124B, either through direct vehicle-to-cloud communication or via a shared network, such as network 122B. This data may include information about the vehicles'current speed, changes in speed, and observed road conditions. For example, if a vehicle has passed a “slow down” sign or encountered a backup on a highway, it may report its speed and location, along with any acceleration or deceleration events, back to external server 124B. The second AI model on the server may use this aggregated data from other vehicles to update its understanding of current traffic and road conditions around the primary vehicle.

In another example of the instant solution, vehicles traveling in the opposite direction provide information about the distance remaining until traffic flow resumes, based on where they observed speeds returning to normal, which allows the AI model(s) to assess the severity of traffic congestion and estimate how long it will last. If vehicles that have recently passed a specific sign exhibit behavior like slowing down significantly or speeding up after a certain point, the AI model incorporates these behavioral cues into its analysis. When generating a response for the primary vehicle 102B, the second AI model 126B uses this collective data to provide a context-sensitive recommendation. For example, it might alert the driver of the primary vehicle to expect a slowdown that will last for a specified distance or time and suggest an alternate route if congestion is expected to persist. The response is transmitted back to the primary vehicle and displayed to the driver via the vehicle interface or display 106B.

In another example, the instant solution integrates hazard prediction using historical data correlated with real-time contextual information. The application 108B of the instant solution is configured to access historical datasets associated with specific road segments, weather conditions, and traffic patterns. These datasets are stored either locally on the vehicle 102B or on the external server 124B hosting the second AI model 126B. When the vehicle approaches a road segment, the system compares the real-time environmental and traffic data—such as weather, visibility, and traffic density—with historical patterns stored in the dataset. For example, if a particular road segment is known for icy conditions during rain or snow or frequent accidents in low-light conditions, the system identifies these risk factors. The application, through functionality depicted herein, generates predictive alerts, such as: “High risk of reduced traction ahead due to historical icy conditions during rainfall.”

The second AI model 126B may use machine learning algorithms to refine the predictions over time, which may incorporate data shared by other vehicles traveling the same route. This process allows the system to update its predictions dynamically, improving accuracy with each iteration. Additionally, the system is configured to prioritize high-risk scenarios by integrating historical hazard data into its decision-making for route planning, sign interpretation, and vehicle control.

In another example, the instant solution incorporates collaborative traffic flow optimization functionality that allows multiple vehicles to share and synchronize data in real time to enhance overall traffic efficiency and safety. Each vehicle is equipped with a processor and communication modules that enable the exchange of real-time data, such as speed, lane position, route intentions and detected hazards. This data is transmitted via a Vehicle-to-Vehicle (V2V) or Vehicle-to-Everything (V2X) communication network facilitated through the network interface.

When the instant solution determines that the complexity is above a threshold, as depicted further herein, the instant solution employs the second AI model 126B hosted on the external server 124B to aggregate and analyze shared data from vehicles within a predefined proximity. For example, when a vehicle detects traffic congestion or hazardous conditions ahead, it communicates this information to nearby vehicles, allowing the first AI model 110B to generate coordinated guidance. The server may suggest lane changes, staggered acceleration patterns, or speed adjustments to reduce bottlenecks and improve traffic flow. For vehicles equipped with autonomous capabilities, the system triggers automatic maneuvers, such as initiating a coordinated lane change to balance lane density across a highway. For example, if the left lane is identified as over-congested while the center lane is underutilized, the system may recommend or autonomously initiate transitions for vehicles, ensuring an even distribution of traffic. Additionally, the system adjusts recommendations based on the individual driving characteristics and preferences of each vehicle occupant, ensuring that the collaborative approach aligns with personalized needs.

In another example, the instant solution includes a driver behavior training and feedback module that provides real-time and historical insights to improve driving habits. This feedback module may reside in a memory in the vehicle, such as the memory associated with the vehicle processor executing the application 108B. The application 108B, in conjunction with the first AI model 110B, monitors driver actions such as speed relative to posted limits, braking patterns, lane usage, and responsiveness to traffic conditions. The driver actions may be obtained by interaction with various processors/ECUs in the vehicle 102B, for example. This data is analyzed locally or transmitted to the second AI model 126B on external server 124B for deeper evaluation, creating a comprehensive profile of the driver's behavior. The instant solution generates feedback (via the application 108B, the first AI model 110B, the server 124B, the second AI model 126B, or any instant processor in the system) based on the analysis, highlighting areas where the driver can improve for enhanced safety, fuel efficiency, or adherence to traffic rules. For example, if the driver consistently exceeds speed limits or frequently brakes abruptly, the system may present recommendations such as “Maintain a steady speed to reduce fuel consumption” or “Increase following distance to improve safety.” The feedback may be presented on the vehicle's display 106B or provided audibly. In another example of the instant solution, to enhance engagement, the instant solution can incorporate a gamified approach by assigning scores or progress levels based on improved behaviors over time. For example, reducing sudden braking events or consistently adhering to speed limits might increase the driver's safety score. In another example, the feedback module integrates a learning component, where it adjusts recommendations based on the driver's response to previous feedback, ensuring continuous personalization.

In another instant solution example, all processing and decision-making occurs in external server 124B, meaning vehicle 102B relies entirely on external systems (servers) to generate, process, and respond to queries. The vehicle's sensors 104B collect raw data from the environment, such as images, radar data, weather conditions, and vehicle diagnostics. This raw data is transmitted to an external server via the network 122B. The vehicle itself performs no onboard data analysis or query formulation, acting primarily as a data relay system. The external server 124B, which hosts the second AI model 126B, receives the raw sensor data from the vehicle.

The second AI model 126B processes this raw data to generate “contextual information,” such as interpreting the meaning of detected road signs, assessing weather conditions, and correlating vehicle location with external factors (e.g., traffic or regional rules).

In another example of the instant solution, the server formulates a query related to the data received. For example, if the server detects a partially obscured speed limit sign, the query might be: “What is the likely speed limit at this location, given current visibility conditions?” The external server 124B sends the query to vehicle 102B via network 122B. For example, the server requests confirmation of specific vehicle parameters like speed, braking behavior, or sensor-specific details not previously transmitted. The vehicle 102B transmits the requested information back to the external server 124B, ensuring that the server has all the data to provide a refined, accurate response. The second AI model 126B integrates the query, the contextual information generated earlier, and the additional data received from the vehicle. The server may also interact with other servers 128B to retrieve supplementary data, such as real-time traffic, weather updates, or regional regulations, enhancing the depth and accuracy of its analysis.

The server generates a response using the combined data. For example, it might determine that the detected speed limit sign is “35 mph” under current visibility conditions and that the vehicle should “reduce speed to 300 feet.” The external server 124B sends the finalized response back to the vehicle 102B via the network 122B. Upon receiving the response, the application 108B within the vehicle processes the server's output and delivers it to one or more occupants via the display 106B. For example, the display might show: “Speed limit ahead: 35 mph. Reduce speed to 300 feet.”

FIG. 1C is another network diagram 100C of the instant solution, according to example embodiments. Sensors 104C in vehicle 102C capture data 120C related to an object, such as a road sign. This captured data is transmitted 122C to the vehicle processor 104C for analysis, where the processor 106C determines whether the vehicle 102C needs to take action 124C.

The vehicle's processor 106C determines the need for the vehicle to take action by analyzing the data received from the sensors 104C, which capture the visual or environmental characteristics of an object, such as a road sign. Once the data is transmitted 122C to the processor, the processor examines attributes of the data, such as the type of sign (e.g., stop sign, speed limit, construction zone), its specific content (e.g., “Speed Limit 30 mph”), and its contextual relevance based on the vehicle's current speed, trajectory, and environmental conditions, as further disclosed herein.

In another example of the instant solution, the processor 106C may use AI algorithms to detect thresholds or trigger conditions for action. These thresholds can include speed differentials (e.g., exceeding posted limits), temporal constraints (e.g., stopping within a safe distance for a stop sign), or spatial parameters (e.g., proximity to a detected obstacle). The processor may query the vehicle AI model 108C or cloud AI model (which may also be referred to as the server) for additional context, such as real-time traffic conditions or regulatory nuances for the specific location.

For example, if the sensor detects a “Stop” sign, the processor 106C may analyze whether the vehicle is approaching the intersection at a speed that would require braking to stop in time. For speed limit signs, the processor 106C may compare the current vehicle speed to the posted speed limit to determine if a reduction in speed is required. In other scenarios, such as construction zones or temporary hazards, the processor 106C evaluates additional factors like road geometry, traffic conditions, or hazard proximity. These may have been derived from real-time data inputs from the vehicle AI model 108C or the cloud AI model 110C. Based on this analysis, the processor 106C determines a recommended action, such as applying brakes, adjusting speed, or changing lanes. This decision is either autonomously executed by the vehicle 102C or conveyed to the driver through a display or audibly, depending on the vehicle's level of automation and abilities.

To aid processor 106C in determining that action is required, processor 106C may engage 126C a vehicle AI model 108C located in vehicle 102C to predict a relevant query based on the analyzed sign data, as shown in steps 128C and 130C. The processor 106C may send the predicted query 130C to the cloud AI model 110C for further analysis.

For example, a query generated by the vehicle AI model 108C could be: “What is the appropriate speed for navigating the detected construction zone ahead, considering current traffic density, road curvature, and weather conditions?” This query may arise when the vehicle detects a “Construction Zone Ahead” sign and analyzes additional inputs from sensors, such as the vehicle's current speed, lane position, and proximity to other vehicles. In another example of the instant solution, the vehicle AI model 108C send this predicted query 130C to request further contextual information from the cloud AI model 110C. Once the cloud AI model 110C processes the predicted query, the processor 106C receives a response 132C containing additional context. The cloud AI model 110C, with access to broader datasets, such as real-time traffic updates, regional road regulations, and weather forecasts, processes the query and provides a detailed response, such as “Reduce speed to 25 mph due to moderate traffic and sharp curves in the zone.”

Based on this response, the processor 106C (for autonomous vehicles) modifies the vehicle's behavior 134C, such as adjusting speed or taking another action to ensure safe and efficient navigation, or (for non-autonomous vehicles) present a message on a display of the vehicle.

When the vehicle processor 106C receives a response 132C from the cloud AI model 110C, it may initiate steps to translate the response into actionable changes for the vehicle, ensuring that the vehicle adapts its behavior to maintain safety, efficiency, and compliance with road conditions. The context received 132C from the cloud AI model 110C provides the vehicle's processor 106C with detailed, real-time information that enhances decision-making capabilities beyond the scope of the vehicle. This context may include information, such as insights into current traffic conditions, such as congestion levels, lane closures, traffic bottlenecks, etc., allowing the processor 106C to adjust speed or recommend lane changes for optimal navigation. It may also include information about road geometry and hazards, such as sharp curves, steep gradients, or temporary obstructions, enabling the vehicle 102C to adapt to challenging environments. Weather and environmental data, such as icy roads, heavy rain, or fog, may also be factored into the response to assist the vehicle in operating under safe parameters based on prevailing conditions. The cloud AI model 110C may integrate regional and regulatory guidelines, such as school zone speed limits or lane restrictions, ensuring compliance with local traffic laws. Real-time updates about dynamic situations, including accidents or construction zones, further inform the processor 106C to adjust behavior as needed.

The processor 106C interprets the response 132C received from the cloud AI model 110C. For example, the response may recommend, “Reduce speed to 25 mph due to moderate traffic and sharp curves ahead.” The processor 106C parses this information to identify the specific action or actions required, such as deceleration or lane adjustments. The response may include data like speed thresholds, distance to hazards, or contextual information such as traffic density or road geometry.

The processor 106C evaluates the vehicle's 102C current state using data from internal sensors and systems, including parameters like the current speed, acceleration, lane position, and steering angle. This data may be obtained via the processor through communication with other electronic control units (ECUs), such as through a communication network (e.g., the CAN bus). The processor 106C compares the data against the response from the cloud AI model 110C. For example, when the vehicle is traveling at 40 mph, and the cloud response 132C recommends 25 mph, the processor calculates the deceleration rate to achieve the required adjustment within a safe distance. In vehicles equipped with advanced driver assistance systems (ADAS) or full autonomy, the processor autonomously executes the required action. For example, it sends signals to the braking system to decelerate or to the steering system to adjust the vehicle's trajectory. The processor ensures these actions are smooth and comply with safety protocols to avoid sudden movements that could destabilize the vehicle or alarm passengers. In vehicles without full autonomy, the processor communicates the action to the driver via visual or auditory alerts on the vehicle's display or HUD. For example, a message may be displayed, “Reduce speed to 25 mph,” which may also be accompanied by a warning chime.

When the vehicle is autonomous, the processor sends commands to the relevant vehicle systems, such as the braking system that engages the brakes to the recommended speed, the powertrain control when deceleration is required over a longer distance, or throttle input is needed to reduce speed more gradually, and/or the steering system when lane adjustments are needed (e.g., to avoid a detected obstacle). When the action is manual, the processor monitors the driver's compliance and readiness to intervene when necessary. For example, if the driver does not decelerate within the required timeframe, the processor might escalate the alert or take over control to prevent a collision.

The processor 106C may monitor the vehicle's behavior and environmental conditions to ensure the action is successfully executed. For example, after deceleration, the processor verifies that the vehicle has approximately reached the recommended speed and remains on a safe trajectory. When conditions change (e.g., the hazard is cleared or traffic dissipates), the processor recalculates and updates the vehicle's behavior as needed.

For example, vehicle 102C detects a “Construction Zone Ahead” sign, and the cloud AI model 110C recommends 132C, reducing speed to 25 mph due to moderate traffic and sharp curves. The processor 106C receives this recommendation, calculates the required deceleration, and autonomously engages the brakes to achieve the target speed while ensuring smooth operation. A notification may be displayed on the HUD, such as, “Construction Zone: Speed Reduced to 25 mph.” If the driver is in control, the processor 106C issues a chime and a visual alert, prompting the driver to reduce speed manually. If the driver fails to act, the processor could escalate with a secondary warning or autonomously intervene, depending on the vehicle's capability.

In another example of the instant solution, a sign is detected by the vehicle's sensors 104C, such as cameras, which capture its visual content. The data collected by the sensors is sent to the vehicle processor 106C. Characteristics of the sign, including shape, text, and symbols, are identified. The processor 106C may fully process the data or may be processed fully or partially by the vehicle AI model 108C. In another example, the vehicle AI model 108C may analyze the detected sign in conjunction with contextual information from other onboard systems. For example, the system considers environmental conditions from weather sensors or location data from GPS to determine the relevance of the sign. Based on this analysis, the AI model determines the action required by the vehicle, such as slowing down, stopping, or merging into another lane, and assigns a level to the action indicating its urgency or complexity.

When the determined action exceeds a first threshold, indicating that additional clarification or complex interpretation is required, the system generates a query. This query may encapsulate details about the detected sign, the action, and the contextual information analyzed by the vehicle AI model 108C. For example, if the sign is partially obscured and reads “Speed Limit 3_,” the query might include the need to confirm the missing data based on environmental conditions such as rain or fog. When the level of the action is below a second threshold, the query is processed locally by the first AI model within the vehicle. The instant application on the vehicle processor 106C generates a first response that directly addresses the action required. For example, if the system determines that the sign indicates that the vehicle needs to stop, it may issue a direct response to notify the driver or initiate a gradual deceleration autonomously.

The level of the action may be associated with an amount of modification to the vehicle. For example, the levels may be in a range, such as level 1 being a lowest level where the modification of the vehicle is minimal and level 5 being a highest level where the modification of the vehicle is maximized. Level 1 may be a slight turning of the steering wheel, and level 5 may be a sharp decrease in speed, maneuvering around traffic, or an object on the road. The level may also be associated with a change in the speed or direction of the vehicle compared to where the vehicle begins. The action may also be related to an amount of time until the action needs to be taken by the vehicle, such as 1 indicating a large amount of time (e.g., 20 seconds) and 5 indicating a small amount of time (e.g., 4 seconds). In another example of the instant solution, the involvement of the cloud AI model 110C may only occur when an amount of time that the vehicle needs to take action is greater than another threshold, due to an amount of time needed to involve the cloud A model that may add additional time before the vehicle is able to take the action.

When the action meets or exceeds the second threshold, the query and contextual information are transmitted to the cloud AI model 110C. This server, hosting the cloud AI model 110C, performs processing by analyzing the query in combination with external datasets. These datasets could include real-time traffic patterns, regional road regulations, or additional environmental data sourced from other connected servers. For example, if the query pertains to an obscured speed limit sign, the server may reference regional traffic databases to confirm the speed limit for that location. The cloud AI model 110C generates a second response based on its analysis and sends it back to the vehicle through the network. The response is received by the application executing on the vehicle processor 106C and may include refined details, such as, “Speed limit confirmed as 35 mph due to school zone rules active until 3:00 PM.”

The vehicle 102C performs the required action using either the first response (generated locally) or the second response (from the cloud AI model 110C). If the system determines that the action is simple, such as adjusting speed to a confirmed limit, it may autonomously control the throttle or brakes. For more complex responses requiring driver intervention, the application communicates the guidance through a display or audio system. For example, the display might present, “Slow down to 10 mph for sharp curve ahead.”

The level of the action may be associated with the environment of the vehicle when proximate to the sign. For example, if the sign is a speed limit sign and the vehicle is within a threshold amount of the speed of the sign, the instant solution will not involve either the first AI model or the second AI model. If the level of the action is higher, the first AI model may be used to determine such situations where there is a curve or current traffic conditions in which the speed on the sign should have more adherence. When the level of the action is at a high level, the second AI model would be used, such as when there is an “Ice on Bridge” sign, and the temperature would need to be examined to determine the chance that there is actually ice on the bridge.

In one embodiment of the instant solution, the system may provide an action for the vehicle to perform when no proximate sign is available. For example, when the vehicle determines an upcoming bridge without a proximate sign, the instant solution processing may include determining an action that the vehicle may need to take in a similar manner as if there had been a sign before the bridge.

In another example of the instant solution, the system leverages pre-existing data, sensor inputs, and predictive analysis to manage scenarios where signs are missing, obscured, or unnecessary. For example, when the vehicle approaches a known bridge in cold weather, the system anticipates the bridge's presence and its associated risks, such as icy conditions, without requiring confirmation from a road sign. The system uses GPS and mapping data to identify upcoming physical features like bridges, sharp curves, tunnels, etc. These features may be stored in the system's database (residing in one or more of the vehicle or an external server), which is regularly updated to ensure accuracy, for example. The system integrates real-time environmental data collected by the vehicle's sensors, such as temperature, humidity, and road surface conditions. For example, if the temperature is near or below freezing, the system predicts the likelihood of ice forming on a bridge. Recognizing that signs may be missing, damaged, or obscured, the system focuses on the physical feature itself rather than relying on sign detection. For example, the system does not need to detect a sign warning of icy bridges; it operates on the assumption that the bridge exists and proactively assesses the associated risk based on conditions. Before the vehicle reaches the bridge, the system generates guidance or takes actions based on the analyzed data. For example, the system adjusts the vehicle's speed or activates stability controls to ensure safe traversal of the bridge under potentially icy conditions.

The system determines the level of action to be performed by analyzing the operational parameters of the vehicle and comparing these parameters against predefined thresholds. This process ensures that the vehicle's response is configured to the specific driving context and level of urgency. The system collects real-time data from various vehicle sensors and systems, such as speed, acceleration, braking pressure, steering angle, and environmental inputs such as road conditions or weather. These parameters provide an understanding of the vehicle's current operational state. For example, the system may detect that the vehicle is traveling at high speed while approaching a sharp curve or a bridge in icy weather.

The collected data is processed by the vehicle AI model 108C, which compares the parameters against corresponding thresholds. These thresholds are based on safety guidelines, regulatory standards, or learned models from historical data. For example, a speed threshold might indicate that reducing speed is when the vehicle exceeds a certain limit while approaching a potentially hazardous area. If the analysis determines that the parameter values exceed or meet a threshold, the system identifies the required action, such as decelerating, changing lanes, or providing a warning to the driver.

In another example of the instant solution, the system determines the level of action required by analyzing parameters associated with the vehicle's operation and its surrounding conditions. These parameters include, but are not limited to, the vehicle's speed, acceleration, proximity to the detected sign, and external factors such as traffic congestion, road curvature, and weather-related hazards. The vehicle's sensors collect data related to these parameters. For example, cameras detect the presence of a sign and estimate its distance, while GPS and location systems provide spatial awareness. Speed sensors and accelerometers record the vehicle's current velocity and acceleration patterns.

The vehicle AI model 108C processes this data to evaluate the context of the detected sign and its associated parameters. For example, if the vehicle is approaching a sharp curve at high speed, the system recognizes the urgency of decelerating to ensure safe navigation. When traffic congestion is detected ahead, the system evaluates the distance to the sign and adjusts the vehicle's response to account for potential delays or hazards. Weather-related data, such as rain or ice detected by environmental sensors, further informs the system's decision-making, allowing it to increase the action level if conditions indicate a heightened risk.

In another example of the instant solution, the cloud AI model 110C uses data received from other vehicles that either are or have been in the past proximate the sign. Analysis of this data and the reaction of the other vehicles is used to determine the response to the vehicle 102C from the cloud AI model 110C. By analyzing how other vehicles behave (e.g., slowing down, changing lanes, or stopping), the cloud AI model 110C provides a more contextually accurate response 132C to the vehicle's predicted query 130C, ensuring that the vehicle's modification aligns with the traffic flow.

For example, vehicle 102C is approaching a “Construction Zone Ahead” sign on a three-lane highway. Vehicle 102C detects the sign and sends a predicted query 130C to the cloud AI model 110C: “What adjustments are recommended for navigating the upcoming construction zone given current conditions?” The cloud AI model 110C processes the query and incorporates data about the reactions of other vehicles in the vicinity, such as the majority of vehicles in the right lane have moved to the middle or left lanes to avoid a temporary lane closure, vehicles in the middle lane have reduced their speed by 15 mph due to congestion and merging traffic, and a lead vehicle 200 meters ahead in the left lane slowed down after detecting construction equipment entering the zone. Based on this information, the cloud AI model 110C generates a response: “Shift to the middle lane, reduce speed by ten mph, and prepare for merging traffic in 100 meters.” The vehicle's processor 104C uses this response 132C to adjust its behavior. If the vehicle operates autonomously, it changes lanes to the middle lane, decelerates, and adjusts its trajectory to account for merging vehicles. If the vehicle is non-autonomous, the system displays these recommendations on the HUD or another display associated with the vehicle 102C, notifying the driver to take the specified actions.

In another example of the instant solution, the road sign interpretation and response system are based on the vehicle's location and the regional traffic rules associated with that area. The instant solution uses GPS or other location-tracking systems to monitor the vehicle's 102C geographic position. This location data is transmitted to the vehicle's processor 104C, which uses the location data to identify the region-specific rules that may apply. The processor queries the cloud AI model 110C to access regional traffic rules, including signage conventions and regulatory practices. When the vehicle's Sensors 104C detect a road sign, such as a “Yield to Oncoming Traffic” sign, the processor analyzes the data to classify the sign and its associated attributes (e.g., shape, text, symbols). The processor cross-references the detected sign with the regional traffic database obtained from the cloud model, for example. This cross-referencing ensures that the detected sign is interpreted in the correct regional context. Based on the regional database, the system determines whether the detected sign is a sign that is not normally seen by the vehicle 102C or requires additional explanation due to local regulations. For example, the cloud AI model 110C may identify that in the current region, the “Yield to Oncoming Traffic” rule applies specifically to narrow bridges where oncoming vehicles always have priority. The instant solution displays additional information on the display associated with the vehicle, which may include the sign's regional context. For example, it adds additional information, such as “Yield to Oncoming Traffic: Region-Specific Rule for Narrow Bridges.” When the driver does not respond appropriately to the regional traffic rule (e.g., fails to yield to oncoming traffic at the narrow bridge), the processor 106C may escalate the alert by generating an audible chime or voice alert (e.g., “Stop Now: Oncoming Vehicle Detected”), flashing a visual warning on the dashboard or HUD and/or autonomously adjusting the vehicle's speed or applying the brakes, in vehicles equipped with advanced driver assistance systems (ADAS).

The instant solution stores data about the driver's interaction with the regional rule and integrates this feedback into the vehicle's onboard AI. Over time, the vehicle AI model 108C refines its predictions and recommendations for similar regional scenarios, ensuring smoother compliance with local rules. The solution may also use data from other vehicles in the area to enhance its regional customization further. For example, if multiple vehicles report slowing down for the same sign, the cloud AI model 110C incorporates this behavior into its recommendations to ensure consistency with local traffic patterns.

The instant solution uses visibility data to prioritize the response when the visibility of a detected road sign is below a certain threshold, enhancing the driver's safety and awareness, particularly in nighttime or low-visibility conditions. For example, the vehicle's sensors 104C detect a road sign, such as a “Sharp Curve Ahead” warning, and concurrently capture visibility-related data using sensors on the vehicle, such as ambient light sensors, weather sensors, or cameras. The processor 106C analyzes this data to determine if the visibility of the sign is below a threshold, such as in poor lighting, heavy fog, or rain. When the visibility is determined to be below the threshold, for example, due to insufficient lighting or environmental obstructions, the processor raises the priority of the response. This prioritization ensures that any modification of the vehicle 102C is urgent. In vehicles equipped with Advanced Driver Assistance Systems (ADAS), the raised-priority response may trigger automatic adjustments to the vehicle's behavior, such as dimming high beams, reducing speed, or tightening lane-keeping controls to navigate the curve safely.

In another example of the instant solution, data is received by the vehicle 102C related to a visibility of the sign. The level of the action is raised when the visibility is below a threshold. Visibility may refer to the ability of the vehicle's sensors to fully detect and interpret the sign, which can be reduced due to environmental factors like fog, rain, or dirt obstructing the sensors'view. Visibility may also pertain to the driver's ability to visually recognize and comprehend the sign if the system relies on human intervention. For example, poor visibility could mean the sensor detects the presence of a sign but cannot extract all details, or it may fail to detect the sign altogether. In such cases, the system assumes the presence of the expected sign, recognizing that road signs are generally static and unlikely to move, and focuses instead on the physical attributes of the road ahead.

The instant solution responds to reduced visibility by analyzing environmental data and the physical layout of the environment. When the sign cannot be read, but the instant solution identifies an upcoming curve, it may generate a query to inform an occupant of the vehicle 102C, such as: “Curve ahead, reduce speed to 10 mph.” For scenarios where no visible sign is detected, the system relies on sensor inputs to determine upcoming physical aspects of the road, such as bridges, curves, or traffic, and assesses safe speeds based on at least the road, traffic, and weather conditions. For example, in foggy weather near a bridge, the system may recommend slowing to a safe speed based on the vehicle's current capabilities and the driver's control.

In another example of the instant solution, the cloud AI model 110C analyzes traffic density data from external servers, such as traffic management systems or connected vehicle networks, to detect patterns indicating congestion that may or may not be near a detected road sign. When the vehicle's processor 106C sends a predicted query 130C to the cloud AI model 110C, it accesses traffic data, including vehicle density, average speeds, and lane usage, from one or more external servers. The cloud AI model 110C identifies traffic patterns indicative of congestion, such as a significant reduction in speed across multiple lanes, frequent braking events, or lane-blocking incidents like stalled vehicles or construction. When congestion is detected, the response generated by the cloud AI model 110C includes a recommendation to adjust the vehicle's lane and/or speed to mitigate delays and maintain safe navigation.

For example, if the detected sign indicates “Merge Ahead” and the traffic density analysis reveals a bottleneck in the right lane, the response may recommend: “Shift to the middle lane and reduce speed to 20 mph for optimal flow.” The vehicle processor 106C implements this response by adjusting the steering and speed controls, such as in an autonomous vehicle.

The instant solution integrates the detection of road conditions beyond a detected sign with the cloud AI model 110C analysis and the vehicle's 102C adaptive response. The cloud AI model 110C, with external data integration capabilities, analyzes road conditions in areas past the detected sign. Road conditions refer to factors such as traffic congestion, surface quality, curves, bridges, inclines, and weather-related hazards like ice, rain, fog, etc. These conditions are detected when their severity exceeds a predefined threshold, such as significant traction loss on icy roads or steep gradients requiring a reduction in speed. For example, if the vehicle detects a sign, such as “Bridge May Be Icy,” and sends a query to the cloud AI model 110C, the server assesses the condition of the bridge and its surroundings using data from vehicle sensors, infrastructure systems, or external real-time data sources like weather updates and traffic patterns.

The cloud AI model 110C generates a second response tailored to the detected condition and transmits it back to the vehicle 102C. For autonomous vehicles, the response may trigger actions such as reducing speed, activating traction control systems, or rerouting the vehicle to avoid the hazardous area. For human-driven vehicles, the system provides alerts through the vehicle's interface, such as “Caution: Icy bridge ahead—reduce speed to 20 mph.” This guidance ensures that the vehicle and its occupants can navigate safely through or around the detected hazard. The solution also defines thresholds for road conditions that require a response, such as friction coefficients for icy roads or vehicle density metrics for traffic congestion. The cloud AI model processes these thresholds in conjunction with real-time data to determine the appropriate response. Real-time communication exists between the vehicle 102C and the cloud AI model 110C, ensuring timely analysis and response generation. The vehicle is equipped with processors and/or actuators to execute autonomous responses or deliver actionable feedback to the driver.

The area and the area past the sign may be a foot to miles long. In another example of the instant solution, the area may be a radius where the outer edge of the radius is the current location of the vehicle. The vehicle being on the outer edge of the radius, heading towards the middle of the radius, having just passed the sign.

In another example of the instant solution, vehicle safety is enhanced by dynamically interpreting road signs in real-time based on contextual factors like traffic, weather, and road conditions, ensuring that drivers receive accurate, adaptive guidance. It achieves this by using AI models both within the vehicle and on external servers to generate and display context-aware information, helping drivers make safer and more informed decisions.

The instant solution dynamically interprets and modifies road sign information based on real-time environmental, traffic, and driving conditions, the instant solution providing contextually relevant guidance to drivers. Utilizing a combination of onboard AI models SLMs and cloud-based AI models LLMs, the system evaluates road sign information while also analyzing factors such as vehicle speed, road curvature, weather conditions, and traffic congestion. It delivers modified prompts via a vehicle's display or heads-up display (HUD), helping drivers make informed decisions.

The instant solution displays data that modifies road sign interpretations based on real-time contextual inputs. For example, the instant solution may display the difference between the driver's current speed and the speed limit at an exit, showing “minus ten mph” when the driver exceeds the limit and based on various contextual factors, such as road, traffic, weather conditions, etc., to provide more accurate guidance. This instant solution refines the adaptive vehicle display system by focusing on the real-time contextual modification of signs rather than solely generating new virtual signs. It prioritizes dynamic adjustments to existing signs and provides predictive prompts that reflect immediate changes in the driving environment, such as sudden traffic buildups or adverse weather.

The instant solution makes use of A models, such as SLMs and LLMs to enhance contextual interpretation. The instant solution considers diverse scenarios, such as rain, fog, wet roads, snow, or other environmental factors, to refine the recommended speed adjustments. Instead of simply displaying a speed difference, the instant solution may advise a greater reduction based on the detected conditions, enhancing driver safety and situational awareness. For example, the instant solution interprets and presents road sign information contextually. Road sign data is received via at least one processor on a vehicle, such as by one or more sensors on the vehicle, which engages a first AI model deployed onboard to generate initial contextual information related to the received data. This data, along with the initial contextual interpretation, is sent to a second AI model hosted on an off-vehicle server, where additional contextual data from external sources, such as traffic conditions, weather, or road curvature, is integrated. The second AI model processes all this information to create a refined contextual interpretation of the road sign.

The server transmits this contextual interpretation back to the vehicle's processor, where it is displayed on an associated interface, such as a heads-up display or dashboard screen.

In another example, a situation may arise when exiting at a specified speed that leads to a sudden encounter with stopped traffic, emphasizing the importance of alerts about unseen traffic around curves. In a further example, the solution may display warnings for unexpected obstacles, such as traffic in blind spots or hidden traffic signals (e.g., red traffic lights under overpasses). The solution may detect these conditions and provide proactive alerts, like flashing yellow lights, to prompt earlier deceleration or increased awareness. The instant solution's ability to handle a wide range of contextual variables such as road type, weather, unseen traffic, etc., presents a functional expansion over current ADAS technologies using a combination of multiple AI models such as immediate vehicle-side processing AI models as well as complex contextual analysis AI models in the cloud.

In another example of the instant solution, when a driver fails to adjust according to the modified prompts, the instant solution issues secondary warnings. These may include audible alerts, visual flashes, or vibrations through the steering wheel, providing an additional layer of safety.

In another example of the instant solution, the system enhances vehicle safety and situational awareness by integrating advanced decision-making processes that prioritize proactive actions, such as braking sooner and/or applying greater braking force, in response to detected road conditions or hazards. The system leverages its onboard sensors 104C and external processing capabilities via the cloud AI model 110C to dynamically assess and adjust the vehicle's response time and braking behavior based on real-time data. The vehicle's sensors, such as cameras, radar, and lidar, detect a potential obstacle, road sign, or environmental hazard, such as a construction zone or reduced visibility due to weather conditions. This data is analyzed either locally by the vehicle AI model 106C or off-board by the cloud AI Model 110C hosted on the external server.

When the system identifies a sign, such as a “reduce speed ahead” sign or an obstacle, it evaluates the time remaining before the vehicle reaches the critical point, such as a hazardous zone or a stopping threshold. Based on this temporal analysis, the system determines whether braking should occur sooner, more forcefully, or both. The system dynamically adjusts the vehicle's braking profile, factoring in variables such as the vehicle's speed, distance to the hazard, road surface conditions, and environmental factors like rain or ice. For example, if the vehicle is approaching a construction zone with uneven terrain, the system might recommend braking 5-10 seconds earlier than usual to ensure a smooth and controlled deceleration.

The system incorporates real-time updates from external sources, such as traffic databases or weather information, to refine its braking strategy. For example, if other vehicles in the vicinity report sudden deceleration due to congestion, the system might decide to apply greater braking force in anticipation of rapidly changing traffic conditions. The system can differentiate between scenarios requiring minor adjustments, such as slowing slightly earlier, and those requiring significant action, such as hard braking over an extended distance.

The temporal aspect also extends to the communication between the vehicle and the external server. If the vehicle AI model 106C determines that additional analysis is required, it sends a query to the cloud AI model 110C, including the estimated time to the critical point and other contextual information. The external server processes this data and returns a response with specific recommendations, such as initiating braking 3 seconds earlier or increasing braking force by 20% under icy conditions.

FIG. 1D is another network diagram 100D of the instant solution, according to example embodiments. A vehicle is depicted containing a display 104E, a display 104D, a processor 106E, and an AI model 108E. The display 104D serves as the interface between the system and the driver. It can be a dashboard screen, heads-up display (HUD), or another visual output device within the vehicle. Data related to the sign is presented to the driver, including warnings, recommended speed, estimated travel times, or route changes. This component ensures that the visual cues are clear and contextually relevant. The processor 106D is the computational hub within the vehicle that receives raw data from various vehicle sensors (e.g., cameras, LiDAR, radar, ultrasonic sensors). The instant solution may fully reside in the processor 106D or partially reside in the processor 106E, and any other computing device mentioned herein. The processor 106D preprocesses the raw data into a structured format that can be analyzed by the vehicle AI model, which may include filtering noise, consolidating sensor inputs, and extracting meaningful features like object type, location, and road conditions. The processor 106D may also route information between sensors, the vehicle AI model, and the display unit. The vehicle AI model 108D is the instant solution's intelligence for providing additional data related to a sign. It uses machine learning functionality to process data from the processor. The instant solution predicts dangerous situations based on the vehicle's surroundings and generates data that is used to present updated and detailed information about signs. The vehicle AI model 108D may also communicate with the cloud AI model 110D to enhance predictions and integrate additional data into its virtual sign updates for real-time display to the driver. The cloud-based AI model provides additional analytical capabilities. It receives data from the vehicle AI model, including vehicle telemetry and contextual data. The cloud AI model 110D incorporates broader external sources 112D, such as real-time traffic databases, weather conditions, and reports from other connected vehicles (via V2V communication), to provide a more comprehensive hazard analysis.

The vehicle's processor 106D detects a proximate road sign 118D using data collected from sensors, cameras, or other input devices mounted on the vehicle. This detection includes data related to the sign, such as its type (e.g., speed limit, warning sign) and specific instructions (e.g., “Reduce Speed to 40 MPH”). This initial data, referred to as a vehicle-side contextual information message 120D, is packaged and sent to the vehicle's AI model 108D. The received data is processed by the vehicle AI model 108D. It processes this information using an AI model. Contextual information is generated 122D by interpreting the road sign's meaning in the context of real-time vehicle conditions. For example, it evaluates factors such as vehicle speed, lane position, or road curvature. The contextual output includes preliminary guidance, such as “Current speed exceeds the limit by 10 MPH” or “Sharp curve ahead—reduce speed.” The initial contextual interpretation is transmitted to the cloud AI model 110D via a message 124D, allowing for further processing using the cloud AI model 110D and access to external resources unavailable on the vehicle itself.

The cloud AI model 110D may communicate with external sources 112D to gather additional contextual data 126D. These sources may include weather APIs to determine conditions like rain, fog, or snow; traffic data feeds to analyze congestion levels or potential delays; road condition databases to assess hazards such as potholes or construction zones, and/or mapping services to incorporate geographical data, such as the proximity of intersections or curves. for example 128D. The external sources 112D respond with contextual information 130D, such as “Rain detected—reduce speed further” or “Traffic buildup 500 feet ahead—prepare to stop.”

The cloud AI model 110D combines data from the initial vehicle-side contextual information message 120D with external inputs (e.g., contextual information 130D) to generate a refined contextual interpretation 132D. This output accounts for both immediate and broader driving conditions, ensuring the guidance is highly relevant. For example, the refined output might suggest, “Reduce speed to 35 MPH due to wet roads and congestion ahead” or “Prepare to stop at a hidden intersection.” The refined contextual interpretation is transmitted back to the vehicle processor (message 132D), ensuring that the vehicle receives up-to-date, accurate guidance without delays, even when external computations are involved. The vehicle processor 106D forwards the refined contextual interpretation 134D to the driver's display 104D. The guidance is presented on display 104D of the vehicle 102D, such as a heads-up display (HUD) or dashboard screen 136D. For example, the display might show A dynamic speed limit (“Reduce Speed to 40 MPH”), warning signs for unseen hazards (“Traffic jam around the curve, decelerate”), alerts for environmental conditions (“Slippery roads—maintain extra caution”), secondary alerts when the driver fails to respond to the displayed guidance.

In another example of the instant solution, vehicle safety is enhanced by dynamically interpreting road signs in real-time based on contextual factors like traffic, weather, and road conditions, ensuring that drivers receive accurate, adaptive guidance. It achieves this by using AI models both within the vehicle and on external servers to generate and display context-aware information, helping drivers make safer and more informed decisions.

The instant solution interprets and modifies road sign information based on environmental, traffic, and driving conditions. It provides contextually relevant guidance to drivers. Utilizing a combination of onboard AI models such as SLMs and cloud-based AI models such as LLMs, the instant solution evaluates road sign information while also analyzing factors such as vehicle speed, road curvature, weather conditions, and traffic congestion. It delivers modified data via a vehicle's display or heads-up display (HUD).

For example, the instant solution may display the difference between the driver's current speed and the speed limit at an exit, showing “minus ten mph” when the driver exceeds the limit and based on various contextual factors, such as road, traffic, weather conditions, etc., to provide more accurate guidance. This instant solution refines the adaptive vehicle display system by focusing on the real-time contextual modification of signs rather than solely generating new virtual signs. It prioritizes dynamic adjustments to existing signs and provides predictive prompts that reflect immediate changes in the driving environment, such as sudden traffic buildups or adverse weather.

The instant solution uses AI models, such as SLMs and LLMs, to enhance contextual interpretation. It considers diverse scenarios—like rain, fog, wet roads, snow, or other environmental factors—to refine the recommendations dynamically. For example, instead of simply displaying a speed difference, the instant solution may advise a greater reduction based on the detected conditions, enhancing driver safety and situational awareness.

In another example, the instant solution interprets and presents road sign information contextually. Road sign data is received via at least one processor on a vehicle, such as by one or more sensors on the vehicle, which engages a first AI model deployed onboard to generate initial contextual information related to the received data. This data, along with the initial contextual interpretation, is sent to a second AI model hosted on an off-vehicle server, where additional contextual data from external sources, such as traffic conditions, weather, or road curvature, is integrated. The second AI model processes all this information to create a refined contextual interpretation of the road sign.

The server transmits this contextual interpretation back to the vehicle's processor, where it is displayed on an associated interface, such as a heads-up display or dashboard screen. This adaptive interpretation is presented to drivers in real-time, providing more meaningful and situation-specific guidance, such as modified speed recommendations or alerts based on current traffic or road conditions.

In another example of the instant solution, a situation may arise when exiting at a specified speed that leads to a sudden encounter with stopped traffic, emphasizing the importance of alerts about unseen traffic around curves. In a further example, the solution may display warnings for unexpected obstacles, such as traffic in blind spots or hidden traffic signals (e.g., red traffic lights under overpasses). The solution may detect these conditions and provide proactive alerts, like flashing yellow lights, to prompt earlier deceleration or increased awareness. When the driver fails to slow down or adjust according to the modified prompts, the instant solution issues secondary warnings. These may include audible alerts, visual flashes, or vibrations through the steering wheel, providing an additional layer of safety.

FIG. 1E is another network diagram 100E of the instant solution, according to example embodiments. A vehicle is depicted containing a display 104E, a processor 106E, and an AI model 108E. The display 104E serves as the interface between the system and the driver. It can be a dashboard screen, heads-up display (HUD), or another visual output device within the vehicle. It presents dynamically generated virtual signs to the driver, including hazard warnings, recommended speed, estimated travel times, or route changes. This component ensures that the visual cues are clear and contextually relevant. The processor 106E is the computational hub within the vehicle that receives raw data from various vehicle sensors (e.g., cameras, LiDAR, radar, ultrasonic sensors). The instant solution may fully reside in the processor 106E or partially reside in the processor 106E, and any other computing device mentioned herein. The processor 106E preprocesses the raw data into a structured format that can be analyzed by the vehicle AI model, which may include filtering noise, consolidating sensor inputs, and extracting meaningful features like object type, location, and road conditions. The processor also acts as a bridge, routing information between sensors, the vehicle AI model, and the display unit. The vehicle AI model 108E is the instant solution's intelligence for analyzing and predicting hazards. It uses advanced machine learning algorithms to process data from the processor and identify potential road hazards. The instant solution predicts dangerous situations based on the vehicle's surroundings and generates virtual signs tailored to the specific context (e.g., construction zones, stalled vehicles, or debris). This AI model 108E also communicates with the cloud AI model 110E to enhance predictions and integrates refined hazard details into its virtual sign updates for real-time display to the driver. The cloud-based AI model provides additional analytical capabilities to refine hazard predictions. It receives data from the vehicle AI model, including hazard characteristics, vehicle telemetry, and contextual data. The cloud AI model 110E incorporates broader external data sources, such as real-time traffic databases, weather conditions, and reports from other connected vehicles (via V2V communication), to provide a more comprehensive hazard analysis. It refines predictions, such as adjusting hazard severity, updating route guidance, or providing more accurate estimated travel times. These refinements are transmitted back to the vehicle for integration into the virtual signage displayed to the driver.

FIG. 1E is another network diagram 100E of the instant solution, at least one sensor within the vehicle 102E detects a road sign, hazard, or relevant condition 120E. The processor 106E in the vehicle receives the raw sensor data and refines it into a structured format suitable for analysis, involving processing parameters like detected object type, location, and urgency of the hazard. The processor sends this refined data 122E to the vehicle's AI model 108E for further evaluation. The vehicle AI model 108E analyzes the refined data using machine learning algorithms. This analysis predicts potential hazards 124E and determines the appropriate virtual sign to generate. The AI model 108E may consider the type of road condition (e.g., construction zone, debris, or stalled vehicle) and recommend guidance, such as reduced speed or alternative routing. The output is a “Virtual Sign Details” message 126E, including at least a hazard type, location, suggested actions (e.g., speed limits), and estimated time to clear the hazard. This information is sent to the display 104E, where the virtual sign is presented to the driver 130E.

The vehicle AI model 108E transmits 132E the initial hazard predictions to a cloud AI model 110E. The message includes at least refined hazard characteristics, vehicle telemetry data, and additional contextual information gathered by sensors. The cloud AI model 110E refines the hazard predictions by incorporating data from external sources such as weather services, traffic databases, or nearby connected vehicles (using V2V communication) 134E. This broader analysis provides more accurate and context-aware updates about the hazard, which are packaged as a “Refined Hazard Details” message 136E. This message includes at least updates to hazard severity, real-time traffic impacts, and recommendations for route adjustments or changes in speed. The refined hazard details are sent back 136E/138E to the vehicle AI model 108E via the processor 106E. The vehicle AI 108E integrates this updated information and adjusts the virtual sign 104E displayed on the vehicle's display unit. The updated virtual sign 142E reflects the most accurate and contextually relevant guidance for the driver, ensuring real-time adaptation to changing road conditions. In another example of the instant solution, the display 104E updates based on new messages from the vehicle AI model 140E, ensuring the driver has up-to-date visual cues, which may include refined speed recommendations, hazard locations, or time-based guidance to navigate safely.

FIG. 1F is a flowchart diagram 100F of the creation of a query, according to example embodiments. The query creation process in the vehicle begins with data collection 102F. The system gathers raw data from various sensors. Cameras capture visual information, such as road signs, symbols, or lane markings; other sensors, such as lidar and radar, measure distances and detect nearby objects. Weather sensors may also record environmental conditions like rain, fog, or snow, and vehicle diagnostic sensors monitor operational data such as speed, SOC, and braking activity. These inputs provide the foundational data for analysis. In the analysis by the first AI model step 104F, the collected data is processed by an AI system embedded within the vehicle. This step involves identifying specific features of the detected elements, such as the type and content of a road sign. This AI model performs contextual analysis, considering conditions like the vehicle's location, speed, and weather. In the structuring of the contextual information 106F, the analyzed data is organized into a coherent format. The system compiles information about the detected sign (e.g., type, content, visibility issues), environmental conditions (e.g., weather or road status), and the vehicle's status (e.g., speed, direction, SOC). This structured information provides a detailed and clear understanding of the situation, forming the basis for creating an effective query. The system combines the contextual information into a well-defined question or request for clarification where the query is formulated 108F. For example, if a speed limit sign is partially visible, the query might ask whether the detected speed limit is accurate under the current conditions, ensuring that ambiguities or uncertainties are addressed in a precise and actionable manner. The instant solution determines the need for external processing 110F by evaluating whether the query can be handled locally by the first AI model or if it needs to be sent to a second AI model on an external server. This decision is based on the complexity of the query and predefined thresholds, such as poor visibility or ambiguous sign content. If external processing is determined to be needed, the query, along with its contextual information, is sent to the second AI model on the server 114F. In another example, the query may not be sent for external processing but only the contextual information. In another example, the contextual information may be determined by the second AI model when the query is only sent for external processing. If handled locally, the first AI model completes the process 112F, providing a direct and immediate response to the system.

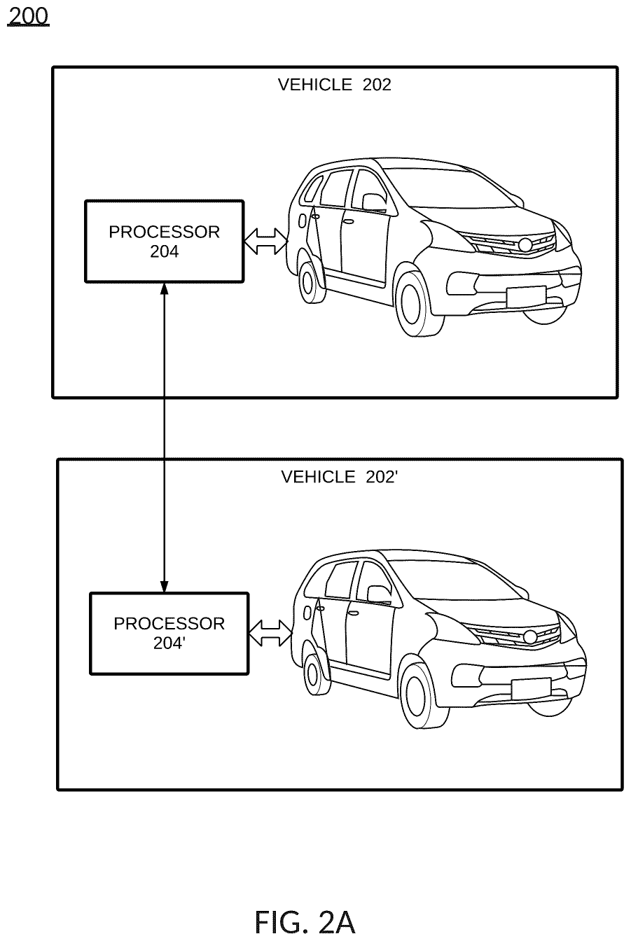

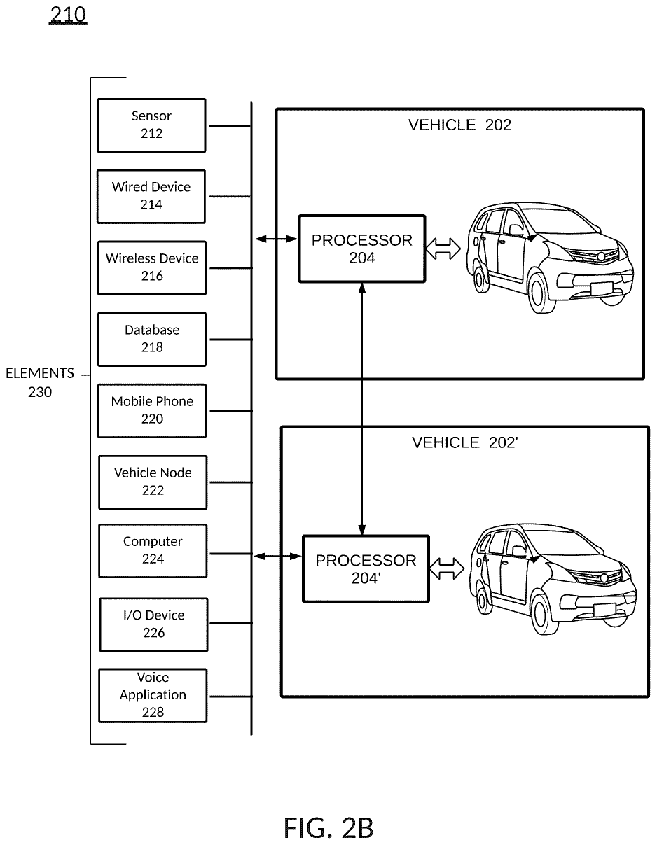

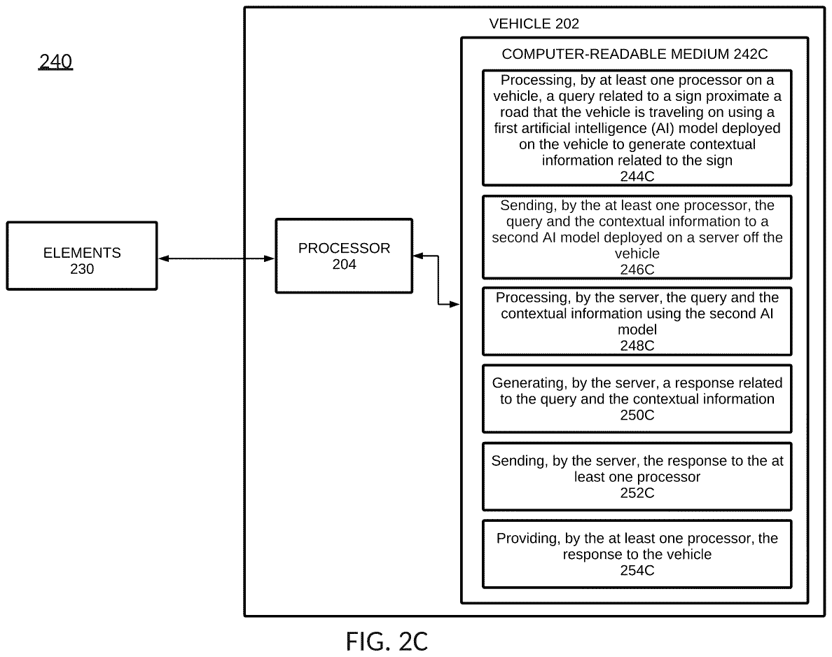

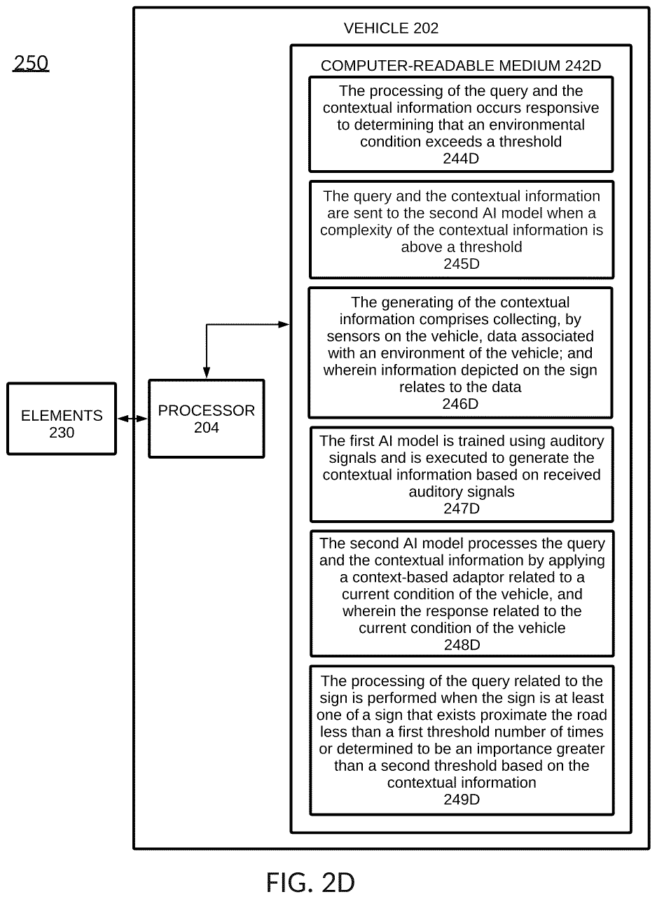

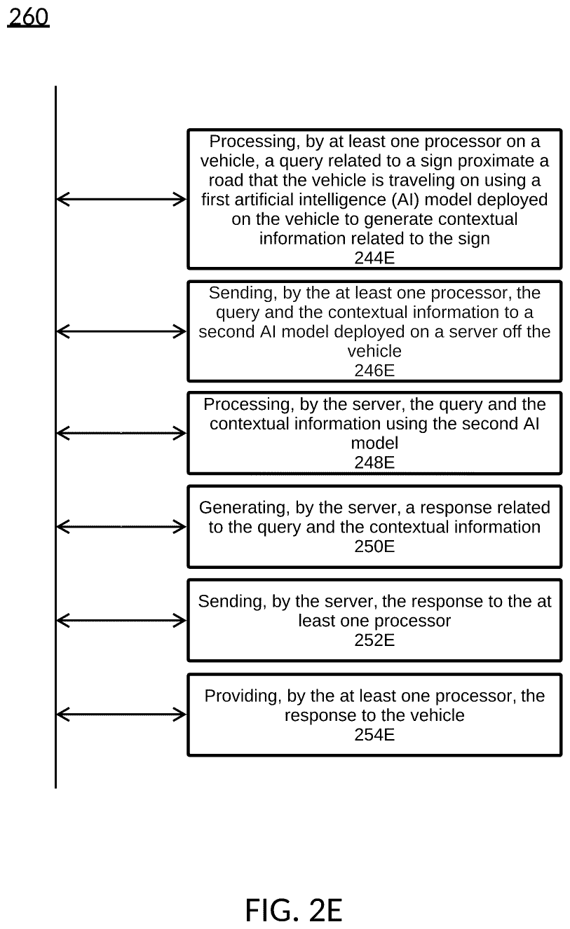

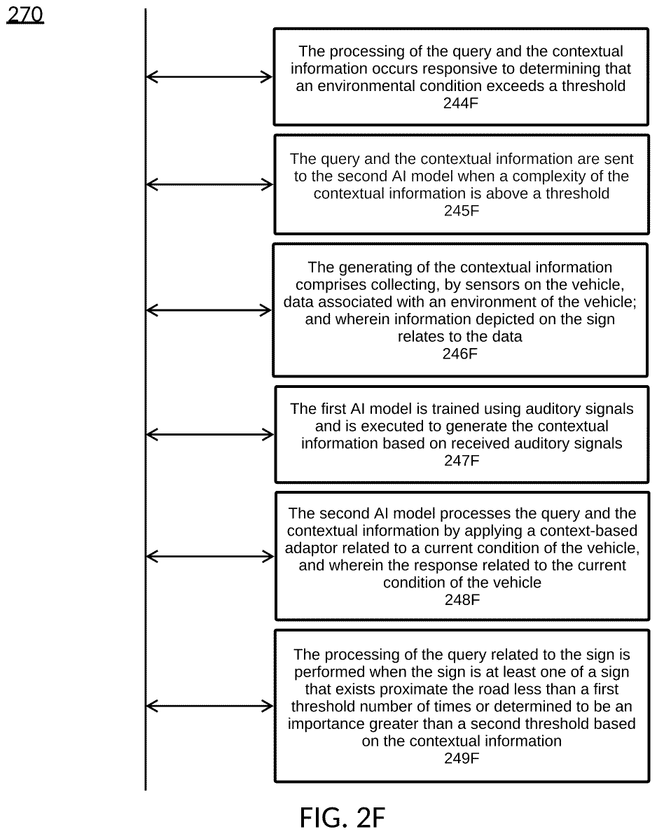

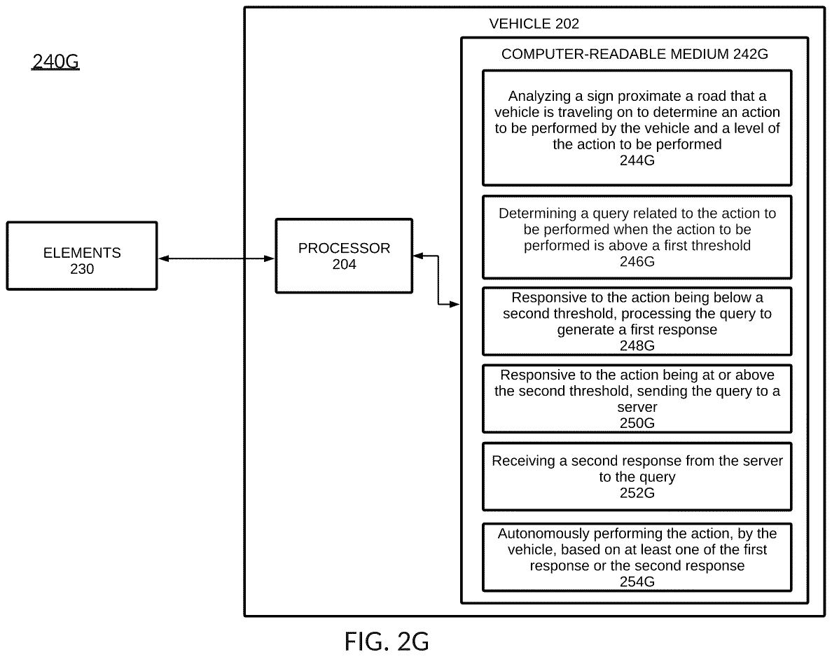

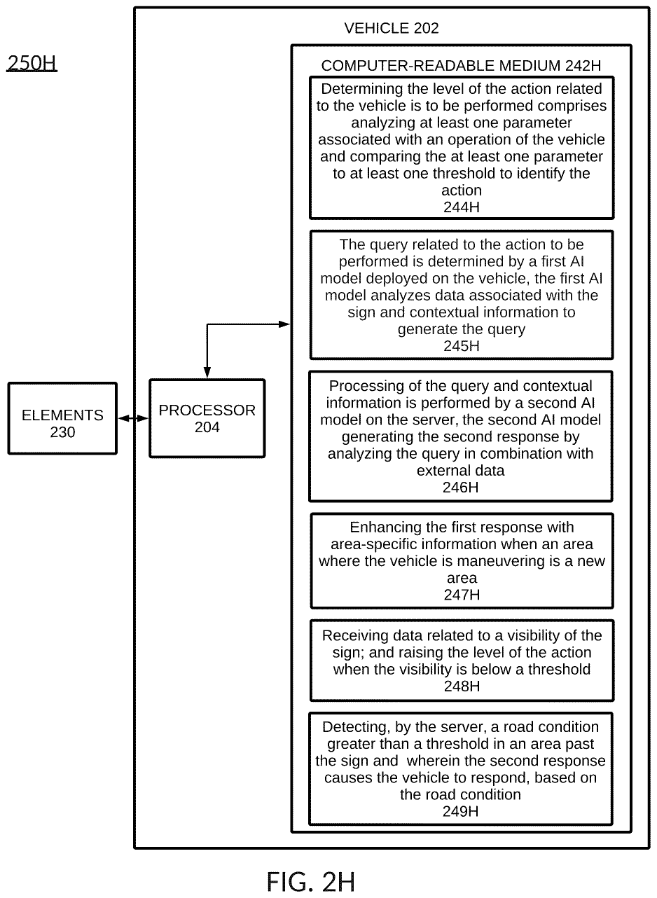

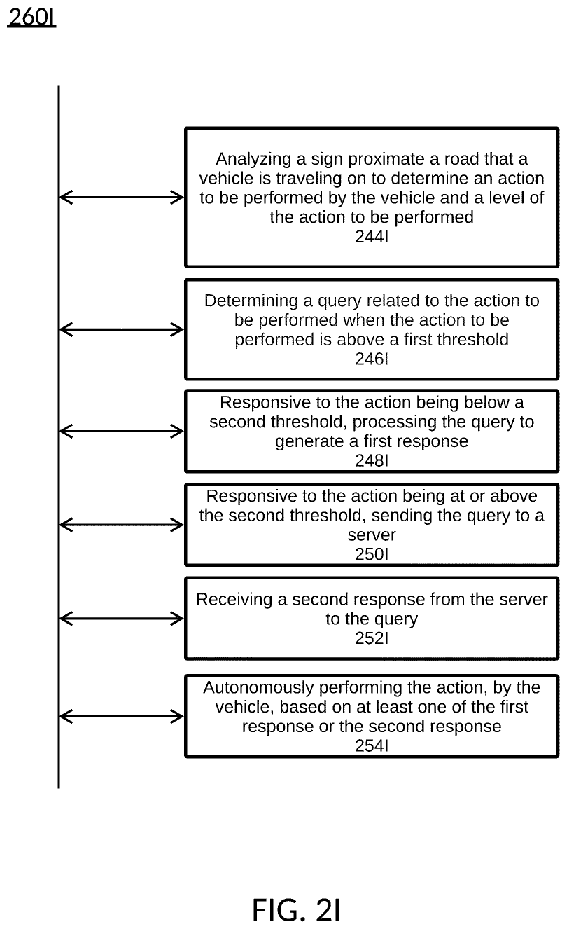

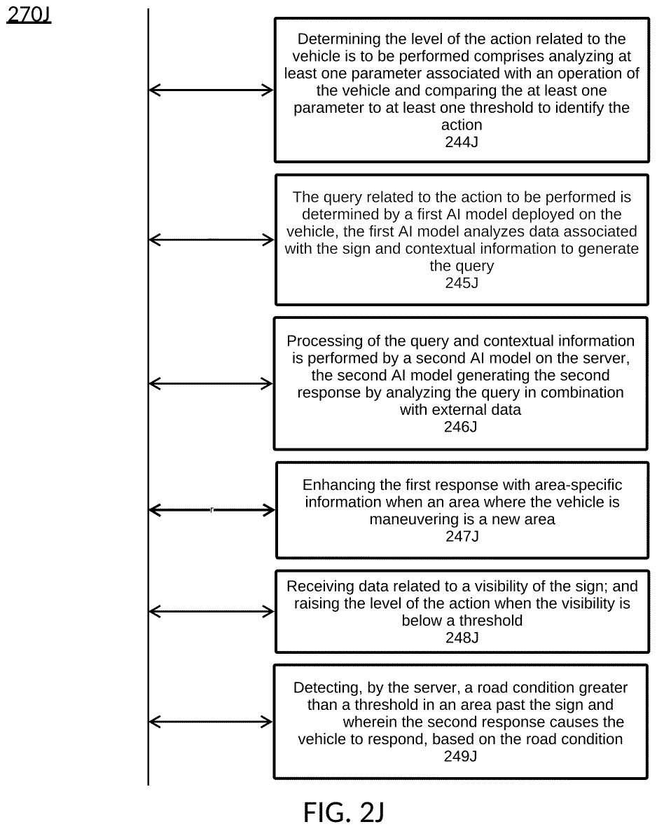

Although the flow diagrams depicted herein, such as FIG. 2C, FIG. 2D, FIG. 2E, and FIG. 2F, FIG. 2G, FIG. 2H, FIG. 2I, and FIG. 2J may be presented as separate flow diagrams, the steps depicted therein may be utilized in conjunction with one another with departing from the scope of the instant solution. Any of the operations in one flow diagram may be utilized and shared with another flow diagram. No example operation is intended to limit the subject matter of any feature, structure, or characteristic of the instant solution or corresponding claim.

It is important to note that all the flow diagrams and corresponding steps and processes derived from FIG. 2C, FIG. 2D, FIG. 2E, and FIG. 2F, FIG. 2G, FIG. 2H, FIG. 2I, and FIG. 2J may be part of a same process or may share sub-processes/steps with one another thus making the diagrams combinable into a single preferred configuration that does not require any one specific operation but which performs certain operations from one example process and from one or more additional processes. All the example processes are related to the same physical system and can be used separately or interchangeably.

FIG. 2A illustrates a vehicle network diagram 200, according to the instant solution. The network comprises elements including a vehicle 202 including a processor 204, as well as a vehicle 202′ including a processor 204′. The vehicles 202, 202′ communicate with one another via the processors 204, 204′, as well as other elements (not shown) including transceivers, transmitters, receivers, storage, sensors, and other elements capable of providing communication. The communication between the vehicles 202, and 202′ can occur directly, via a private and/or a public network (not shown), or via other vehicles and elements comprising one or more of a processor, memory, and/or software. Although depicted as single vehicles and processors, a plurality of vehicles and processors may be present. One or more of the applications, features, steps, solutions, etc., described and/or depicted herein may be utilized and/or provided by the instant elements.

FIG. 2B illustrates another vehicle network diagram 210, according to the instant solution. The network comprises elements including a vehicle 202 including a processor 204, as well as a vehicle 202′ including a processor 204′. The vehicles 202, 202′ communicate with one another via the processors 204, 204′, as well as other elements (not shown), including transceivers, transmitters, receivers, storage, sensors, and other elements capable of providing communication. The communication between the vehicles 202, and 202′ can occur directly, via a private and/or a public network (not shown), or via other vehicles and elements comprising one or more of a processor, memory, and software. The processors 204, 204′ can further communicate with one or more elements 230 including sensor 212, wired device 214, wireless device 216, database 218, mobile phone 220, vehicle node 222, computer 224, input/output (I/O) device 226, and voice application 228. The processors 204, 204′can further communicate with elements comprising one or more of a processor, memory, and/or software.

Although depicted as single vehicles, processors and elements, a plurality of vehicles, processors and elements may be present. Information or communication can occur to and/or from any of the processors 204, 204′ and elements 230. For example, the mobile phone 220 may provide information to the processor 204, which may initiate the vehicle 202 to take an action, may further provide the information or additional information to the processor 204′, which may initiate the vehicle 202′ to take an action, and may further provide the information or additional information to the mobile phone 220, the vehicle 222, and/or the computer 224. One or more of the applications, features, steps, solutions, etc., described and/or depicted herein may be utilized and/or provided by the instant elements.

FIG. 2C illustrates another vehicle network diagram 240, according to the instant solution. The network comprises elements including a vehicle 202, a processor 204, and a non-transitory computer-readable storage medium 242C. The processor 204 is communicably coupled to the non-transitory computer-readable storage medium 242C and elements 230 (which were depicted in FIG. 2B). The vehicle 202 may be a vehicle, server, or any device with a processor and memory.

The processor 204 performs one or more of processing, by at least one processor on a vehicle, a query related to a sign proximate a road that the vehicle is traveling on using a first artificial intelligence (AI) model deployed on the vehicle to generate contextual information related to the sign 244C, sending, by the at least one processor, the query and the contextual information to a second AI model deployed on a server off the vehicle 246C, processing, by the server, the query and the contextual information using the second AI model 248C, generating, by the server, a response related to the query and the contextual information 250C, sending, by the server, the response to the at least one processor 252C, and providing, by the at least one processor, the response to the vehicle 254C.

FIG. 2D illustrates a further vehicle network diagram 250, according to the instant solution. The network comprises elements including a vehicle 202, a processor 204, and a non-transitory computer-readable storage medium 242D. The processor 204 is communicably coupled to the non-transitory computer-readable storage medium 242D and elements 230 (which were depicted in FIG. 2B). The vehicle 202 may be a vehicle, server or any device with a processor and memory.

The processor 204 performs one or more of the processing of the query and the contextual information occurs responsive to determining that an environmental condition exceeds a threshold 244D, the query and the contextual information are sent to the second AI model when a complexity of the contextual information is above a threshold 245D, the generating of the contextual information comprises collecting, by sensors on the vehicle, data associated with an environment of the vehicle; and wherein information depicted on the sign relates to the data 246D, the first AI model is trained using auditory signals and is executed to generate the contextual information based on received auditory signals 247D the second AI model processes the query and the contextual information by applying a context-based adaptor related to a current condition of the vehicle, and wherein the response related to the current condition of the vehicle 248D, the processing of the query related to the sign is performed when the sign is at least one of a sign that exists proximate the road less than a first threshold number of times or determined to be an importance greater than a second threshold based on the contextual information 249D.

While this example describes in detail only one vehicle 202, multiple such nodes may be connected, such as via a network or blockchain. The vehicle 202 may include additional components and that some of the components described herein may be removed and/or modified without departing from the scope of the instant application. The vehicle 202 may have a computing device or a server computer, or the like, and may include a processor 204, which may be a semiconductor-based microprocessor, a central processing unit (CPU), an application-specific integrated circuit (ASIC), a field-programmable gate array (FPGA), and/or another hardware device. Although a single processor 204 is depicted, the vehicle 202 may include multiple processors, multiple cores, or the like without departing from the scope of the instant application. The vehicle 202 may be a vehicle, server or any device with a processor and memory.

The processors and/or computer-readable storage medium may fully or partially reside in the interior or exterior of the vehicles. The steps or features stored in the computer-readable storage medium may be fully or partially performed by any of the processors and/or elements in any order. Additionally, one or more steps or features may be added, omitted, combined, performed at a later time, etc.

FIG. 2E illustrates a flow diagram 260, according to the instant solution. Referring to FIG. 2E, the instant solution includes one or more of processing, by at least one processor on a vehicle, a query related to a sign proximate a road that the vehicle is traveling on using a first artificial intelligence (AI) model deployed on the vehicle to generate contextual information related to the sign 244E, sending, by the at least one processor, the query and the contextual information to a second AI model deployed on a server off the vehicle 246E, processing, by the server, the query and the contextual information using the second AI model 248E, generating, by the server, a response related to the query and the contextual information 250E, sending, by the server, the response to the at least one processor 252E, and providing, by the at least one processor, the response to the vehicle 254E.

FIG. 2F illustrates another flow diagram 270, according to the instant solution. Referring to FIG. 2F, the instant solution includes one or more of the processing of the query and the contextual information occurs responsive to determining that an environmental condition exceeds a threshold 244F, the query and the contextual information are sent to the second AI model when a complexity of the contextual information is above a threshold 245F, the generating of the contextual information comprises collecting, by sensors on the vehicle, data associated with an environment of the vehicle; and wherein information depicted on the sign relates to the data 246F, the first AI model is trained using auditory signals and is executed to generate the contextual information based on received auditory signals 247F the second AI model processes the query and the contextual information by applying a context-based adaptor related to a current condition of the vehicle, and wherein the response related to the current condition of the vehicle 248F, the processing of the query related to the sign is performed when the sign is at least one of a sign that exists proximate the road less than a first threshold number of times or determined to be an importance greater than a second threshold based on the contextual information 249F.

FIG. 2G illustrates yet another vehicle network diagram 240G, according to the instant solution. The network comprises elements including a vehicle 202, a processor 204, and a non-transitory computer-readable storage medium 242G. The processor 204 is communicably coupled to the non-transitory computer-readable storage medium 242G and elements 230 (which were depicted in FIG. 2B). The vehicle 202 may be a vehicle, server, or any device with a processor and memory.

The processor 204 performs one or more of analyzing a sign proximate a road that a vehicle is traveling on to determine an action to be performed by the vehicle and a level of the action to be performed 244G, determining a query related to the action to be performed when the action to be performed is above a first threshold 246G, responsive to the action being below a second threshold, processing the query to generate a first response 248G, responsive to the action being at or above the second threshold, sending the query to a server 250G, receiving a second response from the server to the query 252G, and autonomously performing the action, by the vehicle, based on at least one of the first response or the second response 254G.

FIG. 2H illustrates a further vehicle network diagram 250H, according to the instant solution. The network comprises elements including a vehicle 202, a processor 204, and a non-transitory computer-readable storage medium 242H and elements 230 (which were depicted in FIG. 2B). The vehicle 202 may be a vehicle, server or any device with a processor and memory.

The processor 204 performs one or more of determining the level of the action related to the vehicle is to be performed comprises analyzing at least one parameter associated with an operation of the vehicle and comparing the at least one parameter to at least one threshold to identify the action 244H, the query related to the action to be performed is determined by a first AI model deployed on the vehicle, the first AI model analyzes data associated with the sign and contextual information to generate the query 245H processing of the query and contextual information is performed by a second AI model on the server, the second AI model generating the second response by analyzing the query in combination with external data 246H, enhancing the first response with area-specific information when an area where the vehicle is maneuvering is a new area 247H, receiving data related to a visibility of the sign; and raising the level of the action when the visibility is below a threshold 248H, and detecting, by the server, a road condition greater than a threshold in an area past the sign and wherein the second response causes the vehicle to respond, based on the road condition 249H.

The processors and/or computer-readable storage medium may fully or partially reside in the interior or exterior of the vehicles. The steps or features stored in the computer-readable storage medium may be fully or partially performed by any of the processors and/or elements in any order. Additionally, one or more steps or features may be added, omitted, combined, performed at a later time, etc.

FIG. 2I illustrates a flow diagram 260I, according to the instant solution. Referring to FIG. 2I, the instant solution includes one or more of analyzing a sign proximate a road that a vehicle is traveling on to determine an action to be performed by the vehicle and a level of the action to be performed 244I, determining a query related to the action to be performed when the action to be performed is above a first threshold 246I, responsive to the action being below a second threshold, processing the query to generate a first response 248I, responsive to the action being at or above the second threshold, sending the query to a server 250I, receiving a second response from the server to the query 252I, and autonomously performing the action, by the vehicle, based on at least one of the first response or the second response 254I.

FIG. 2J illustrates another flow diagram 270J, according to the instant solution. Referring to FIG. 2J, the instant solution includes one or more of determining the level of the action related to the vehicle is to be performed comprises analyzing at least one parameter associated with an operation of the vehicle and comparing the at least one parameter to at least one threshold to identify the action 244J, the query related to the action to be performed is determined by a first AI model deployed on the vehicle, the first AI model analyzes data associated with the sign and contextual information to generate the query 245J, processing of the query and contextual information is performed by a second AI model on the server, the second AI model generating the second response by analyzing the query in combination with external data 246J, enhancing the first response with area-specific information when an area where the vehicle is maneuvering is a new area 247J, receiving data related to a visibility of the sign; and raising the level of the action when the visibility is below a threshold 248J, and detecting, by the server, a road condition greater than a threshold in an area past the sign and wherein the second response causes the vehicle to respond, based on the road condition 249J.

Technological advancements typically build upon the fundamentals of predecessor technologies; such is the case with Artificial Intelligence (AI) models. An AI classification system describes the stages of AI progression. The first classification is known as “Reactive Machines,” followed by present-day AI classification “Limited Memory Machines” (also known as “Artificial Narrow Intelligence”), then progressing to “Theory of Mind” (also known as “Artificial General Intelligence”), and reaching the AI classification “Self-Aware” (also known as “Artificial Superintelligence”). Present-day Limited Memory Machines are a growing group of AI models built upon the foundation of its predecessor, Reactive Machines. Reactive Machines emulate human responses to stimuli; however, they are limited in their capabilities as they cannot typically learn from prior experience. Once the AI model's learning abilities emerged, its classification was promoted to Limited Memory Machines. In this present-day classification, AI models learn from large volumes of data, detect patterns, solve problems, generate and predict data, and the like, while inheriting all of the capabilities of Reactive Machines. Examples of AI models classified as Limited Memory Machines include, but are not limited to, Chatbots, Virtual Assistants, Machine Learning (ML), Deep Learning (DL), Natural Language Processing (NLP), Generative AI (GenAI) models, and any future AI models that are yet to be developed possessing characteristics of Limited Memory Machines. Generative AI models combine Limited Memory Machine technologies, incorporating ML and DL, forming the foundational building blocks of future AI models. For example, Theory of Mind is the next progression of AI that may be able to perceive, connect, and react by generating appropriate reactions in response to an entity with which the AI model is interacting; all of these capabilities rely on the fundamentals of Generative AI. Furthermore, in an evolution into the Self-Aware classification, AI models will be able to understand and evoke emotions in the entities they interact with, as well as possess their own emotions, beliefs, and needs, all of which rely on the Generative AI fundamentals of learning from experiences to generate and draw conclusions about itself and its surroundings. Generative AI models are integral and core to future artificial intelligence models. As described herein, Generative AI refers to present-day Generative AI models and future AI models.

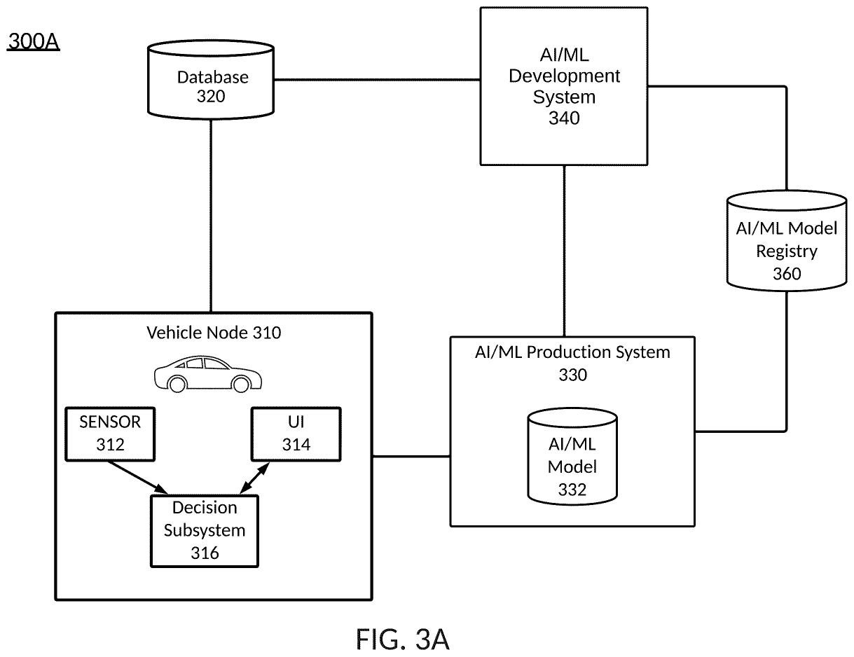

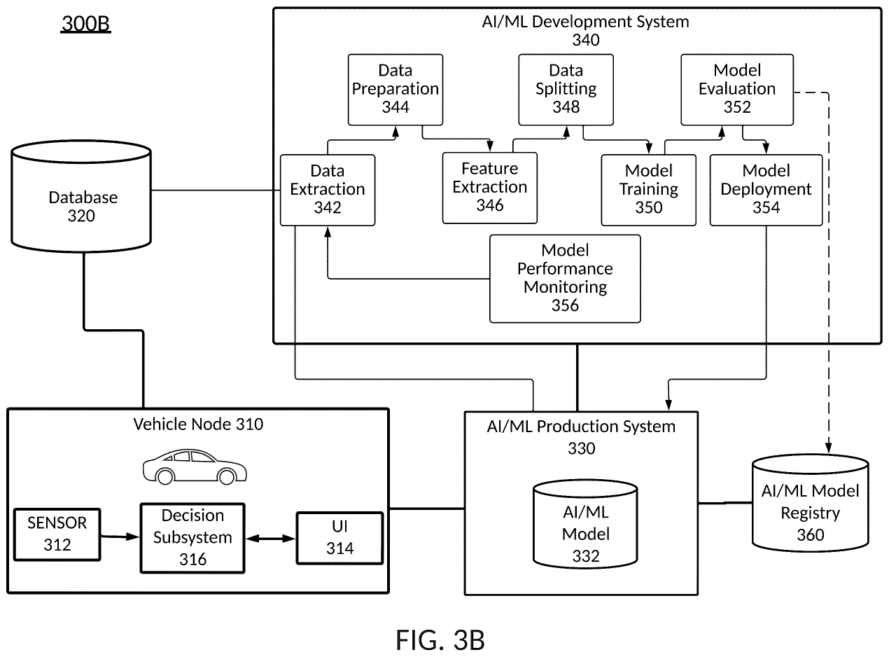

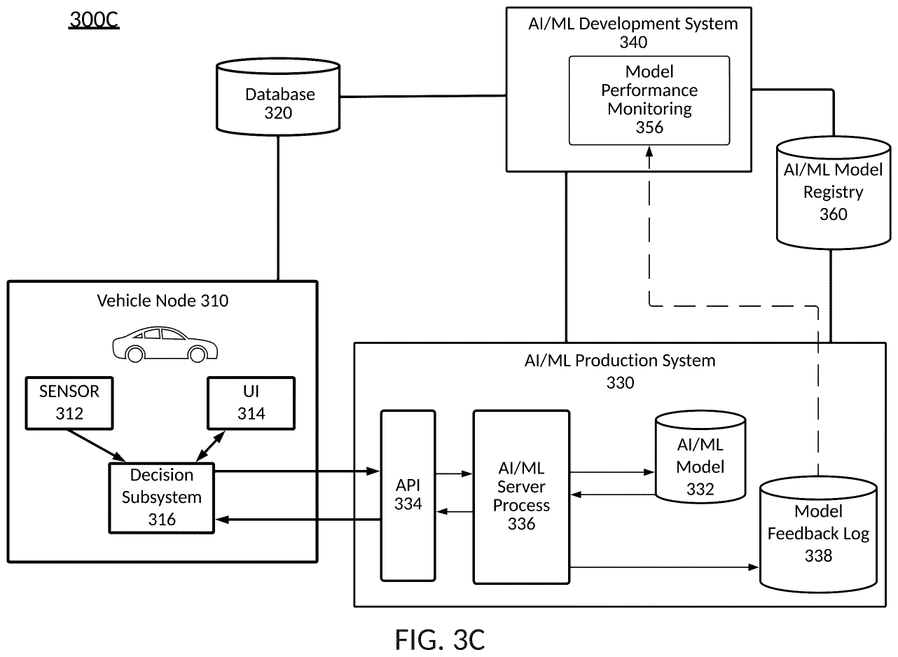

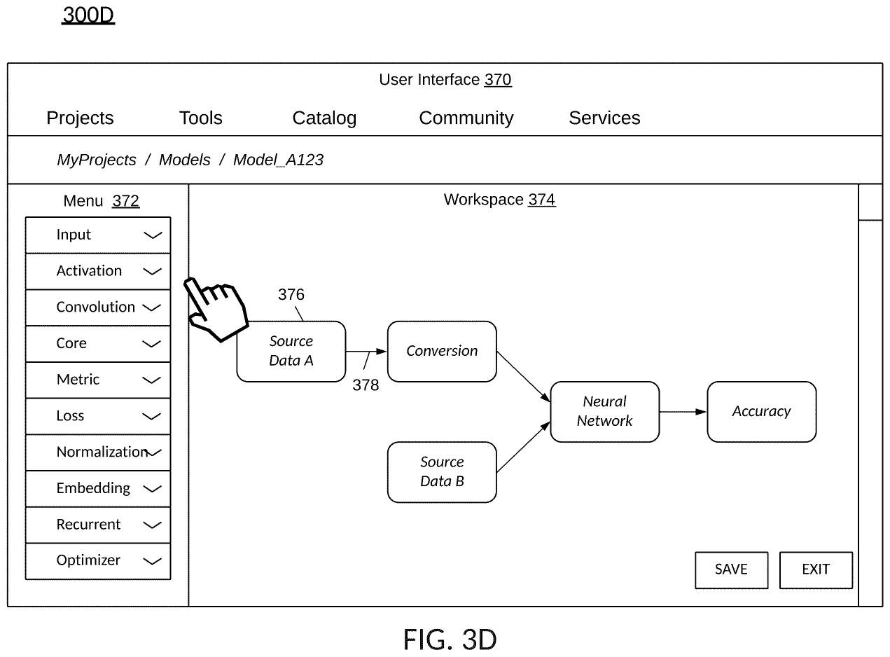

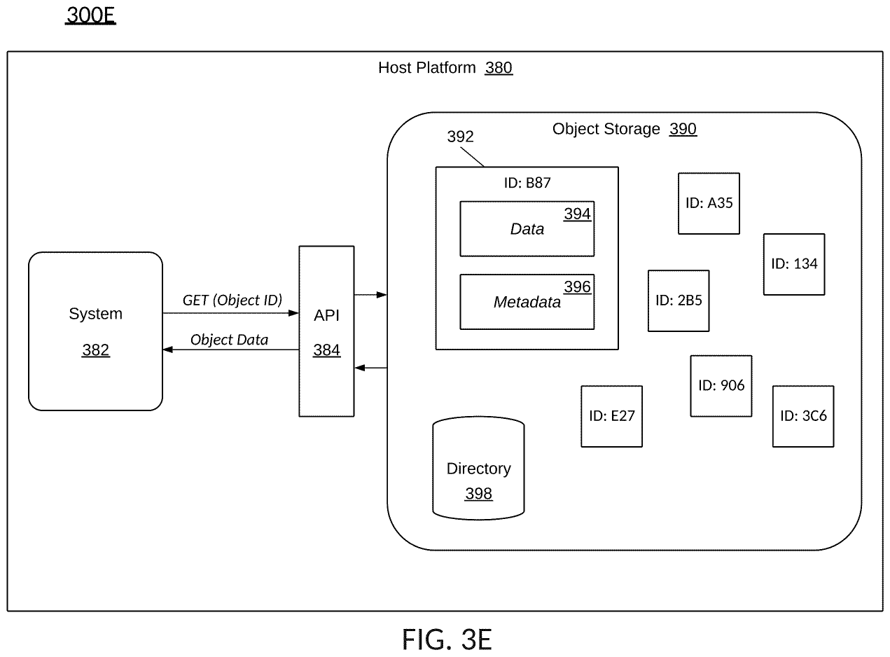

FIG. 3A illustrates an AI/ML network diagram 300A that supports AI-assisted vehicle or occupant decision points. Other branches of AI, such as, but not limited to, computer vision, fuzzy logic, expert systems, neural networks/deep learning, generative AI, and natural language processing, may all be employed in developing the AI model shown in these configurations. Further, the AI model included in these configurations is not limited to a particular AI algorithm. Any algorithm or combination of algorithms related to supervised, unsupervised, and reinforcement learning algorithms may be employed.

In one configuration of the instant solution, Generative AI (GenAI) may be used by the instant solution in the transformation of data. Vehicles are equipped with diverse sensors, cameras, radars, and LiDARs, which collect a vast array of data, such as images, speed readings, GPS data, and acceleration metrics. However, raw data, once acquired, undergoes preprocessing that may involve normalization, anonymization, missing value imputation, or noise reduction to allow the data to be further used effectively.

The GenAI executes data augmentation following the preprocessing of the data. Due to the limitation of datasets in capturing the vast complexity of real-world vehicle scenarios, augmentation tools are employed to expand the dataset. This might involve image-specific transformations like rotations, translations, or brightness adjustments. For non-image data, techniques like jittering can be used to introduce synthetic noise, simulating a broader set of conditions.

In the instant solution, data generation is then performed on the data. Tools like Generative Adversarial Networks (GANs) and Variational Autoencoders (VAEs) are trained on existing datasets to generate new, plausible data samples. For example, GANs might be tasked with crafting images showcasing vehicles in uncharted conditions or from unique perspectives. As another example, the synthesis of sensor data may be performed to model and create synthetic readings for such scenarios, enabling thorough system testing without actual physical encounters. A critical step in the use of GenAI, given the safety-critical nature of vehicles, is validation. This validation might include the output data being compared with real-world datasets or using specialized tools like a GAN discriminator to gauge the realism of the crafted samples. The AI model may be implemented, where implemented may include at least one of: developing the model, deploying the model, accessing the model, selecting the model, running the model, optimizing the model, monitoring the model, maintaining the model, etc.

Vehicle node 310 may include a plurality of sensors 312 that may include but are not limited to, light sensors, weight sensors, cameras, LiDAR, and radar. In some configurations of the instant solution, these sensors 312 send data to a database 320 that stores data about the vehicle and occupants of the vehicle. In some configurations of the instant solution, these sensors 312 send data to one or more decision subsystems 316 in vehicle node 310 to assist in decision-making.

Vehicle node 310 may include one or more user interfaces (UIs) 314, such as a steering wheel, navigation controls, audio/video controls, temperature controls, etc. In some configurations of the instant solution, these UIs 314 send data to a database 320 that stores event data about the UIs 314 that includes but is not limited to selection, state, and display data. In some configurations of the instant solution, these UIs 314 send data to one or more decision subsystems 316 in vehicle node 310 to assist decision-making.

Vehicle node 310 may include one or more decision subsystems 316 that drive a decision-making process around, but not limited to, vehicle control, temperature control, charging control, etc. In some configurations of the instant solution, the decision subsystems 316 gather data from one or more sensors 312 to aid in the decision-making process. In some configurations of the instant solution, a decision subsystem 316 may gather data from one or more UIs 314 to aid in the decision-making process. In some configurations of the instant solution, a decision subsystem 316 may provide feedback to a UI 314.

An AI/ML production system 330 may be used by a decision subsystem 316 in a vehicle node 310 to assist in its decision-making process. The AI/ML production system 330 includes one or more AI/ML models 332 that are executed to retrieve the needed data, such as, but not limited to, a prediction, a categorization, a UI prompt, etc. In some configurations of the instant solution, an AI/ML production system 330 is hosted on a server. In some configurations of the instant solution, the AI/ML production system 330 is cloud-hosted. In some configurations of the instant solution, the AI/ML production system 330 is deployed in a distributed multi-node architecture. In some configurations of the instant solution, the AI production system resides in vehicle node 310.

An AI/ML development system 340 creates one or more AI/ML models 332. In some configurations of the instant solution, the AI/ML development system 340 utilizes data in the database 320 to develop and train one or more AI models 332. In some configurations of the instant solution, the AI/ML development system 340 utilizes feedback data from one or more AI/ML production systems 330 for new model development and/or existing model re-training. In another configuration of the instant solution, the AI/ML development system 340 resides and executes on a server. In another configuration of the instant solution, the AI/ML development system 340 is cloud-hosted. In a further configuration of the instant solution, the AI/ML development system 340 utilizes a distributed data pipeline/analytics engine.

Once an AI/ML model 332 has been trained and validated in the AI/ML development system 340, it may be stored in an AI/ML model registry 360 for retrieval by either the AI/ML development system 340 or by one or more AI/ML production systems 330. The AI/ML model registry 360 resides in a dedicated server in one configuration of the instant solution. In some configurations of the instant solution, the AI/ML model registry 360 is cloud-hosted. The AI/ML model registry 360 is a distributed database in other examples of the instant solution. In further examples of the instant solution, the AI/ML model registry 360 resides in the AI/ML production system 330.

FIG. 3B illustrates a process 300B for developing one or more AI/ML models that support AI-assisted vehicle or occupant decision points. An AI/ML development system 340 executes steps to develop an AI/ML model 332 that begins with data extraction 342, in which data is loaded and ingested from one or more data sources. In some examples of the instant solution, vehicle and user data is extracted from a database 320. In some examples of the instant solution, model feedback data is extracted from one or more AI/ML production systems 330.

Once the required data has been extracted 342, it must be prepared 344 for model training. In some examples of the instant solution, this step involves statistical testing of the data to see how well it reflects real-world events, its distribution, the variety of data in the dataset, etc. In some examples of the instant solution, the results of this statistical testing may lead to one or more data transformations being employed to normalize one or more values in the dataset. In some examples of the instant solution, this step includes cleaning data deemed to be noisy. A noisy dataset includes values that do not contribute to the training, such as but not limited to, null and long string values. Data preparation 344 may be a manual process or an automated process using one or more of the elements and/or functions described or depicted herein.

Features of the data are identified and extracted 346. In some examples of the instant solution, a feature of the data is internal to the prepared data from step 344. In other examples of the instant solution, a feature of the data requires a piece of prepared data from step 344 to be enriched by data from another data source to be used in developing an AI/ML model 332. In some examples of the instant solution, identifying features is a manual process or an automated process using one or more of the elements and/or functions described or depicted herein. Once the features have been identified, the values of the features are collected into a dataset that will be used to develop the AI/ML model 332.

The dataset output from feature extraction step 346 is split 348 into a training and a validation data set. The training data set is used to train the AI/ML model 332, and the validation data set is used to evaluate the performance of the AI/ML model 332 on unseen data.

The AI/ML model 332 is trained and tuned 350 using the training data set from the data splitting step 348. In this step, the training data set is fed into an AI/ML algorithm with an initial set of algorithm parameters. The performance of the AI/ML model 332 is then tested within the AI/ML development system 340 utilizing the validation data set from step 348. These steps may be repeated with adjustments to one or more algorithm parameters until the model's performance is acceptable based on various goals and/or results.

The AI/ML model 332 is evaluated 352 in a staging environment (not shown) that resembles the ultimate AI/ML production system 330. This evaluation uses a validation dataset to ensure the performance in an AI/ML production system 330 matches or exceeds expectations. In some examples of the instant solution, the validation dataset from step 348 is used. In other examples of the instant solution, one or more unseen validation datasets are used. In some examples of the instant solution, the staging environment is part of the AI/ML development system 340. In other examples of the instant solution, the staging environment is managed separately from the AI/ML development system 340. Once the AI/ML model 332 has been validated, it is stored in an AI/ML model registry 360, which can be retrieved for deployment and future updates. As before, in some configurations of the instant solution, the model evaluation step 352 is a manual process or an automated process using one or more of the elements and/or functions described or depicted herein.

Once an AI/ML model 332 has been validated and published to an AI/ML model registry 360, it may be deployed 354 to one or more AI/ML production systems 330. In some examples of the instant solution, the performance of deployed AI/ML models 332 is monitored 356 by the AI/ML development system 340. In some examples of the instant solution, AI/ML model 332 feedback data is provided by the AI/ML production system 330 to enable model performance monitoring 356. In some examples of the instant solution, the AI/ML development system 340 periodically requests feedback data for model performance monitoring 356. In some examples of the instant solution, model performance monitoring includes one or more triggers that result in the AI/ML model 332 being updated by repeating steps 342-354 with updated data from one or more data sources.

FIG. 3C illustrates a process 300C for utilizing an AI/ML model that supports AI-assisted vehicle or occupant decision points. As stated previously, the AI model utilization process depicted herein reflects ML, which is a particular branch of AI, but the instant solution is not limited to ML and is not limited to any AI algorithm or combination of algorithms.

Referring to FIG. 3C, an AI/ML production system 330 may be used by a decision subsystem 316 in vehicle node 310 to assist in its decision-making process. The AI/ML production system 330 provides an application programming interface (API) 334, executed by an AI/ML server process 336 through which requests can be made. In some examples of the instant solution, a request may include an AI/ML model 332 identifier to be executed. In some examples of the instant solution, the AI/ML model 332 to be executed is implicit based on the type of request. In some examples of the instant solution, a data payload (e.g., to be input to the model during execution) is included in the request. In some examples of the instant solution, the data payload includes sensor 312 data received from vehicle node 310. In some examples of the instant solution, the data payload includes UI 314 data from vehicle node 310. In some examples of the instant solution, the data payload includes data from other vehicle node 310 subsystems (not shown), including but not limited to, occupant data subsystems. In some examples of the instant solution, one or more elements or nodes 320, 330, 340, or 360 may be located in the vehicle node 310.

Upon receiving the API 334 request, the AI/ML server process 336 may need to transform the data payload or portions of the data payload to be valid feature values in an AI/ML model 332. Data transformation may include but is not limited to combining data values, normalizing data values, and enriching the incoming data with data from other data sources. Once any required data transformation occurs, the AI/ML server process 336 executes the appropriate AI/ML model 332 using the transformed input data. Upon receiving the execution result, the AI/ML server process 336 responds to the API caller, which is a decision subsystem 316 of vehicle node 310. In some examples of the instant solution, the response may result in an update to a UI 314 in vehicle node 310. In some examples of the instant solution, the response includes a request identifier that can be used later by the decision subsystem 316 to provide feedback on the AI/ML model 332 performance. Further, in some configurations of the instant solution, immediate performance feedback may be recorded into a model feedback log 338 by the AI/ML server process 336. In some examples of the instant solution, execution model failure is a reason for immediate feedback.

In some examples of the instant solution, the API 334 includes an interface to provide AI/ML model 332 feedback after an AI/ML model 332 execution response has been processed. This mechanism may be used to evaluate the performance of the AI/ML model 332 by enabling the API caller to provide feedback on the accuracy of the model results. For example, if the AI/ML model 332 provided an estimated time of arrival of 20 minutes, but the actual travel time was 24 minutes, that may be indicated. In some examples of the instant solution, the feedback interface includes the identifier of the initial request so that it can be used to associate the feedback with the request. Upon receiving a call into the feedback interface of API 334, the AI/ML server process 336 records the feedback in the model feedback log 338. In some examples of the instant solution, the data in this model feedback log 338 is provided to model performance monitoring 356 in the AI/ML development system 340. This log data is streamed to the AI/ML development system 340 in one example of the instant solution. In some examples of the instant solution, the log data is provided upon request. In some examples and features of the instant solution, the model feedback records in the model feedback log 338 are used as input for retraining the AI model 332.

Model retraining involves repeating steps 342-354 using the current data in the data source along with the model feedback log 338. In some examples and features of the instant solution, the AI model 332 is retrained periodically as a matter of business process to consider the latest data and/or retrained based on a trigger, such as, but not limited to, a recent model accuracy falling below a predetermined threshold. In some examples and features of the instant solution, the model feedback data 338 is used as input to determine the recent model accuracy.

A number of the steps/features that may utilize the AI/ML process described herein include one or more of: processing, by at least one processor on a vehicle, a query related to a sign proximate a road that the vehicle is traveling on using a first artificial intelligence (AI) model deployed on the vehicle to generate contextual information related to the sign, sending, by the at least one processor, the query and the contextual information to a second AI model deployed on a server off the vehicle, processing, by the server, the query and the contextual information using the second AI model, generating, by the server, a response related to the query and the contextual information, sending, by the server, the response to the at least one processor, and providing, by the at least one processor, the response to the vehicle.

Data associated with any of these steps/features, as well as any other features or functionality described or depicted herein, the AI/ML production system 330, as well as one or more of the other elements depicted in FIG. 3C may be used to process this data in a pre-transformation and/or post-transformation process. Data related to this process can be used by the vehicle node 310. In one example of the instant solution, data related to this process may be used with a charging infrastructure, such as charging station, a server, a wireless device, and/or any of the processors described or depicted herein.

FIG. 3D illustrates a process 300D of designing a new machine learning model via a user interface 370 of the system according to examples of the instant solution. As an example, a model may be output as part of the AI/ML Development System 340. Referring to FIG. 3D, a user can use an input mechanism from menu 372 of a user interface 370 to add pieces/components to a model being developed within a workspace 374 of the user interface 370.

The menu 372 includes a plurality of graphical user interface (GUI) menu options which can be selected to reveal additional components that can be added to the model design shown in the workspace 374. The GUI menu includes options for adding elements to the workspace, such as features which may include neural networks, machine learning models, AI models, data sources, conversion processes (e.g., vectorization, encoding, etc.), analytics, etc. The user can continue to add features to the model and connect them using edges or other elements to create a flow within the workspace 374. For example, the user may add a node 376 to a flow of a new model within the workspace 374. For example, the user may connect the node 376 to another node in the diagram via an edge 378, creating a dependency within the diagram. When the user is done, the user can save the model for subsequent training/testing.

In another example, the name of the object can be identified from a web page or a user interface 370 where the object is visible within a browser or the workspace 374 on the user device. A pop-up within the browser or the workspace 374 can be overlayed where the object is visible. The pop-up includes an option to navigate to the identified web page corresponding to the alternative object via a rule set.

FIG. 3E illustrates a process 300E of accessing an object 392 from an object storage 390 of the host platform 380 according to examples of the instant solution. For example, the object storage 390 may store data that is used by the AI models and machine learning (ML) models, including but not limited to training data, expected outputs for testing, training results, and the like. The object storage 390 may also store any other kind of data. Each object may include a unique identifier, a data section 394, and a metadata section 396, which provide a descriptive context associated with the data, including data that can later be extracted for purposes of machine learning. The unique identifier may uniquely identify an object with respect to all other objects in the object storage 390. The data section 394 may include unstructured data such as web pages, digital content, images, audio, text, and the like.

Instead of breaking files into blocks stored on disks in a file system, the object storage 390 handles objects as discrete units of data stored in a structurally flat data environment. Here, the object storage may not use folders, directories, or complex hierarchies. Instead, each object may be a simple, self-contained repository that includes the data, the metadata, and the unique identifier that a client application can use to locate and access it. In this case, the metadata is more descriptive than a file-based approach. The metadata can be customized with additional context that can later be extracted and leveraged for other purposes, such as data analytics.

The objects that are stored in the object storage 390 may be accessed via an API 384. The API 384 may be a Hypertext Transfer Protocol (HTTP)-based RESTful API (also known as a RESTful Web service). The API 384 can be used by the client application or system 382 to query an object's metadata to locate the desired object data via the Internet from anywhere on any device. The API 384 may use HTTP commands such as “PUT” or “POST” to upload an object, “GET” to retrieve an object, “DELETE” to remove an object, and the like.

The object storage 390 may provide a directory 398 that uses the metadata of the objects to locate appropriate data files. The directory 398 may contain descriptive information about each object stored in the object storage 390, such as a name, a unique identifier, a creation timestamp, a collection name, etc. To query the object within the object storage 390, the client application may submit a command, such as an HTTP command, with an identifier of the object 392, a payload, etc. The object storage 390 can store the actions and results described herein, including associating two or more lists of ranked assets with one another based on variables used by the two or more lists of ranked assets that have a correlation at or above a predetermined threshold.

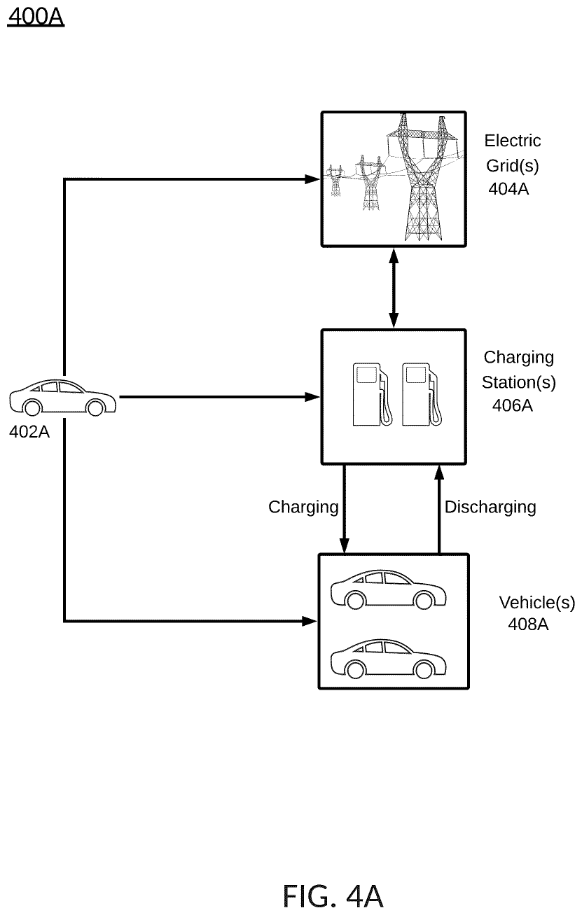

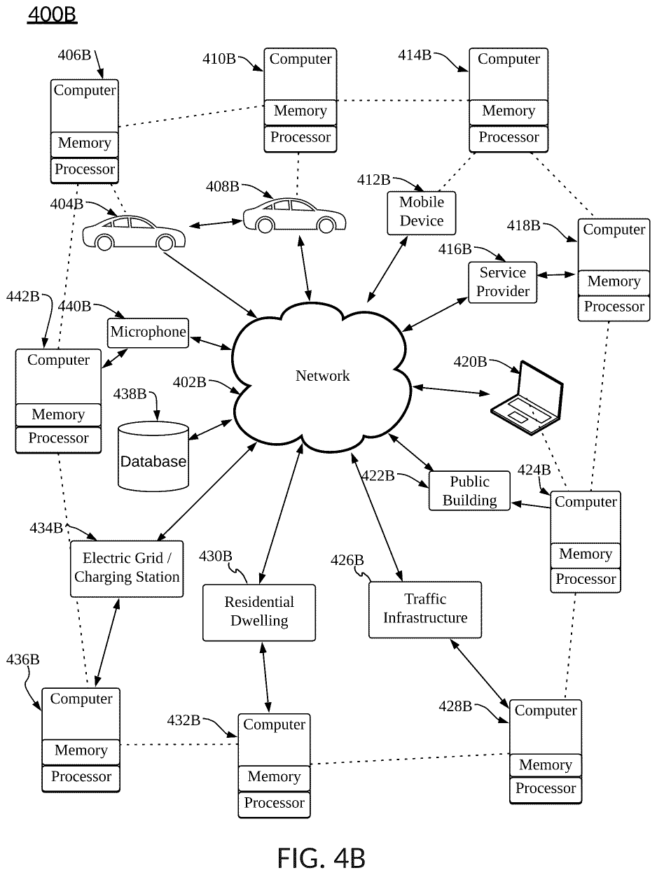

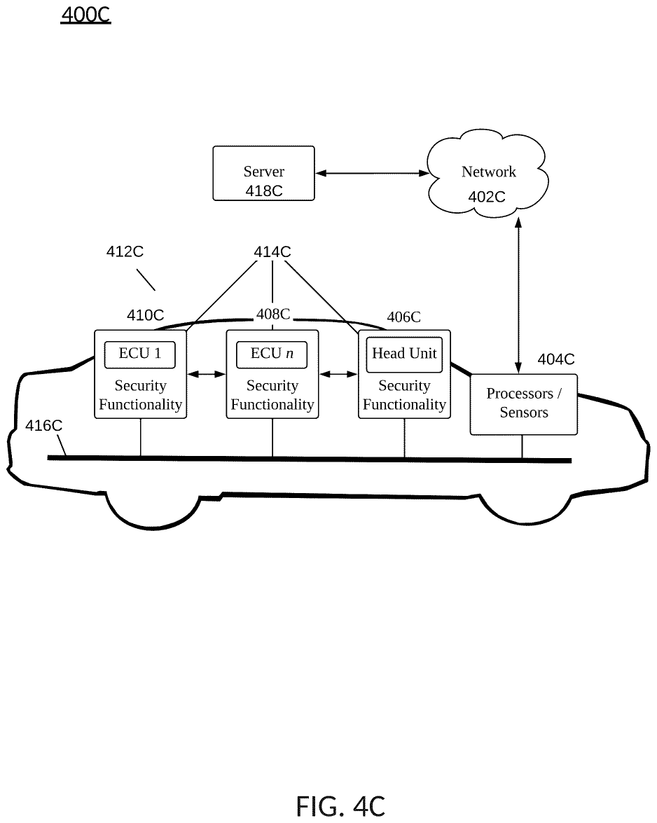

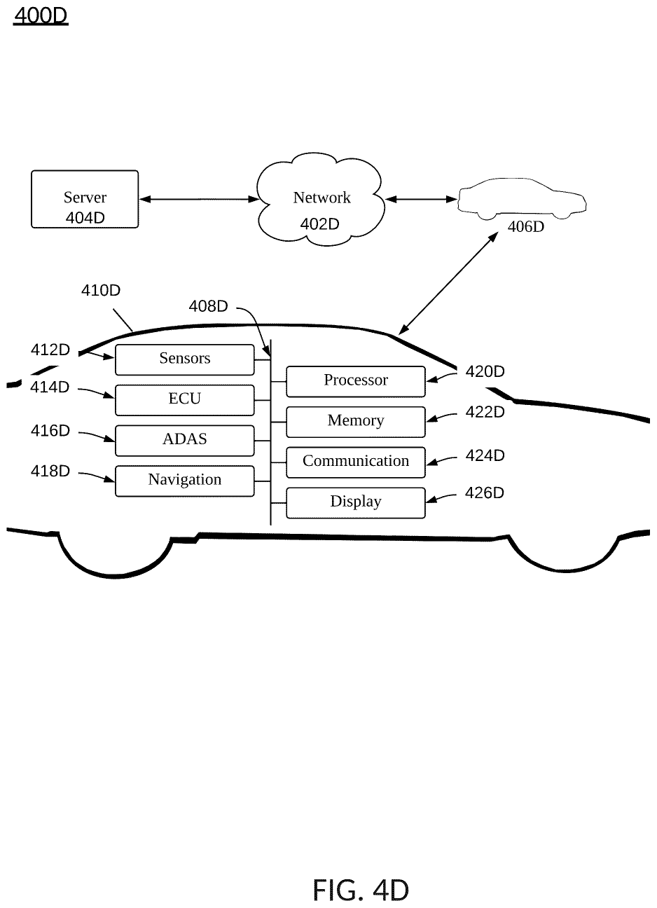

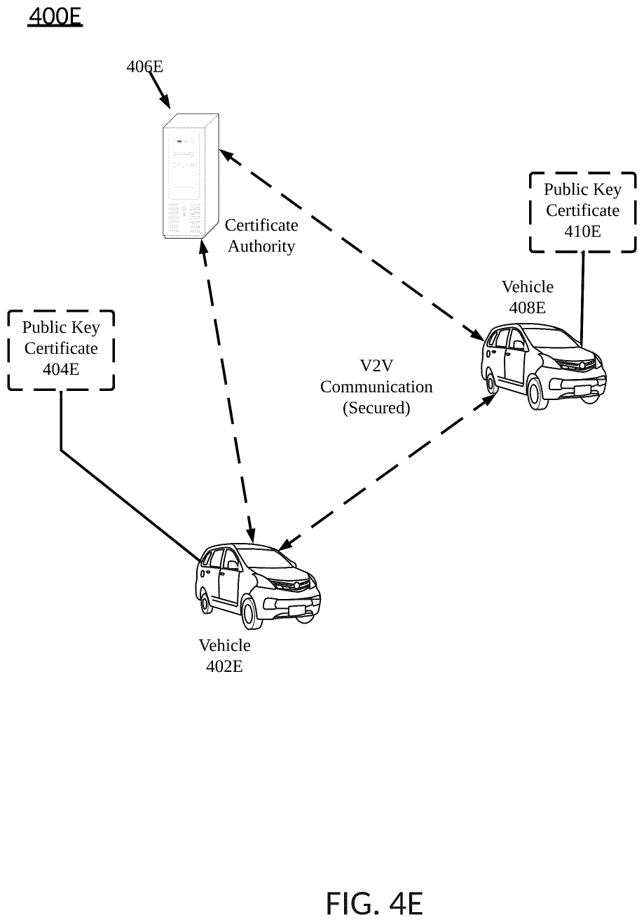

FIG. 4A illustrates a diagram 400A depicting the electrification of one or more elements. In one example, a vehicle 402A may provide energy stored in its batteries to one or more elements, including other vehicle(s) 408A, charging station(s) 406A, and electric grid(s) 404A. The electric grid(s) 404A is/are coupled to one or more of the charging station(s) 406A, which may be coupled to one or more of the vehicle(s) 408A. This configuration allows the distribution of electricity/power received from the vehicle 402A. The vehicle 402A may also interact with the other vehicle(s) 408A, such as via V2V technology, communication over cellular networks, Wi-Fi®, and the like. The vehicle 402A may also interact via wired and/or wireless connections with other vehicles 408A, the charging station(s) 406A and/or with the electric grid(s) 404A. In one example, the vehicle 402A is routed (or routes itself) in a safe and efficient manner to the electric grid(s) 404A, the charging station(s) 406A, or the other vehicle(s) 408A. Using one or more examples of the instant solution, the vehicle 402A can provide energy to one or more of the elements depicted herein in various advantageous ways as described and/or depicted herein. Further, the safety and efficiency of the vehicle may be increased, and the environment may be positively affected as described and/or depicted herein. The hierarchy of a charging network may include a charging location which is a physical location where a vehicle may maneuver to connect and receive electricity. The charging location may include one or more charging stations. A charging bay may be proximate or associated with each charging station. A charging apparatus may be on the charging station, and a charging port on the vehicle may be configured to accept the charging apparatus to charge a battery on the vehicle. The connection between the charging apparatus and the vehicle may be a physical and/or a wireless connection.

The terms ‘energy,’ ‘electricity,’ ‘power,’ and the like may be used to denote any form of energy received, stored, used, shared, and/or lost by the vehicle(s). The energy may be referred to in conjunction with a voltage source and/or a current supply of charge provided from an entity to the vehicle(s) during a charge/use operation. Energy may also be in the form of fossil fuels (for example, for use with a hybrid vehicle) or via alternative power sources, including but not limited to lithium-based, nickel-based, hydrogen fuel cells, atomic/nuclear energy, fusion-based energy sources, and energy generated during an energy sharing and/or usage operation for increasing or decreasing one or more vehicles energy levels at a given time.

In one example, the charging station 406A manages the amount of energy transferred from the vehicle 402A such that there is sufficient charge remaining in the vehicle 402A to arrive at a destination. In another example, a wireless connection is used to wirelessly direct an amount of energy transfer between vehicles 408A, wherein the vehicles may both be in motion. In another example, wireless charging may occur via a fixed charger and batteries of the vehicle in alignment with one another (such as a charging mat in a garage or parking space). In another example, an idle vehicle, such as a vehicle 402A (which may be autonomous) is directed to provide an amount of energy to a charging station 406A and return to the original location (for example, its original location or a different destination). In another example, a mobile energy storage unit (not shown) is used to collect surplus energy from at least one other vehicle 408A and transfer the stored surplus energy at a charging station 406A. In another example, factors determine an amount of energy to transfer to a charging station 406A, such as distance, time, traffic conditions, road conditions, environmental/weather conditions, the vehicle's condition (weight, etc.), an occupant(s) schedule while utilizing the vehicle, a prospective occupant(s) schedule waiting for the vehicle, etc. In another example, the vehicle(s) 408A, the charging station(s) 406A and/or the electric grid(s) 404A can provide energy to the vehicle 402A.

In one example of the instant solution, a location such as a building, a residence, or the like (not depicted), is communicably coupled to one or more of the electric grid(s) 404A, the vehicle 402A, and/or the charging station(s) 406A. The rate of electric flow to one or more of the location, the vehicle 402A and/or the other vehicle(s) 408A is modified, depending on external conditions, such as weather. For example, when the external temperature is extremely hot or extremely cold, raising the chance for an outage of electricity, the flow of electricity to a connected vehicle 402A/408A is slowed to help minimize the chance of an outage.

In one example of the instant solution, vehicles 402A and 408A may be utilized as bidirectional vehicles. Bidirectional vehicles are those that may serve as mobile microgrids that can assist in the supplying of electrical power to the grid 404A and/or reduce the power consumption when the grid is stressed. Bidirectional vehicles incorporate bidirectional charging, which in addition to receiving a charge to the vehicle, the vehicle can transfer energy from the vehicle to the grid 404A, otherwise referred to as “V2G”. In bidirectional charging, the electricity flows both ways; to the vehicle and from the vehicle. When a vehicle is charged, alternating current (AC) electricity from the grid 404A is converted to direct current (DC). This may be performed by one or more of the vehicle's own converter(s) or a converter on the charging station 406A. The energy stored in the vehicle's batteries may be sent in an opposite direction back to the grid. The energy is converted from DC to AC through a converter usually located in the charging station 406A, otherwise referred to as a bidirectional charger. Further, the instant solution as described and depicted with respect to FIG. 4A can be utilized in this and other networks and/or systems.

FIG. 4B is a diagram showing interconnections between different elements 400B. The instant solution may be stored and/or executed entirely or partially on and/or by one or more computing devices 414B, 418B, 424B, 428B, 432B, 436B, 406B, 442B and 410B associated with various entities, all communicably coupled and in communication with a network 402B. A database 438B is communicably coupled to the network and allows for the storage and retrieval of data. In one example, the database is an immutable ledger. One or more of the various entities may be a vehicle 404B, service provider 416B, public building 422B, traffic infrastructure 426B, residential dwelling 430B, an electric grid/charging station 434B, a microphone 440B, and/or another vehicle 408B. Other entities and/or devices, such as one or more private users using a mobile device 412B, a laptop 420B, an augmented reality (AR) device, a virtual reality (VR) device, and/or any wearable device may also interwork with the instant solution. The mobile device 412B, laptop 420B, microphone 440B, and other devices may be connected to one or more of the connected computing devices 414B, 418B, 424B, 428B, 432B, 436B, 406B, 442B, and 410B. The one or more public buildings 422B may include various agencies. The one or more public buildings 422B may utilize a computing device 424B. The one or more service provider(s) 416B may include a dealership, a tow truck service, a collision center, or other repair shop. The one or more service provider(s) 416B may utilize a computing apparatus 418B. These various computer devices may be directly and/or communicably coupled to one another, such as via wired networks, wireless networks, blockchain networks, and the like. In one example, the microphone 440B may be utilized as a virtual assistant. In another example, the one or more traffic infrastructure 426B may include one or more traffic signals, one or more sensors including one or more cameras, vehicle speed sensors or traffic sensors, and/or other traffic infrastructure. The one or more traffic infrastructure 426B may utilize a computing device 428B.

In one example of the instant solution, anytime an electrical charge is given or received to/from a charging station and/or an electrical grid, the entities that allow that to occur are one or more of a vehicle, a charging station, a server, and a network communicably coupled to the vehicle, the charging station, and the electrical grid.

In one example, a vehicle 408B/404B can transport a person, an object, a permanently or temporarily affixed apparatus, and the like. In another example, the vehicle 408B may communicate with vehicle 404B via V2V communication through the computers associated with each vehicle 406B and 410B and may be referred to as a car, vehicle, automobile, and the like. The vehicle 404B/408B may be a self-propelled wheeled conveyance, such as a car, a sports utility vehicle, a truck, a bus, a van, or other motor or battery-driven or fuel cell-driven vehicle. For example, vehicle 404B/408B may be an electric vehicle, a hybrid vehicle, a hydrogen fuel cell vehicle, a plug-in hybrid vehicle, or any other type of vehicle with a fuel cell stack, a motor, and/or a generator. Other examples of vehicles include bicycles, scooters, trains, planes, boats, and any other form of conveyance that is capable of transportation. The vehicle 404B/408B may be semi-autonomous or autonomous. For example, vehicle 404B/408B may be self-maneuvering and navigate without human input. An autonomous vehicle may have and use one or more sensors and/or a navigation unit to drive autonomously. All of the data described or depicted herein can be stored, analyzed, processed and/or forwarded by one or more of the elements in FIG. 4B.

FIG. 4C is another block diagram showing interconnections between different elements in one example 400C. A vehicle 412C is presented and includes ECUs 410C, 408C, and a head unit (otherwise known as an infotainment system) 406C. An ECU is an embedded system in automotive electronics that controls one or more of the electrical systems or subsystems in a vehicle. ECUs may include but are not limited to the management of a vehicle's engine, brake system, gearbox system, door locks, dashboard, airbag system, infotainment system, electronic differential, and active suspension. ECUs are connected to the vehicle's Controller Area Network (CAN) bus 416C. The ECUs may also communicate with a vehicle computer 404C via the CAN bus 416C. The vehicle's processors/sensors (such as the vehicle computer) 404C can communicate with external elements, such as a server 418C via a network 402C (such as the Internet). Each ECU 410C, 408C, and head unit 406C may contain its own security policy. The security policy defines permissible processes that can be executed in the proper context. In one example, the security policy may be partially or entirely provided in the vehicle computer 404C.

ECUs 410C, 408C, and head unit 406C may each include a custom security functionality element 414C defining authorized processes and contexts within which those processes are permitted to run. Context-based authorization to determine validity if a process can be executed allows ECUs to maintain secure operation and prevent unauthorized access from elements such as the vehicle's CAN Bus. When an ECU encounters a process that is unauthorized, that ECU can block the process from operating. Automotive ECUs can use different contexts to determine whether a process is operating within its permitted bounds, such as proximity contexts, nearby objects, distance to approaching objects, speed, and trajectory relative to other moving objects, and operational contexts such as an indication of whether the vehicle is moving or parked, the vehicle's current speed, the transmission state, user-related contexts such as devices connected to the transport via wireless protocols, use of the infotainment, cruise control, parking assist, driving assist, location-based contexts, and/or other contexts.

Referring to FIG. 4D, an operating environment 400D for a connected vehicle, is illustrated according to some examples of the instant solution. As depicted, the vehicle 410D includes a CAN bus 408D connecting elements 412D-426D of the vehicle. Other elements may be connected to the CAN bus and are not depicted herein. The depicted elements connected to the CAN bus include a sensor set 412D, Electronic Control Units 414D, autonomous features or Advanced Driver Assistance Systems (ADAS) 416D, and the navigation system 418D. In some examples of the instant solution, the vehicle 410D includes a processor 420D, a memory 422D, a communication unit 424D, and an electronic display 426D.

The processor 420D includes an arithmetic logic unit, a microprocessor, a general-purpose controller, and/or a similar processor array to perform computations and provide electronic display signals to a display unit 426D. The processor 420D processes data signals and may include various computing architectures, including a complex instruction set computer (CISC) architecture, a reduced instruction set computer (RISC) architecture, or an architecture implementing a combination of instruction sets. The vehicle 410D may include one or more processors 420D. Other processors, operating systems, sensors, displays, and physical configurations that are communicably coupled to one another (not depicted) may be used with the instant solution.

Memory 422D is a non-transitory memory storing instructions or data that may be accessed and executed by the processor 420D. The instructions and/or data may include code to perform the techniques described herein. The memory 422D may be a dynamic random-access memory (DRAM) device, a static random-access memory (SRAM) device, flash memory, or another memory device. In some examples of the instant solution, the memory 422D also may include non-volatile memory or a similar permanent storage device and media, which may include a hard disk drive, a floppy disk drive, a compact disc read only memory (CD-ROM) device, a digital versatile disk read only memory (DVD-ROM) device, a digital versatile disk random access memory (DVD-RAM) device, a digital versatile disk rewritable (DVD-RW) device, a flash memory device, or some other mass storage device for storing information on a permanent basis. A portion of the memory 422D may be reserved for use as a buffer or virtual random-access memory (virtual RAM). The vehicle 410D may include one or more memories 422D without deviating from the current solution.

The memory 422D of the vehicle 410D may store one or more of the following types of data: navigation route data 418D, and autonomous features data 416D. In some examples of the instant solution, the memory 422D stores data that may be necessary for the navigation application 418D to provide the functions.

The navigation system 418D may describe at least one navigation route including a start point and an endpoint. In some examples of the instant solution, the navigation system 418D of the vehicle 410D receives a request from a user for navigation routes wherein the request includes a starting point and an ending point. The navigation system 418D may query a real-time data server 404D (via a network 402D), such as a server that provides driving directions, for navigation route data corresponding to navigation routes, including the start point and the endpoint. The real-time data server 404D transmits the navigation route data to the vehicle 410D via a wireless network 402D, and the communication system 424D stores the navigation data 418D in the memory 422D of the vehicle 410D.

The ECU 414D controls the operation of many of the systems of the vehicle 410D, including the ADAS systems 416D. The ECU 414D may, responsive to instructions received from the navigation system 418D, deactivate any unsafe and/or unselected autonomous features for the duration of a journey controlled by the ADAS systems 416D. In this way, the navigation system 418D may control whether ADAS systems 416D are activated or enabled so that they may be activated for a given navigation route.

The sensor set 412D may include any sensors in the vehicle 410D generating sensor data. For example, the sensor set 412D may include short-range sensors and long-range sensors. In some examples of the instant solution, the sensor set 412D of the vehicle 410D may include one or more of the following vehicle sensors: a camera, a Light Detection and Ranging (LiDAR) sensor, an ultrasonic sensor, an automobile engine sensor, a radar sensor, a laser altimeter, a manifold absolute pressure sensor, an infrared detector, a motion detector, a thermostat, a sound detector, a carbon monoxide sensor, a carbon dioxide sensor, an oxygen sensor, a mass airflow sensor, an engine coolant temperature sensor, a throttle position sensor, a crankshaft position sensor, a valve timer, an air-fuel ratio meter, a blind spot meter, a curb feeler, a defect detector, a Hall effect sensor, a parking sensor, a radar gun, a speedometer, a speed sensor, a tire-pressure monitoring sensor, a torque sensor, a transmission fluid temperature sensor, a turbine speed sensor (TSS), a variable reluctance sensor, a vehicle speed sensor (VSS), a water sensor, a wheel speed sensor, a global positioning system (GPS) sensor, a mapping functionality, and any other type of automotive sensor. The navigation system 418D may store the sensor data in the memory 422D.

The communication unit 424D transmits and receives data to and from the network 402D or to another communication channel. In some examples of the instant solution, the communication unit 424D may include a dedicated short-range communication (DSRC) transceiver, a DSRC receiver, and other hardware or software necessary to make the vehicle 410D a DSRC-equipped device.

The vehicle 410D may interact with other vehicles 406D via V2V technology. V2V communication includes sensing radar information corresponding to relative distances to external objects, receiving GPS information of the vehicles, setting areas where the other vehicles 406D are located based on the sensed radar information, calculating probabilities that the GPS information of the object vehicles will be located at the set areas, and identifying vehicles and/or objects corresponding to the radar information and the GPS information of the object vehicles based on the calculated probabilities, in one example.

For a vehicle to be adequately secured, the vehicle must be protected from unauthorized physical access as well as unauthorized remote access (e.g., cyber-threats). To prevent unauthorized physical access, a vehicle is equipped with a secure access system such as a keyless entry in one example. Meanwhile, security protocols are added to a vehicle's computers and computer networks to facilitate secure remote communications to and from the vehicle in one example.

ECUs are nodes within a vehicle that control tasks ranging from activating the windshield wipers to controlling anti-lock brake systems. ECUs are often connected to one another through the vehicle's central network, which may be referred to as a controller area network (CAN). State-of-the-art features such as autonomous driving are strongly reliant on implementing new, complex ECUs such as ADAS, sensors, and the like. While these new technologies have helped improve the safety and driving experience of a vehicle, they have also increased the number of externally-communicating units inside of the vehicle, making them more vulnerable to attack. Below are some examples of protecting the vehicle from physical intrusion and remote intrusion.

In an example of the instant solution, a CAN includes a CAN bus with a high and low terminal and a plurality of ECUs, which are connected to the CAN bus via wired connections. The CAN bus is designed to allow microcontrollers and devices to communicate with each other in an application without a host computer. The CAN bus implements a message-based protocol (i.e., ISO 11898 standards) that allows ECUs to send commands to one another at a root level. Meanwhile, the ECUs represent controllers for controlling electrical systems or subsystems within the vehicle. Examples of the electrical systems include power steering, anti-lock brakes, air-conditioning, tire pressure monitoring, cruise control, and many other features.

In one example, the ECU includes a transceiver and a microcontroller. The transceiver may be used to transmit and receive messages to and from the CAN bus. For example, the transceiver may convert the data from the microcontroller into a format of the CAN bus and also convert data from the CAN bus into a format for the microcontroller. Meanwhile, the microcontroller interprets the messages and also decides what messages to send using ECU software installed therein in one example.

To protect the CAN from cyber threats, various security protocols may be implemented. For example, sub-networks (e.g., sub-networks A and B, etc.) may be used to divide the CAN into smaller sub-CANs and limit an attacker's capabilities to access the vehicle remotely. In one example of the instant solution, a firewall (or gateway, etc.) may be added to block messages from crossing the CAN bus across sub-networks. If an attacker gains access to one sub-network, the attacker will not have access to the entire network. To make sub-networks even more secure, the most critical ECUs are not placed on the same sub-network, in one example.

In addition to protecting a vehicle's internal network, vehicles may also be protected when communicating with external networks such as the Internet. One of the benefits of having a vehicle connection to a data source such as the Internet is that information from the vehicle can be sent through a network to remote locations for analysis. Examples of vehicle information include GPS, onboard diagnostics, tire pressure, and the like. These communication systems are often referred to as telematics because they involve the combination of telecommunications and informatics. Further, the instant solution as described and depicted can be utilized in this and other networks and/or systems, including those that are described and depicted herein.

FIG. 4E illustrates an example 400E of vehicles 402E and 408E performing secured V2V communications using security certificates, according to examples of the instant solution. Referring to FIG. 4E, the vehicles 402E and 408E may communicate via V2V communications over a short-range network, a cellular network, or the like. Before sending messages, the vehicles 402E and 408E may sign the messages using a respective public key certificate. For example, the vehicle 402E may sign a V2V message using a public key certificate 404E. Likewise, the vehicle 408E may sign a V2V message using a public key certificate 410E. The public key certificates 404E and 410E are associated with the vehicles 402E and 408E, respectively, in one example.

Upon receiving the communications from each other, the vehicles may verify the signatures with a certificate authority 406E or the like. For example, the vehicle 408E may verify with the certificate authority 406E that the public key certificate 404E used by vehicle 402E to sign a V2V communication is authentic. If the vehicle 408E successfully verifies the public key certificate 404E, the vehicle knows that the data is from a legitimate source. Likewise, the vehicle 402E may verify with the certificate authority 406E that the public key certificate 410E used by the vehicle 408E to sign a V2V communication is authentic. Further, the instant solution as described and depicted with respect to FIG. 4E can be utilized in this and other networks and/or systems including those that are described and depicted herein.

In some examples of the instant solution, a computer may include a security processor. In particular, the security processor may perform authorization, authentication, cryptography (e.g., encryption), and the like, for data transmissions that are sent between ECUs and other devices on a CAN bus of a vehicle, and also data messages that are transmitted between different vehicles. The security processor may include an authorization module, an authentication module, and a cryptography module. The security processor may be implemented within the vehicle's computer and may communicate with other vehicle elements, for example, the ECUs/CAN network, wired and wireless devices such as wireless network interfaces, input ports, and the like. The security processor may ensure that data frames (e.g., CAN frames, etc.) that are transmitted internally within a vehicle (e.g., via the ECUs/CAN network) are secure. Likewise, the security processor can ensure that messages transmitted between different vehicles and devices attached or connected via a wire to the vehicle's computer are also secured.

For example, the authorization module may store passwords, usernames, PIN codes, biometric scans, and the like for different vehicle users. The authorization module may determine whether a user (or technician) has permission to access certain settings such as a vehicle's computer. In some examples of the instant solution, the authorization module may communicate with a network interface to download any necessary authorization information from an external server. When a user desires to make changes to the vehicle settings or modify technical details of the vehicle via a console or GUI within the vehicle or via an attached/connected device, the authorization module may require the user to verify themselves in some way before such settings are changed. For example, the authorization module may require a username, a password, a PIN code, a biometric scan, a predefined line drawing or gesture, and the like. In response, the authorization module may determine whether the user has the necessary permissions (access, etc.) being requested.

The authentication module may be used to authenticate internal communications between ECUs on the CAN network of the vehicle. As an example, the authentication module may provide information for authenticating communications between the ECUs. As an example, the authentication module may transmit a bit signature algorithm to the ECUs of the CAN network. The ECUs may use the bit signature algorithm to insert authentication bits into the CAN fields of the CAN frame. All ECUs on the CAN network typically receive each CAN frame. The bit signature algorithm may dynamically change the position, amount, etc., of authentication bits each time a new CAN frame is generated by one of the ECUs. The authentication module may also provide a list of ECUs that are exempt (safe list) and that do not need to use the authentication bits. The authentication module may communicate with a remote server to retrieve updates to the bit signature algorithm and the like.

The encryption module may store asymmetric key pairs to be used by the vehicle to communicate with other external user devices and vehicles. For example, the encryption module may provide a private key to be used by the vehicle to encrypt/decrypt communications, while the corresponding public key may be provided to other user devices and vehicles to enable the other devices to decrypt/encrypt the communications. The encryption module may communicate with a remote server to receive new keys, updates to keys, keys of new vehicles, users, etc., and the like. The encryption module may also transmit any updates to a local private/public key pair to the remote server.

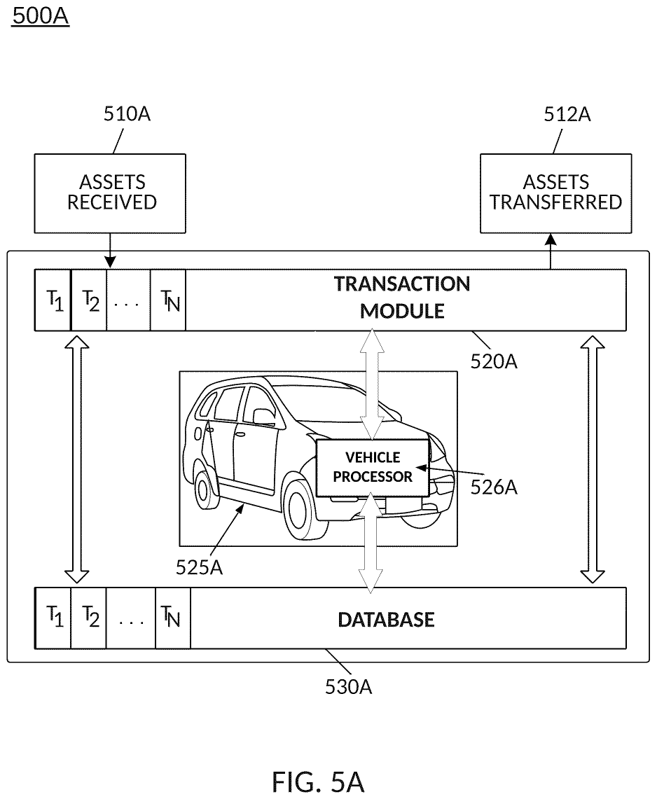

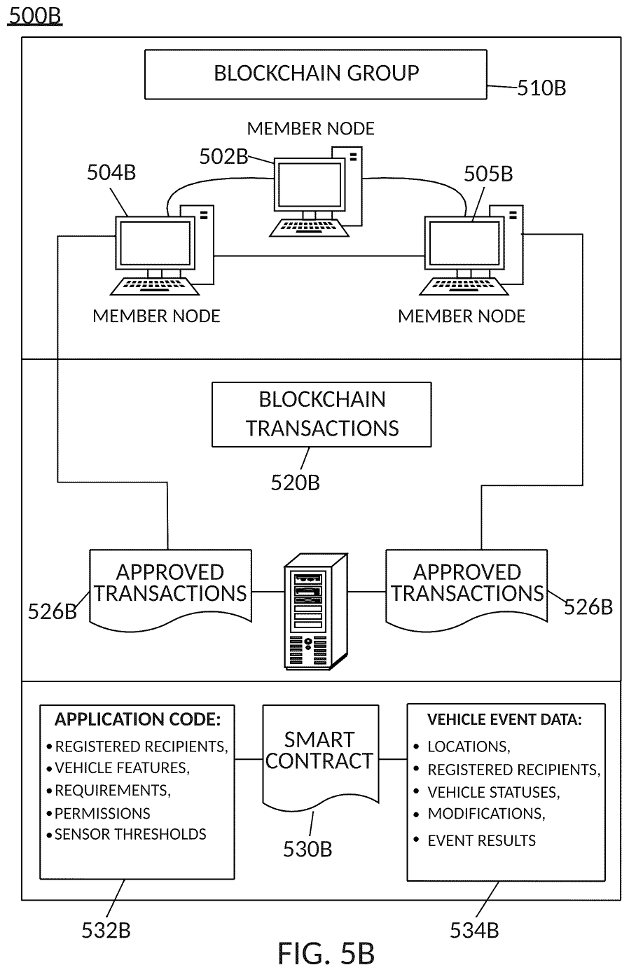

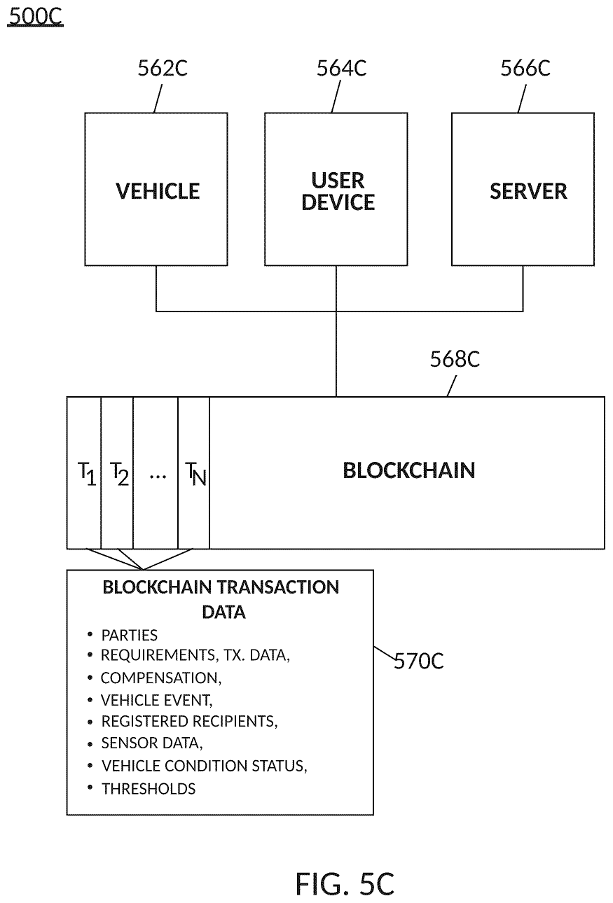

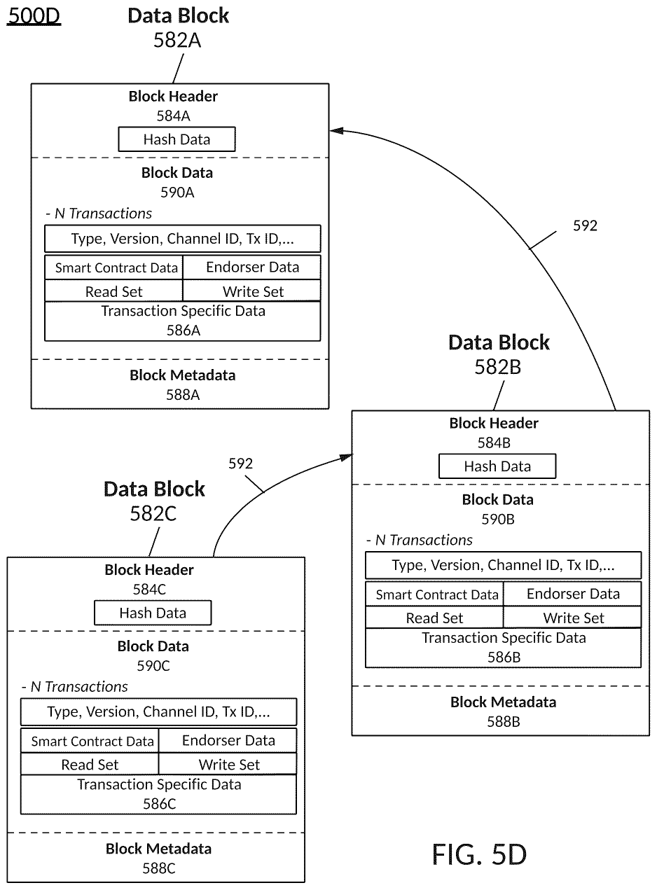

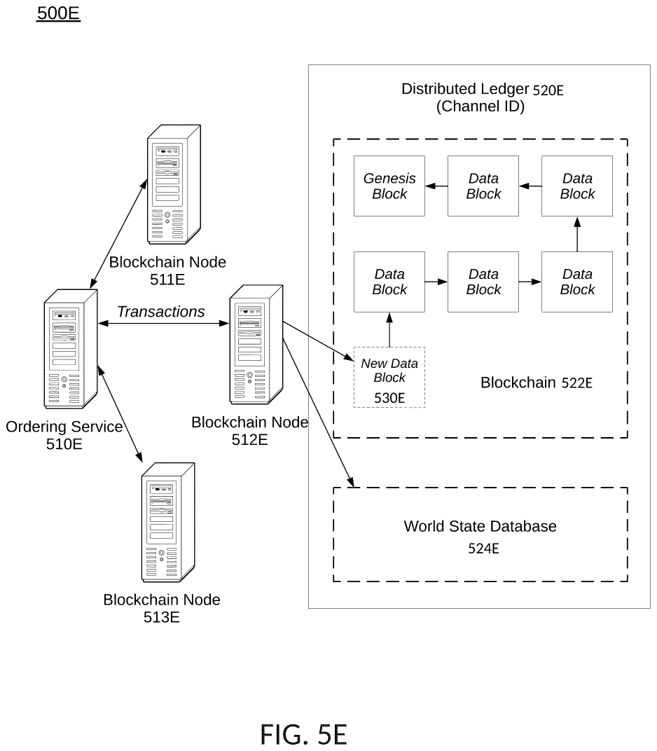

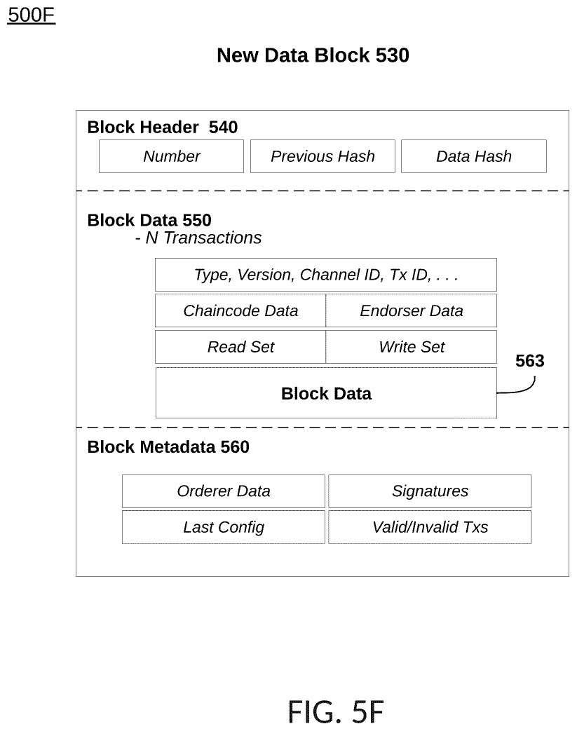

FIG. 5A illustrates an example vehicle configuration 500A for managing database transactions associated with a vehicle, according to examples of the instant solution. Referring to FIG. 5A, as a particular vehicle 525A is engaged in transactions (e.g., vehicle service, dealer transactions, delivery/pickup, transportation services, etc.), the vehicle may receive assets 510A and/or expel/transfer assets 512A according to a transaction(s). A vehicle processor 526A resides in the vehicle 525A and communication exists between the vehicle processor 526A, a database 530A, and the transaction module 520A. The transaction module 520A may record information, such as assets, parties, credits, service descriptions, date, time, location, results, notifications, unexpected events, etc. Those transactions in the transaction module 520A may be replicated into a database 530A. The database 530A can be one of a SQL database, a relational database management system (RDBMS), a relational database, a non-relational database, a blockchain, a distributed ledger, and may be on board the vehicle, may be off-board the vehicle, may be accessed directly and/or through a network, or be accessible to the vehicle.

In one example of the instant solution, a vehicle may engage with another vehicle to perform various actions such as to share, transfer, acquire service calls, etc. when the vehicle has reached a status where the services need to be shared with another vehicle. For example, the vehicle may be due for a battery charge and/or may have an issue with a tire and may be en route to pick up a package for delivery. A vehicle processor resides in the vehicle and communication exists between the vehicle processor, a first database, and a transaction module. The vehicle may notify another vehicle, which is in its network and which operates on its service, such as its blockchain member service. A vehicle processor resides in another vehicle and communication exists between the vehicle processor, a second database, and a transaction module. The another vehicle may then receive the information via a wireless communication request to perform the package pickup from the vehicle and/or from a server (not shown). The transactions are logged in the transaction modules and of both vehicles. The credits are transferred from the vehicle to the other vehicle and the record of the transferred service is logged in the first database. The first database can be one of a SQL database, an RDBMS, a relational database, a non-relational database, a blockchain, a distributed ledger, and may be on board the vehicle, may be off-board the vehicle, may be accessible directly and/or through a network. A maximum charge capacity of a battery of a vehicle is a measure of the battery's capacity relative to when it was new. As a battery ages chemically, its capacity decreases, which can result in fewer hours of usage between charges.

FIG. 5B illustrates a blockchain architecture configuration 500B, according to examples of the instant solution. Referring to FIG. 5B, the blockchain architecture 500B may include certain blockchain elements, for example, a group of blockchain member nodes 502B-505B as part of a blockchain group 510B. In one example of the instant solution, a permissioned blockchain is not accessible to all parties but only to those members with permissioned access to the blockchain data. The blockchain nodes participate in a number of activities, such as blockchain entry addition and validation process (consensus). One or more of the blockchain nodes may endorse entries based on an endorsement policy and may provide an ordering service for all blockchain nodes. A blockchain node may initiate a blockchain action (such as an authentication) and seek to write to a blockchain immutable ledger stored in the blockchain, a copy of which may also be stored on the underpinning physical infrastructure.

The blockchain transactions 520B are stored in memory of computers as the transactions are received and approved by the consensus model dictated by the members'nodes. Approved transactions 526B are stored in current blocks of the blockchain and committed to the blockchain via a committal procedure, which includes performing a hash of the data contents of the transactions in a current block and referencing a previous hash of a previous block. Within the blockchain, one or more smart contracts 530B may exist that define the terms of transaction agreements and actions included in smart contract executable application code 532B, such as registered recipients, vehicle features, requirements, permissions, sensor thresholds, etc. The code may be configured to identify whether requesting entities are registered to receive vehicle services, what service features they are entitled/required to receive given their profile statuses and whether to monitor their actions in subsequent events. For example, when a service event occurs and a user is riding in the vehicle, the sensor data monitoring may be triggered, and a certain parameter, such as a vehicle charge level, may be identified as being above/at/below a particular threshold for a particular period of time, then the result may be a change to a current status, which requires an alert to be sent to the managing party (i.e., vehicle owner, vehicle operator, server, etc.) so the service can be identified and stored for reference. The vehicle sensor data collected may be based on types of sensor data used to collect information about vehicle's status. The sensor data may also be the basis for the vehicle event data 534B, such as a location(s) to be traveled, an average speed, a top speed, acceleration rates, whether there were any collisions, was the expected route taken, what is the next destination, whether safety measures are in place, whether the vehicle has enough charge/fuel, etc. All such information may be the basis of smart contract terms 530B, which are then stored in a blockchain. For example, sensor thresholds stored in the smart contract can be used as the basis for whether a detected service is necessary and when and where the service should be performed.

In one example of the instant solution, a blockchain logic example includes a blockchain application interface as an API or plug-in application that links to the computing device and execution platform for a particular transaction. The blockchain configuration may include one or more applications, which are linked to application programming interfaces (APIs) to access and execute stored program/application code (e.g., smart contract executable code, smart contracts, etc.), which can be created according to a customized configuration sought by participants and can maintain their own state, control their own assets, and receive external information. This can be deployed as an entry and installed, via appending to the distributed ledger, on all blockchain nodes.

The smart contract application code provides a basis for the blockchain transactions by establishing application code, which when executed causes the transaction terms and conditions to become active. The smart contract, when executed, causes certain approved transactions to be generated, which are then forwarded to the blockchain platform. The platform includes a security/authorization, computing devices, which execute the transaction management and a storage portion as a memory that stores transactions and smart contracts in the blockchain.

The blockchain platform may include various layers of blockchain data, services (e.g., cryptographic trust services, virtual execution environment, etc.), and underpinning physical computer infrastructure that may be used to receive and store new entries and provide access to auditors, which are seeking to access data entries. The blockchain may expose an interface that provides access to the virtual execution environment necessary to process the program code and engage the physical infrastructure. Cryptographic trust services may be used to verify entries such as asset exchange entries and keep information private.

The blockchain architecture configuration of FIGS. 5A and 5B may process and execute program/application code via one or more interfaces exposed, and services provided, by the blockchain platform. As a non-limiting example, smart contracts may be created to execute reminders, updates, and/or other notifications subject to the changes, updates, etc. The smart contracts can themselves be used to identify rules associated with authorization and access requirements and usage of the ledger. For example, the information may include a new entry, which may be processed by one or more processing entities (e.g., processors, virtual machines, etc.) included in the blockchain layer. The result may include a decision to reject or approve the new entry based on the criteria defined in the smart contract and/or a consensus of the peers. The physical infrastructure may be utilized to retrieve any of the data or information described herein.

Within smart contract executable code, a smart contract may be created via a high-level application and programming language, and then written to a block in the blockchain. The smart contract may include executable code that is registered, stored, and/or replicated with a blockchain (e.g., distributed network of blockchain peers). An entry is an execution of the smart contract code, which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A smart contract executable code may include the code interpretation of a smart contract, with additional features. As described herein, the smart contract executable code may be program code deployed on a computing network, where it is executed and validated by chain validators together during a consensus process. The smart contract executable code receives a hash and retrieves from the blockchain a hash associated with the data template created by use of a previously stored feature extractor. If the hashes of the hash identifier and the hash created from the stored identifier template data match, then the smart contract executable code sends an authorization key to the requested service. The smart contract executable code may write to the blockchain data associated with the cryptographic details.

FIG. 5C illustrates a blockchain configuration for storing blockchain transaction data, according to examples of the instant solution. Referring to FIG. 5C, the example configuration 500C provides for the vehicle 562C, the user device 564C and a server 566C sharing information with a distributed ledger (i.e., blockchain) 568C. The server may represent a service provider entity inquiring with a vehicle service provider to share user profile rating information in the event that a known and established user profile is attempting to rent a vehicle with an established rated profile. The server 566C may be receiving and processing data related to a vehicle's service requirements. As the service events occur, such as the vehicle sensor data indicates a need for fuel/charge, a maintenance service, etc., a smart contract may be used to invoke rules, thresholds, sensor information gathering, etc., which may be used to invoke the vehicle service event. The blockchain transaction data 570C is saved for each transaction, such as the access event, the subsequent updates to a vehicle's service status, event updates, etc. The transactions may include the parties, the requirements (e.g., 18 years of age, service eligible candidate, valid driver's license, etc.), compensation levels, the distance traveled during the event, the registered recipients permitted to access the event and host a vehicle service, rights/permissions, sensor data retrieved during the vehicle event operation to log details of the next service event and identify a vehicle's condition status, and thresholds used to make determinations about whether the service event was completed and whether the vehicle's condition status has changed.

FIG. 5D illustrates blockchain blocks 500D that can be added to a distributed ledger, according to examples of the instant solution, and contents of block structures 582A to 582n. Referring to FIG. 5D, clients (not shown) may submit entries to blockchain nodes to enact activity on the blockchain. As an example, clients may be applications that act on behalf of a requester, such as a device, person, or entity to propose entries for the blockchain. The plurality of blockchain peers (e.g., blockchain nodes) may maintain a state of the blockchain network and a copy of the distributed ledger. Different types of blockchain nodes/peers may be present in the blockchain network including endorsing peers, which simulate and endorse entries proposed by clients and committing peers which verify endorsements, validate entries, and commit entries to the distributed ledger. In this example, the blockchain nodes may perform the role of endorser node, committer node, or both.

The instant system includes a blockchain that stores immutable, sequenced records in blocks, and a state database (current world state) maintaining a current state of the blockchain. One distributed ledger may exist per channel and each peer maintains its own copy of the distributed ledger for each channel of which they are a member. The instant blockchain is an entry log, structured as hash-linked blocks where each block contains a sequence of N entries. Blocks may include various components such as those shown in FIG. 5D. The linking of the blocks may be generated by adding a hash of a prior block's header within a block header of a current block. In this way, all entries on the blockchain are sequenced and cryptographically linked together preventing tampering with blockchain data without breaking the hash links. Furthermore, because of the links, the latest block in the blockchain represents every entry that has come before it. The instant blockchain may be stored on a peer file system (local or attached storage), which supports an append-only blockchain workload.

The current state of the blockchain and the distributed ledger may be stored in the state database. Here, the current state data represents the latest values for all keys ever included in the chain entry log of the blockchain. Smart contract executable code invocations execute entries against the current state in the state database. To make these smart contract executable code interactions extremely efficient, the latest values of all keys are stored in the state database. The state database may include an indexed view into the entry log of the blockchain, it can therefore be regenerated from the chain at any time. The state database may automatically get recovered (or generated if needed) upon peer startup, before entries are accepted.

Endorsing nodes receive entries from clients and endorse the entry based on simulated results. Endorsing nodes hold smart contracts, which simulate the entry proposals. When an endorsing node endorses an entry, the endorsing node creates an entry endorsement, which is a signed response from the endorsing node to the client application indicating the endorsement of the simulated entry. The method of endorsing an entry depends on an endorsement policy that may be specified within smart contract executable code. An example of an endorsement policy is “the majority of endorsing peers must endorse the entry.” Different channels may have different endorsement policies. Endorsed entries are forwarded by the client application to an ordering service.

The ordering service accepts endorsed entries, orders them into a block, and delivers the blocks to the committing peers. For example, the ordering service may initiate a new block when a threshold of entries has been reached, a timer times out, or another condition is met. In this example, a blockchain node is a committing peer that has received a data block 582A for storage on the blockchain. The ordering service may be made up of a cluster of orderers. The ordering service does not process entries, smart contracts, or maintain the shared ledger. Rather, the ordering service may accept the endorsed entries and specify the order in which those entries are committed to the distributed ledger. The architecture of the blockchain network may be designed such that the specific implementation of ‘ordering’ becomes a pluggable component.

Entries are written to the distributed ledger in a consistent order. The order of entries is established to ensure that the updates to the state database are valid when they are committed to the network. Unlike a cryptocurrency blockchain system where ordering occurs through the solving of a cryptographic puzzle, or mining, in this example the parties of the distributed ledger may choose the ordering mechanism that best suits that network.

Referring to FIG. 5D, a block 582A (also referred to as a data block) that is stored on the blockchain and/or the distributed ledger may include multiple data segments such as a block header 584A to 584n, transaction-specific data 586A to 586n, and block metadata 588A to 588n. It should be appreciated that the various depicted blocks and their contents, such as block 582A and its contents are merely for purposes of an example and are not meant to limit the scope of the examples of the instant solution. In some cases, both the block header 584A and the block metadata 588A may be smaller than the transaction-specific data 586A, which stores entry data; however, this is not a requirement. The block 582A may store transactional information of N entries (e.g., 100, 500, 1000, 2000, 3000, etc.) within the block data 590A to 590n. The block 582A may also include a link to a previous block (e.g., on the blockchain) within the block header 584A. In particular, the block header 584A may include a hash of a previous block's header. The block header 584A may also include a unique block number, a hash of the block data 590A of the current block 582A, and the like. The block number of the block 582A may be unique and assigned in an incremental/sequential order starting from zero. The first block in the blockchain may be referred to as a genesis block, which includes information about the blockchain, its members, the data stored therein, etc.

The block data 590A may store entry information of each entry that is recorded within the block. For example, the entry data may include one or more of a type of the entry, a version, a timestamp, a channel ID of the distributed ledger, an entry ID, an epoch, a payload visibility, a smart contract executable code path (deploy), a smart contract executable code name, a smart contract executable code version, an input (smart contract executable code and functions), a client (creator) identifier such as a public key and certificate, a signature of the client, identities of endorsers, endorser signatures, a proposal hash, smart contract executable code events, response status, namespace, a read set (list of key and version read by the entry, etc.), a write set (list of key and value, etc.), a start key, an end key, a list of keys, a Merkel tree query summary, and the like. The entry data may be stored for each of the N entries.

In some examples of the instant solution, the block data 590A may also store transaction-specific data 586A, which adds additional information to the hash-linked chain of blocks in the blockchain. Accordingly, the data 586A can be stored in an immutable log of blocks on the distributed ledger. Some of the benefits of storing such data 586A are reflected in the various examples of the instant solution disclosed and depicted herein. The block metadata 588A may store multiple fields of metadata (e.g., as a byte array, etc.). Metadata fields may include signature on block creation, a reference to a last configuration block, an entry filter identifying valid and invalid entries within the block, last offset of an ordering service that ordered the block, and the like. The signature, the last configuration block, and the orderer metadata may be added by the ordering service. Meanwhile, a committer of the block (such as a blockchain node) may add validity/invalidity information based on an endorsement policy, verification of read/write sets, and the like. The entry filter may include a byte array of a size equal to the number of entries in the block data and a validation code identifying whether an entry was valid/invalid.

The other blocks 582B to 582n in the blockchain also have headers, files, and values. However, unlike the first block 582A, each of the headers 584A to 584n in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 592, to establish an auditable and immutable chain-of-custody.

FIG. 5E illustrates a process 500E of a new block being added to a distributed ledger 520E, according to examples of the instant solution, and FIG. 5D illustrates the contents of FIG. 5E's new data block structure 530E for blockchain, according to examples of the instant solution. Referring to FIG. 5E, clients (not shown) may submit transactions to blockchain nodes 511E, 512E, and/or 513E. Clients may be instructions received from any source to enact activity on the blockchain 522E. As an example, clients may be applications that act on behalf of a requester, such as a device, person, or entity to propose transactions for the blockchain. The plurality of blockchain peers (e.g., blockchain nodes 511E, 512E, and 513E) may maintain a state of the blockchain network and a copy of the distributed ledger 520E. Different types of blockchain nodes/peers may be present in the blockchain network including endorsing peers which simulate and endorse transactions proposed by clients and committing peers which verify endorsements, validate transactions, and commit transactions to the distributed ledger 520E. In this example, the blockchain nodes 511E, 512E, and 513E may perform the role of endorser node, committer node, or both.

The distributed ledger 520E includes a blockchain which stores immutable, sequenced records in blocks, and a state database 524E (current world state) maintaining a current state of the blockchain 522E. One distributed ledger 520E may exist per channel and each peer maintains its own copy of the distributed ledger 520E for each channel of which they are a member. The blockchain 522E is a transaction log, structured as hash-linked blocks where each block contains a sequence of N transactions. The linking of the blocks (shown by arrows in FIG. 5E) may be generated by adding a hash of a prior block's header within a block header of a current block. In this way, all transactions on the blockchain 522E are sequenced and cryptographically linked together preventing tampering with blockchain data without breaking the hash links. Furthermore, because of the links, the latest block in the blockchain 522E represents every transaction that has come before it. The blockchain 522E may be stored on a peer file system (local or attached storage), which supports an append-only blockchain workload.

The current state of the blockchain 522E and the distributed ledger 520E may be stored in the state database 524E. Here, the current state data represents the latest values for all keys ever included in the chain transaction log of the blockchain 522E. Chaincode invocations execute transactions against the current state in the state database 524E. To make these chaincode interactions extremely efficient, the latest values of all keys are stored in the state database 524E. The state database 524E may include an indexed view into the transaction log of the blockchain 522E, and it can therefore be regenerated from the chain at any time. The state database 524E may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction.” Different channels may have different endorsement policies. Endorsed transactions are forwarded by the client application to the ordering service 510E.

The ordering service 510E accepts endorsed transactions, orders them into a block, and delivers the blocks to the committing peers. For example, the ordering service 510E may initiate a new block when a threshold of transactions has been reached, a timer times out, or another condition is met. In the example of FIG. 5E, the blockchain node 512E is a committing peer that has received a new data block 530E for storage on blockchain 522E. The first block in the blockchain may be referred to as a genesis block which includes information about the blockchain, its members, the data stored therein, etc.

The ordering service 510E may be made up of a cluster of orderers. The ordering service 510E does not process transactions, smart contracts, or maintain the shared ledger. Rather, the ordering service 510E may accept the endorsed transactions and specifies the order in which those transactions are committed to the distributed ledger 522E. The architecture of the blockchain network may be designed such that the specific implementation of ‘ordering’ becomes a pluggable component.

Transactions are written to the distributed ledger 520E in a consistent order. The order of transactions is established to ensure that the updates to the state database 524E are valid when they are committed to the network. Unlike a cryptocurrency blockchain system where ordering occurs through the solving of a cryptographic puzzle, or mining, in this example the parties of the distributed ledger 520E may choose the ordering mechanism that best suits the network.

When the ordering service 510E initializes a new data block 530E, the new data block 530E may be broadcast to committing peers (e.g., blockchain nodes 511E, 512E, and 513E). In response, each committing peer validates the transaction within the new data block 530E by checking to make sure that the read set and the write set still match the current world state in the state database 524E. Specifically, the committing peer can determine whether the read data that existed when the endorsers simulated the transaction is identical to the current world state in the state database 524E. When the committing peer validates the transaction, the transaction is written to the blockchain 522E on the distributed ledger 520E, and the state database 524E is updated with the write data from the read-write set. If a transaction fails, that is, if the committing peer finds that the read-write set does not match the current world state in the state database 524E, the transaction ordered into a block will still be included in that block, but it will be marked as invalid, and the state database 524E will not be updated.

Referring to FIG. 5F 500F, a new data block 530 (also referred to as a data block) that is stored on the blockchain 522E of the distributed ledger 520E may include multiple data segments such as a block header 540, block data 550, and block metadata 560. It should be appreciated that the various depicted blocks and their contents, such as new data block 530 and its contents shown in FIG. 5F, are merely examples and are not meant to limit the scope of the examples of the instant solution. The new data block 530 may store transactional information of N transaction(s) (e.g., 1, 10, 100, 500, 1000, 2000, 3000, etc.) within the block data 550. The new data block 530 may also include a link to a previous block (e.g., on the blockchain 522E in FIG. 5E) within the block header 540. In particular, the block header 540 may include a hash of a previous block's header. The block header 540 may also include a unique block number, a hash of the block data 550 of the new data block 530, and the like. The block number of the new data block 530 may be unique and assigned in various orders, such as an incremental/sequential order starting from zero.

The block data 550 may store transactional information of each transaction that is recorded within the new data block 530. For example, the transaction data may include one or more of a type of the transaction, a version, a timestamp, a channel ID of the distributed ledger 520E (shown in FIG. 5E), a transaction ID, an epoch, a payload visibility, a chaincode path (deploy tx), a chaincode name, a chaincode version, an input (chaincode and functions), a client (creator) identifier such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, and the like. The transaction data may be stored for each of the N transactions.

In one example of the instant solution, the block data 563 may include data comprising one or more of processing, by at least one processor on a vehicle, a query related to a sign proximate a road that the vehicle is traveling on using a first artificial intelligence (AI) model deployed on the vehicle to generate contextual information related to the sign, sending, by the at least one processor, the query and the contextual information to a second AI model deployed on a server off the vehicle, processing, by the server, the query and the contextual information using the second AI model, generating, by the server, a response related to the query and the contextual information, sending, by the server, the response to the at least one processor, and providing, by the at least one processor, the response to the vehicle.

In another example of the instant solution, the block data 563 may include data comprising one or more of processing, by at least one processor on a vehicle, a query related to a sign proximate a road that the vehicle is traveling on using a first artificial intelligence (AI) model deployed on the vehicle to generate contextual information related to the sign, sending, by the at least one processor, the query and the contextual information to a second AI model deployed on a server off the vehicle, processing, by the server, the query and the contextual information using the second AI model, generating, by the server, a response related to the query and the contextual information, sending, by the server, the response to the at least one processor, and providing, by the at least one processor, the response to the vehicle.

Although in FIG. 5F the blockchain data 563 is depicted in the block data 550 but may also be located in the block header 540 or the block metadata 560.

The block metadata 560 may store multiple fields of metadata (e.g., as a byte array, etc.). Metadata fields may include signature on block creation, a reference to a last configuration block, a transaction filter identifying valid and invalid transactions within the block, last offset of an ordering service that ordered the block, and the like. The signature, the last configuration block, and the orderer metadata may be added by the ordering service 510E in FIG. 5E. Meanwhile, a committer of the block (such as blockchain node 512E in FIG. 5E) may add validity/invalidity information based on an endorsement policy, verification of read/write sets, and the like. The transaction filter may include a byte array of a size equal to the number of transactions in the block data and a validation code identifying whether a transaction was valid/invalid.

The above examples of the instant solution may be implemented in hardware, in a computer program executed by a processor, in firmware, or in a combination of the above. A computer program may be embodied on a computer-readable storage medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

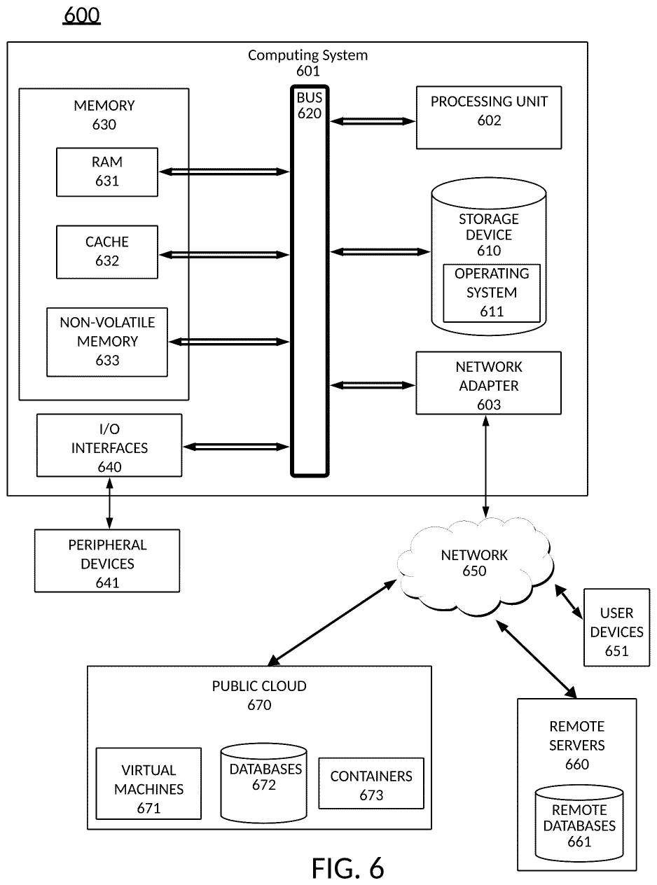

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components. For example, FIG. 6 illustrates an example computing system architecture 600, which may represent or be integrated in any of the above-described components, etc.

FIG. 6 illustrates a computing environment according to examples of the instant solution. FIG. 6 is not intended to suggest any limitation as to the scope of use or functionality of examples of the instant solution of the application described herein. Regardless, the computing environment 600 can be implemented to perform any of the functionalities described herein. In computer environment 600, computing system 601 is operational within numerous other general-purpose or special-purpose computing system environments or configurations.

Computing system 601 may take the form of a desktop computer, laptop computer, tablet computer, smartphone, smartwatch or other wearable computer, server computing system, thin client, thick client, network PC, minicomputing system, mainframe computer, quantum computer, and distributed cloud computing environment that includes any of the described systems or devices, and the like or any other form of computer or mobile device now known or to be developed in the future that is capable of running a program, accessing a network 650 or querying a database. Depending upon the technology, the performance of a computer-implemented method may be distributed among multiple computers and between multiple locations. However, in this presentation of the computing environment 600, a detailed discussion is focused on a single computer, specifically computing system 601, to keep the presentation as simple as possible.

Computing system 601 may be located in a cloud, even though it is not shown in a cloud in FIG. 6. On the other hand, computing system 601 is not required to be in a cloud except to any extent as may be affirmatively indicated. Computing system 601 may be described in the general context of computing system-executable instructions, such as program modules, executed by a computing system 601. Generally, program modules may include routines, programs, objects, components, logic, data structures, and so on that perform tasks or implement certain abstract data types. As shown in FIG. 6, computing system 601 in computing environment 600 is shown in the form of a general-purpose computing device. The components of computing system 601 may include, but are not limited to, one or more processors or processing units 602, a system memory 630, and a bus 620 that couples various system components, including system memory 630 to processing unit 602.

Processing unit 602 includes one or more computer processors of any type now known or to be developed. The processing unit 602 may contain circuitry distributed over multiple integrated circuit chips. The processing unit 602 may also implement multiple processor threads and multiple processor cores. Cache 632 is a memory that may be in the processor chip package(s) or located “off-chip,” as depicted in FIG. 6. Cache 632 is typically used for data or code that the threads or cores running on the processing unit 602 should be available for rapid access. In some computing environments, processing unit 602 may be designed to work with qubits and perform quantum computing.

Network adapter 603 enables the computing system 601 to connect and communicate with one or more networks 650, such as a local area network (LAN), a wide area network (WAN), and/or a public network (e.g., the Internet). It bridges the computer's internal bus 620 and the external network, exchanging data efficiently and reliably. The network adapter 603 may include hardware, such as modems or Wi-Fi® signal transceivers, and software for packetizing and/or de-packetizing data for communication network transmission. Network adapter 603 supports various communication protocols to ensure compatibility with network standards. For Ethernet connections, it adheres to protocols such as IEEE 802.3, while for wireless communications, it might support IEEE 802.11 standards, Bluetooth®, near-field communication (NFC), or other network wireless radio standards.

Computing system 601 may include a removable/non-removable, volatile/non-volatile computer storage device 610. By way of example only, storage device 610 can be a non-removable, non-volatile magnetic media (not shown and typically called a “hard drive”). One or more data interfaces can connect it to the bus 620. In examples of the instant solution where computing system 601 is required to have a large amount of storage (for example, where computing system 601 locally stores and manages a large database), then this storage may be provided by storage devices 610 designed for storing very large amounts of data, such as a storage area network (SAN) that is shared by multiple, geographically distributed computers.

The operating system 611 is software that manages computing system 601 hardware resources and provides common services for computer programs. Operating system 611 may take several forms, such as various known proprietary operating systems or open-source Portable Operating System Interface type operating systems that employ a kernel.

The bus 620 represents one or more of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 620 is the signal conduction path that allows the various components of computing system 601 to communicate with each other.

Memory 630 is any volatile memory now known or to be developed in the future. Examples include dynamic random-access memory (RAM 631) or static type RAM 631. Typically, the volatile memory is characterized by random access, but this is not required unless affirmatively indicated. In computing system 601, memory 630 is in a single package and is internal to computing system 601, but alternatively or additionally, the volatile memory may be distributed over multiple packages and/or located externally with respect to computing system 601. By way of example only, memory 630 can be provided for reading from and writing to a non-removable, non-volatile magnetic media (shown as storage device 610, and typically called a “hard drive”). Memory 630 may include at least one program product having a set (e.g., at least one) of program modules configured to carry out various functions. A typical computing system 601 may include cache 632, a specialized volatile memory generally faster than RAM 631 and generally located closer to the processing unit 602. Cache 632 stores frequently accessed data and instructions accessed by the processing unit 602 to speed up processing time. The computing system 601 may include non-volatile memory 633 in ROM, PROM, EEPROM, and flash memory. Non-volatile memory 633 often contains programming instructions for starting the computer, including the basic input/output system (BIOS) and information required to start the operating system 611.

Computing system 601 may also communicate with one or more peripheral devices 641 via an input/output (I/O) interface 640. Such devices may include a keyboard, a pointing device, a display, etc. ; one or more devices that enable a user to interact with computing system 601; and/or any devices (e.g., network card, modem, etc.) that enable computing system 601 to communicate with one or more other computing devices. Such communication can occur via I/O interfaces 640. As depicted, I/O interface 640 communicates with the other components of computing system 601 via bus 620.

Network 650 is any computer network that can receive and/or transmit data. Network 650 can include a WAN, LAN, private cloud, or public Internet, capable of communicating computer data over non-local distances by any technology that is now known or to be developed in the future. Any connection depicted can be wired and/or wireless and may traverse other components that are not shown. In some examples of the instant solution, a network 650 may be replaced and/or supplemented by LANs designed to communicate data between devices located in a local area, such as a Wi-Fi® network. The network 650 typically includes computer hardware such as copper transmission cables, optical transmission fibers, wireless transmission, routers, firewalls, switches, gateway computers, edge servers, and network infrastructure known now or to be developed in the future. Computing system 601 connects to network 650 via network adapter 603 and bus 620.

User devices 651 are any computing systems used and controlled by an end user in connection with computing system 601. For example, in a hypothetical case where computing system 601 is designed to provide a recommendation to an end user, this recommendation may typically be communicated from network adapter 603 of computing system 601 through network 650 to a user device 651, allowing user device 651 to display, or otherwise present, the recommendation to an end user. User devices can be a wide array of devices, including personal computers (PCs), laptops, tablets, hand-held, mobile phones, etc.

Remote servers 660 are any computers that serve at least some data and/or functionality over a network 650, for example, WAN, a virtual private network (VPN), a private cloud, or via the Internet to computing system 601. These networks 650 may communicate with a LAN to reach users. The user interface may include a web browser or an application that facilitates communication between the user and remote data. Such applications have been called “thin” desktops or “thin clients.” Thin clients typically incorporate software programs to emulate desktop sessions. Mobile applications can also be used. Remote servers 660 can also host remote databases 661, with the database located on one remote server 660 or distributed across multiple remote servers 660. Remote databases 661 are accessible from database client applications installed locally on the remote server 660, other remote servers 660, user devices 651, or computing system 601 across a network 650.

A public cloud 670 is an on-demand availability of computing system resources, including data storage and computing power, without direct active management by the user. Public clouds 670 are often distributed, with data centers in multiple locations for availability and performance. Computing resources on public clouds 670 are shared across multiple tenants through virtual computing environments comprising virtual machines 671, databases 672, containers 673, and other resources. A container 673 is an isolated, lightweight software for running an application on the host operating system 611. Containers 673 are built on top of the host operating system's kernel and contain only applications and some lightweight operating system APIs and services. In contrast, virtual machine 671 is a software layer that includes a complete operating system 611 and kernel. Virtual machines 671 are built on top of a hypervisor emulation layer designed to abstract a host computer's hardware from the operating software environment. Public clouds 670 generally offer hosted databases 672 abstracting high-level database management activities. It should be further understood that one or more of the elements described or depicted in FIG. 6 can perform one or more of the actions, functionalities, or features described or depicted herein. Computing environment 600, which may be located in or associated with a vehicle, enhances the functionality and interoperability of components, including computing systems within vehicles. The architecture incorporates a processor and a storage medium, which can be integrated with the processor or configured as separate components. This flexible setup allows for customization based on specific vehicular computing needs, whether embedded within an application-specific integrated circuit (ASIC) for dedicated tasks or as discrete units for modular scalability. The computing system, depicted in FIG. 6, demonstrates adaptability to various vehicular settings, from passenger cars and commercial trucks to autonomous and connected vehicles, supporting a range of functionalities.

Computing system 601 includes a processing unit 602 connected to a system memory 630 via a bus 620. This configuration facilitates the rapid processing and communication necessary for real-time vehicular operations, such as navigation, telematics, and autonomous driving functionalities. A network adapter 603 ensures the system's connectivity to at least vehicular networks and the Internet of Vehicles (IoV), as well as supporting protocols and standards essential for vehicular communication, safety, and entertainment systems.

Storage solutions within the computing system 601 support the robust data requirements of vehicles, from storing extensive maps and software updates to logging vehicle diagnostics and telematics information. The system's operating system 611 is designed to manage these resources efficiently.

The bus architecture 620 is tailored to vehicular needs, supporting high-speed data transfer and reliable communication between the computing system's components, essential for the timely execution of vehicular functions. Memory 630, including both volatile and non-volatile options, is optimized for the operational demands of vehicles, providing the necessary speed and capacity for tasks ranging from immediate processing needs to long-term data storage.

Peripheral interfaces 641 and I/O interfaces 640 are integrated to facilitate interaction with other vehicular systems and components, such as sensors, actuators, and user interfaces, highlighting the system's capacity for vehicular integration. Moreover, the system's design accounts for connectivity with external networks 650, including at least dedicated vehicular communication networks.

One or more of the components described or depicted herein, including at least vehicle 202, computer 224, vehicle node 310, AI/ML systems 330/340/360/332, computers/servers 410C/414C/418C/424C/428C/432C/436C/442C/406C, server 418D, server 404E, Certificate Authority 306I, Member Nodes 502B-505B, server 566C, and servers 510E-513E, may be one or more of the components including at least 601, 641, 650, 651, 660, 670, and 671.

Although an example of at least one of a system, method, and non-transitory computer-readable storage medium has been illustrated in the accompanied drawings and described in the foregoing detailed description, it will be understood that the application is not limited to the examples of the instant solution disclosed, but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device, and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many examples of the instant solution. Indeed, methods, systems and apparatuses disclosed herein may be implemented in localized and distributed forms consistent with computing technology.

It should be noted that some of the system features described in this specification have been presented as modules to emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field-programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Further, modules may be stored on a computer-readable storage medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated within modules and embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the examples of the instant solution is not intended to limit the scope of the application as claimed but is merely representative of selected examples of the instant solution of the application.

One having ordinary skill in the art will readily understand that the above may be practiced with steps in a different order and/or with hardware elements in configurations that are different from those which are disclosed. Therefore, although the application has been described based upon these preferred examples of the instant solution, it would be apparent to those of skill in the art that certain modifications, variations, and alternative constructions would be apparent.

While preferred examples of the instant solution of the present application have been described, it is to be understood that the examples of the instant solution described are illustrative only and the scope of the application is to be defined solely by the appended claims when considered with a full range of equivalents and modifications (e.g., protocols, hardware devices, software platforms etc.) thereto.

What is claimed is:

1. A method, comprising:
processing, by at least one processor on a vehicle, a query related to a sign proximate a road that the vehicle is traveling on using a first artificial intelligence (AI) model deployed on the vehicle to generate contextual information related to the sign;
sending, by the at least one processor, the query and the contextual information to a second AI model deployed on a server off the vehicle;
processing, by the server, the query and the contextual information using the second AI model;
generating, by the server, a response related to the query and the contextual information;
sending, by the server, the response to the at least one processor; and
providing, by the at least one processor, the response to the vehicle.

2. The method of claim 1, wherein the processing of the query and the contextual information occurs responsive to determining that an environmental condition exceeds a threshold.

3. The method of claim 1, wherein the query and the contextual information are sent to the second AI model when a complexity of the contextual information is above a threshold.

4. The method of claim 1, wherein the generating of the contextual information comprises:
collecting, by sensors on the vehicle, data associated with an environment of the vehicle; and
wherein information depicted on the sign relates to the data.

5. The method of claim 1, wherein the first AI model is trained using auditory signals and is executed to generate the contextual information based on received auditory signals.

6. The method of claim 1, wherein the second AI model processes the query and the contextual information by applying a context-based adaptor related to a current condition of the vehicle, and wherein the response related to the current condition of the vehicle.

7. The method of claim 1, wherein the processing of the query related to the sign is performed when the sign is at least one of:
a sign that exists proximate the road less than a first threshold number of times; or
determined to be an importance greater than a second threshold based on the contextual information.

8. A system, comprising:
a memory; and
at least one processor, wherein the memory and the at least one processor are communicatively coupled, wherein the at least one processor is configured to:
process, by at least one processor on a vehicle, a query related to a sign proximate a road that the vehicle travels on via a first artificial intelligence (AI) model deployed on the vehicle to generate contextual information related to the sign;
send, by the at least one processor, the query and the contextual information to a second AI model deployed on a server off the vehicle;
process, by the server, the query and the contextual information via the second AI model;
generate, by the server, a response related to the query and the contextual information;
send, by the server, the response to the at least one processor; and
provide, by the at least one processor, the response to the vehicle.

9. The system of claim 8, wherein the process of the query and the contextual information occurs responsive to a determination that an environmental condition exceeds a threshold.

10. The system of claim 8, wherein the query and the contextual information are sent to the second AI model when a complexity of the contextual information is above a threshold.

11. The system of claim 8, wherein the generate of the contextual information comprises:
collect, by sensors on the vehicle, data associated with an environment of the vehicle; and
wherein information depicted on the sign relates to the data.

12. The system of claim 8, wherein the first AI model is trained with auditory signals and is executed to generate the contextual information based on received auditory signals.

13. The system of claim 8, wherein the second AI model processes the query and the contextual information by an application of context-based adaptor related to a current condition of the vehicle, and wherein the response related to the current condition of the vehicle.

14. The system of claim 8, wherein the process of the query related to the sign is performed when the sign is at least one of:
a sign that exists proximate the road less than a first threshold number of times; or
determined to be an importance greater than a second threshold based on the contextual information.

15. A computer program product comprising:
one or more computer-readable storage media; and
program instructions stored on the one or more computer-readable storage media to perform operations comprising:
sending, by the at least one processor, the query and the contextual information to a second AI model deployed on a server off the vehicle;
processing, by the server, the query and the contextual information via the second AI model;
generating, by the server, a response related to the query and the contextual information;
sending, by the server, the response to the at least one processor; and
providing, by the at least one processor, the response to the vehicle.

16. The computer program product of claim 15, wherein the processing the query and the contextual information occurs responsive to determining that an environmental condition exceeds a threshold.

17. The computer program product of claim 15, wherein the query and the contextual information are sent to the second AI model when a complexity of the contextual information is above a threshold.

18. The computer program product of claim 15, wherein the generating the contextual information comprises:
collect, by sensors on the vehicle, data associated with an environment of the vehicle; and
wherein information depicted on the sign relates to the data.

19. The computer program product of claim 15, wherein the first AI model is trained with auditory signals and is executed to generate the contextual information based on received auditory signals.

20. The computer program product of claim 15, wherein the second AI model processes the query and the contextual information by an application of context-based adaptor related to a current condition of the vehicle, and wherein the response related to the current condition of the vehicle.
